(19) United States
(12) Patent Application Publication
(10) Pub. No.: US 2025/0103981 A1
(43) Pub. Date: Mar. 27, 2025

(54) SYSTEM AND METHOD FOR DETERMINING ESTIMATED ANNUAL PAVEMENT COST

(71) Applicant: United States of America as Represented by The Secretary of The Army, Alexandria, VA (US)

(72) Inventors: Mohamed Y. Shahin, Windsor, CO (US); Robert E. Reinke, Indianapolis, IN (US); Spencer H. Dickey, Indianapolis, IN (US)

(21) Appl. No.: 18/372,133

(22) Filed: Sep. 25, 2023

(51) Int. Cl. G06Q 10/0631; G06Q 40/06; G06Q 50/08

(52) U.S. Cl. CPC G06Q 10/06313; G06Q 40/06; G06Q 50/08

(57) ABSTRACT

A specialized computer running pavement management application (PMA) software may be configured to apply risk cost and return on investment analysis to determine an optimized work plan for maintenance and repairs of a network of road sections. PMA may be configured to incorporate global maintenance and repair activities (such as surface treatments), major maintenance and repair activities (such as overlays and reconstruction), and localized preventative maintenance and repair activities (such as crack sealing and patching).

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### CROSS CITATIONS

Co-pending application (COE-871B) filed on the same day as this application and incorporated by reference in its entirety contains detailed information on the algorithm and method to determine critical PCI for a PCI using major ROI calculations.

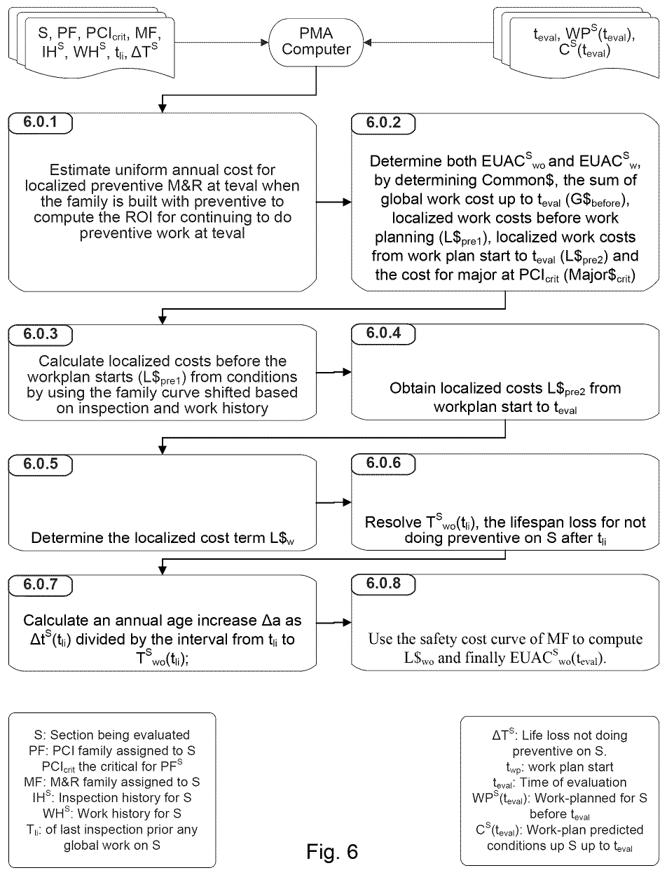

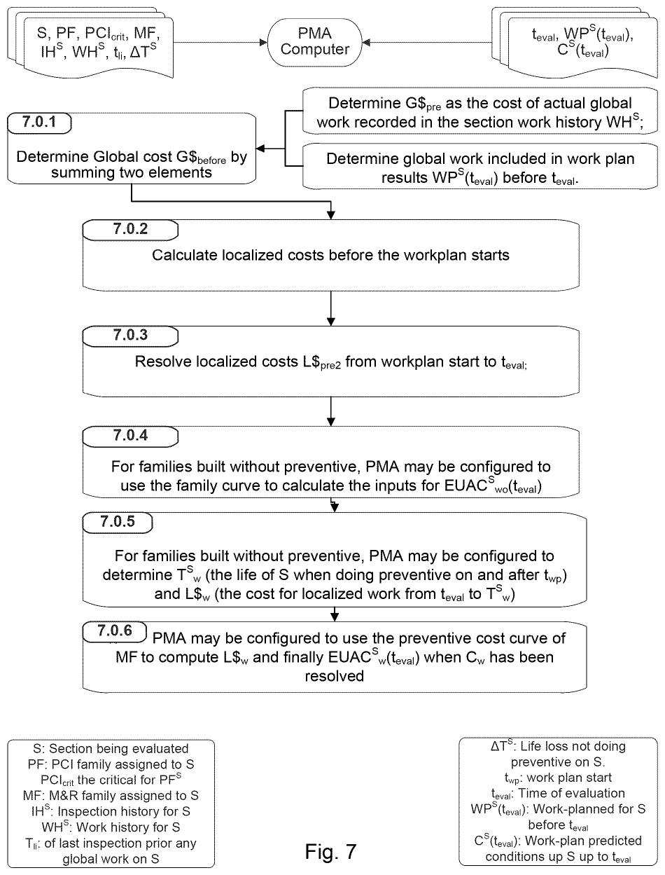

Co-pending application (COE-871C) filed on the same day as this application and incorporated by reference in its entirety contains detailed information on the algorithm and method to: determine critical estimated uniform annual costs for preventive M&R at tₑᵥₐₗ when the family is built with preventive to compute the ROI for continuing to do preventive work at tₑᵥₐₗ: determine critical estimated uniform annual costs for preventive M&R at tₑᵥₐₗ when the family is built with preventive to compute the ROI for starting to do preventive work at tₑᵥₐₗ (see FIG. 6B and related description); estimate uniform annual cost for localized preventive M&R at tₑᵥₐₗ when the family is built without preventive to compute the ROI for continuing to do preventive work at tₑᵥₐₗ; and determine estimated uniform annual cost for localized preventive M&R at tₑᵥₐₗ when the family is built without preventive to compute the ROI for starting to do preventive work at tₑᵥₐₗ (see FIG. 7B and related description).

### FIELD OF INVENTION

This invention relates to systems and methods for repairing pavement.

### BACKGROUND OF THE INVENTION

Repair and maintenance of the civil infrastructure, including roads and highways of the United States present great technical and financial challenges. The American Association of State Highway Transportation Officials (AASHTO) issued a bottom-line report in 2010 stating that $160 billion a year must be spent to maintain infrastructure; however, only about $80 billion is being spent. The result is a rapidly failing infrastructure. New methods of maintaining existing roads and new methods of constructing roads that would extend the useful life for the same budget dollar are needed to meet the challenges of addressing our failing infrastructure.

In the United States alone there are approximately 4.4 million center lane miles of asphalt concrete, with a center lane comprising a 24-foot-wide pavement surface having a lane in each direction. Asphalt concrete paving surfaces are typically prepared by heating aggregate to 400° F., and applying liquid asphalt (e.g., by spraying into a pug mill or drum coating) to yield a mixture of 95% aggregate and 5% asphalt.

When asphalt pavement has been in place for several years, the pavement progressively ages. Water works its way into the pavement. It begins to lose its integrity on the surface, causing aggregate at the surface of the pavement to be lost. The pavement surface roughens as aggregate is lost, and cracks begin to form. Conventional pavement repair techniques at this stage in the deterioration process may include: pouring hot rubber asphalt into the cracks, using cold patch (a cold mix asphalt that can be applied to a damaged road surface, e.g., placed in a pothole, under ambient temperature conditions using hand tools). Another technique for repairing pavement exhibiting minimal damage involves application of a liquid asphalt emulsion to the pavement surface may provide a degree of waterproofing to slow the aging process, or, for surfaces exhibiting more deterioration, application of a thin layer of a slurry of aggregate and asphalt emulsion over the top of the pavement.

Preparing and installing hot asphalt pavement involves running aggregate through a heat tube (typically at around 400° F.) where moisture is driven off to prevent boiling over when the rock contacts molten asphalt. The aggregate is added to asphalt, optionally containing a rubber polymer. The aggregate is sent through a mill having high velocity tines that rolls the aggregate through a spray of asphalt. The resulting mixture of aggregate with baked-on asphalt typically comprises 95% aggregate and 5% asphalt (optionally with rubber polymer). The mixture exits the mill at about 350° F. and is transported into waiting trucks (e.g., a belly dump truck) which are driven to the job site. New pavement is laid down over an earthen base covered with gravel that has been graded and compacted. Typically, the new road is not laid in a single pass. Instead, a first 2-3-inch lift of loose hot asphalt is laid down and partially compacted, and then a second lift is laid over the first and compacted. The temperature of the asphalt concrete pavement at this stage is typically about 140° F. Additional lifts can be added as desired, e.g., to a depth of approximately 12 inches, depending upon the expected usage conditions for the road (heavy or light transportation, the velocity of traffic, desired lifetime). Primer or additional material is typically not put between layers of lift in new construction, as the fresh pavement exhibits good adherence to itself in new construction. New construction design typically never requires any primer or additional material between the subsequent lifts.

After approximately fifteen years of exposure to the elements, it may become cost prohibitive to attempt to maintain asphalt pavement via conventional cold patching, waterproofing, and slurry techniques. The conventional approach at this stage in the deterioration of the pavement typically involves priming the damaged surface and applying a layer of hot mix asphalt. For pavement too deteriorated for application priming and application of a layer of hot mix asphalt, a cold-in-place recycling process can be employed.

Existing pavement (asphalt or concrete) may be repaired by use of an overlay, e.g., a mixture of aggregate and asphalt such as described above for new road construction. In the case of repaving over the top of rigid concrete, some type of primer is typically applied, e.g., as a spray resulting in application of approximately 10 gallons of primer per 1,000 square feet of pavement. The primer can be an asphalt emulsion that provides a tacky surface for the new overlay. A single layer of overlay can be applied, or multiple layers, typically two or more.

A conventional method for achieving some resistance to the telegraphing of old defects in the underlying roadbed is to put down a hot tack coat of asphalt, lay a polypropylene mat over the hot tack coat of asphalt, followed by a layer of new hot asphalt concrete which is then compacted over the existing surface.

Deterioration mechanisms of new highways have often been investigated over a 20-year life cycle. Overlays may be applied between the twelfth and fifteenth year. Within the first five years, cracks or potholes typically do not appear unless there is acute damage to the pavement, or loose material underneath the pavement. After the first five years, physical symptoms of deterioration are observed, including lateral and longitudinal cracks due to shrinkage of the pavement mass through the loss of binder and embrittlement of the asphalt. Cracks ultimately result in the creation of a pothole. Raveling is a mechanism wherein the effects of exposure to water and sun break down the adhesion between the rock on the top surface of the pavement and the underlying aggregate, such that small and then larger rock is released from the pavement. A stress fracture is where the pavement, for one reason or another, may not have been thick enough to withstand exposure to an extremely heavy load, moisture, or poor compaction underneath. When combined with shrinkage of the asphalt itself as it goes through heating and cooling cycles, and application of oxidative stress, stress fractures can also result. Stress fractures are characterized by extending in different directions (unlike the lateral or longitudinal cracking as described above).

Conventional repair of shallow surface fissures and raveling uses various methods. Re-saturants are materials that soften old asphalt. They are typically mixed with an emulsion and sprayed onto the surface of the old pavement. The material may penetrate into the uppermost 20 or 30 mils of the pavement and softens the asphalt, imparting flexibility. Thermally fluidized hot asphalt can also be sprayed directly onto the surface, which hardens and provides waterproofing. A fog seal may typically be sprayed on the surface and can be provided with a sand blotter to improve the friction coefficient. In a chip seal, a rubberized emulsion can also be sprayed onto the aged pavement, and then stone is broadcast into the rubberized emulsion which then hardens, bonding the stone. Slurry seal employs a cold aggregate/asphalt mixture prepared in a pug mill and placed on the aged pavement surface, but is applied in a much thinner layer, e.g., 0.25-0.75 inches. Once the pavement surface is repaired, any safety markings can be repainted.

The following materials and patents provide background information on the invention.

Patent: US 2010/0235203 A1 (incorporated by reference in its entirety), titled “Engineered Management System Particularly Suited for Maintenance and Repair (M&R) Management of Structure Such as Pavements.”

Patent: U.S. Pat. No. 10,936,282 B2 (incorporated by reference in its entirety), titled “System for Processing Multi-Level Condition Data to Achieve Standardized Prioritization.”

Textbook: Shahin, M. Y., “Pavement Management for Airports, Roads, and Parking Lots”, Second Edition.

U.S. Air Force Technical Letter (ETL), “Preventive Maintenance Plan (PMP) for Airfield Pavements.”

Shahin, M. Y. and Dodson, E. “Procedures for Determining the Risk of Not Performing Pavement Preventive Maintenance”, 17^{th} International Road Federation World Meeting, November 2013.

### BRIEF SUMMARY OF THE INVENTION

Configurations of the present invention may relate to a pavement management application (PMA) computer comprising a processor and tangible memory storing non-transitory computer readable software configured to cause the processor to execute a pavement repair program. The program may comprise an input interface displayed on a computer screen. The input interface may request the user to: select a pavement having at least one Section(S); the section S having an area (Area^{S}); the section having a Pavement Condition Index (PCI). The input interface may require the user: specify a financial budget; and specify a date at which the computer should calculate an estimated uniform annual cost (EUAC). The pavement management application (PMA) computer may comprise a pavement condition index calculator configured to determine a PCI value for the section. A pavement condition index calculation may comprise a deterioration curve caused by pavement age, pavement condition, and localized preventative M&R history information; and a critical PCI value being a value below which preventive global and localized maintenance and repair (M&R) are no longer performed and safety M&R begins. The pavement management application (PMA) computer may comprise a database for storing: an M&R family (MF) assigned to the selected Section; an inspection history for Section S; the inspection history comprising a date of inspection; an age of the pavement at the date of inspection (time/age); the PCI value based on measured distresses of the pavement; and a work planning date (t_{wp}) indicating when M&R work planning is scheduled to begin. The pavement management application (PMA) computer may comprise: a work planning module configured to integrate risk and return on investment (ROI) calculations into pavement work planning; a pavement lifetime calculator configured to calculate a lifetime of section S (T^{S}_{w}(tₑᵥₐₗ)); and a return on investment calculator configured to determine an estimated uniform annual cost per unit of a section of pavement (EUAC^{s}_{w}) (tₑᵥₐₗ) as well as the risk of not doing the work as planned by pavement management application (PMA).

Configurations of the present invention may also relate to a pavement management application (PMA) computer comprising a processor and tangible memory storing non-transitory computer readable software configured to cause the processor to execute a pavement repair program specialized in determining global maintenance and repair costs (Global M&R). The program may comprise a solver configured to determine an estimated uniform annual cost per unit of a section of pavement when performing work (EUAC^{s}_{w}) (tₑᵥₐₗ) for a particular work category for a pavement section at an evaluation date (tₑᵥₐₗ) and an estimated uniform annual cost per unit of a section of road without performing work (EUAC^{s}_{wo}) (tₑᵥₐₗ) for a particular work category for a pavement section at an evaluation date (tₑᵥₐₗ). The solver may comprise: an input interface configured to allow a user to specify to the program: a Section of pavement for evaluation (S); a PCI family (PF) assigned to Section(S) defined as PF^{S}; a critical PCI (PCI_{crit}) for PF^{S}; a M&R family (MF^{S}) assigned to S; an inspection history (IH^{S}) for S; a work history (WH^{S}) for S; a work plan start (t_{WP}); a time of evaluation (tₑᵥₐₗ); a work-planned work for S before (tₑᵥₐₗ); and a work-plan predicted conditions (CS(tₑᵥₐₗ)) for S up to tₑᵥₐₗ. The pavement management application (PMA) computer may comprise: a work calculator; a work planner; a common cost calculator configured to calculate a common cost (Common$) equal to G$_{before}+Major$_{crit}; a EUAC_{WO} calculator for determining EUAC^{S}_{WO}(tₑᵥₐₗ)—an estimated uniform annual cost per unit area for S without (wo) performing work of a particular category on S at time/age tₑᵥₐₗ; and a EUAC_{W} calculator for determining EUAC^{S}_{W}(tₑᵥₐₗ)—an estimated uniform annual cost per unit area for S when performing work (w) of a particular category at time/age tₑᵥₐₗ.

Configurations of the present invention may also relate to a pavement management application (PMA) computer comprising a processor and tangible memory storing non-transitory computer readable software configured to cause the processor to execute a pavement repair program. The program may comprise a “LocalCostCalc” module configured to calculate a localized cost component of EUAC across three separate time periods. The “LocalCostCalc” module may comprise: a historical calculator for determining costs from a last major M&R (t=0) until work planning starts (t=t_{wp}−1); a planned calculator for determining costs from a work plan starting (t=t_{wp}) until before the current evaluation time (t=tₑᵥₐₗ); a future calculator for determining costs from t=tₑᵥₐₗ to a year before reconstruction (t=t_{recon}−1); and a cost calculator configured to calculate a result cost; the result cost generated by summing a first cost vector, a second cost vector, and a third cost vector.

### COLOR DRAWINGS

The patent or application file contains at least one drawing executed in color. Copies of this patent or patent application publication with color drawing(s) will be provided by the Office upon request and payment of the necessary fee.

### BRIEF DESCRIPTION OF THE DRAWINGS

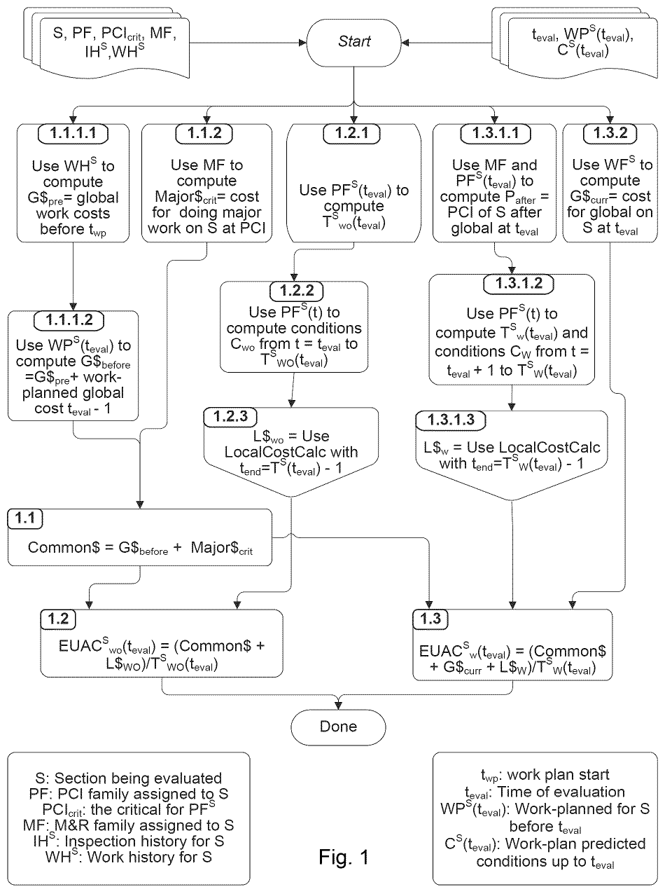

FIG. 1 is a flowchart for a method of determining estimated uniform annual cost with and without global M&R at time tₑᵥₐₗ.

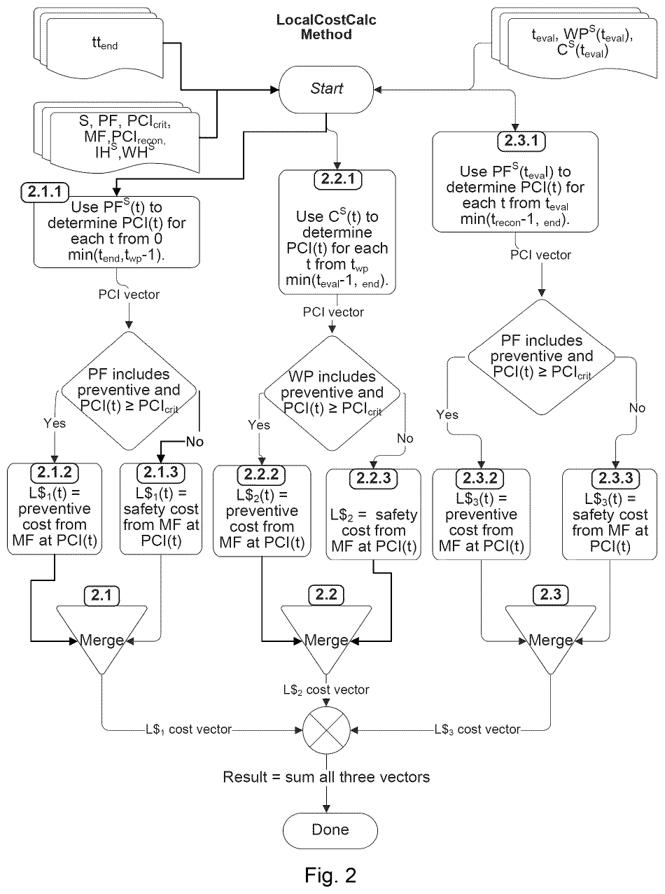

FIG. 2 is a flowchart for calculating the localized cost component of estimated uniform annual cost for Global and Major M&R.

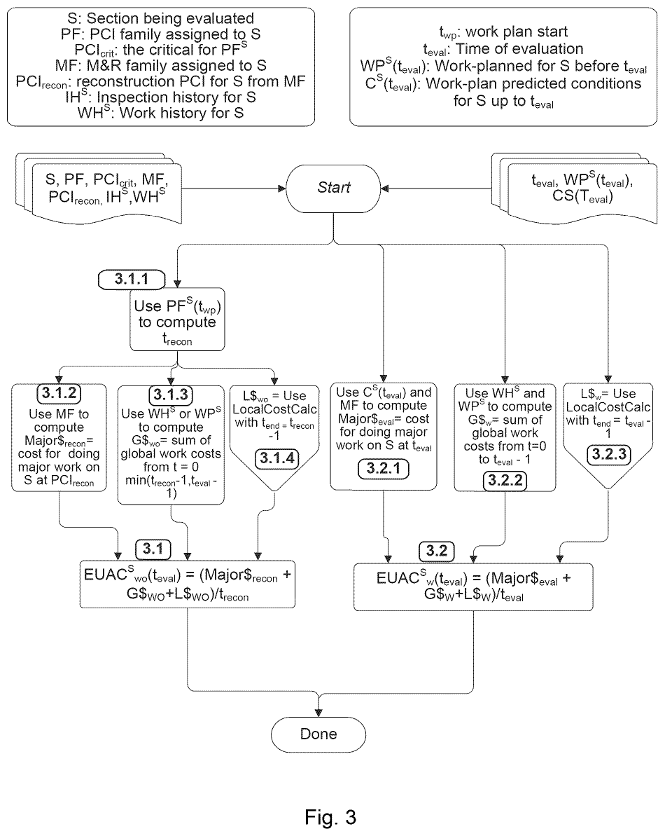

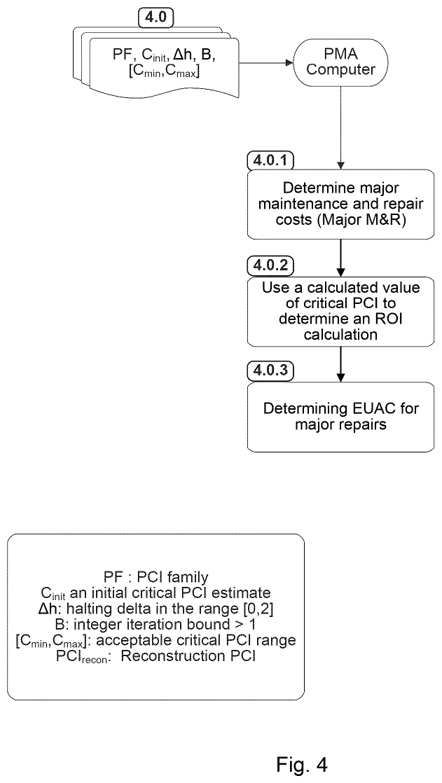

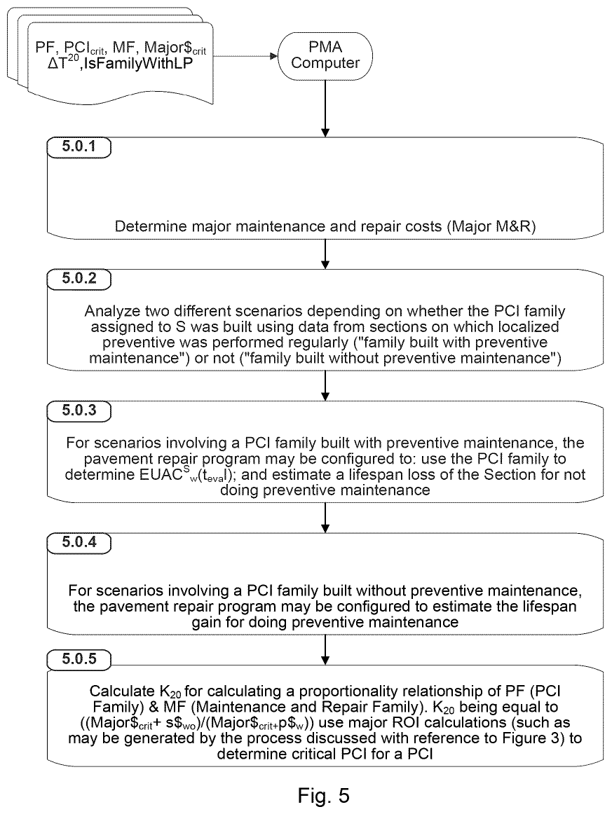

FIG. 3 is a flowchart for determining estimated uniform annual cost with and without major M&R at time tₑᵥₐₗ.

FIG. 4 is a flowchart detailing an algorithm for using major ROI calculation to determine critical PCI for a PCI family PF.

FIG. 5 is a flowchart for calculating the value of k₂₀ in the proportionality function P (PF, MF).

FIG. 6 is a flowchart for determining an estimated uniform annual cost for localized preventive M&R at tₑᵥₐₗ when the family is built with preventive to compute the ROI for continuing to do preventive work at tₑᵥₐₗ.

FIG. 7 is a flowchart for determining estimated uniform annual cost for localized preventive M&R at tₑᵥₐₗ when the family is built without preventive to compute the ROI for continuing to do preventive work at tₑᵥₐₗ.

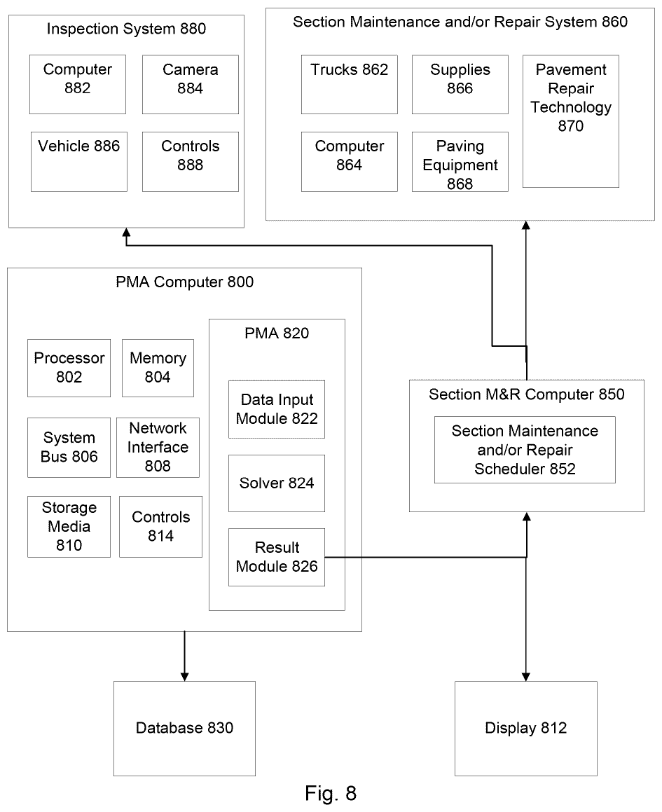

FIG. 8 shows a schematic view of the pavement management application (PMA) computer section M&R computer, inspection system and section maintenance and/or repair system.

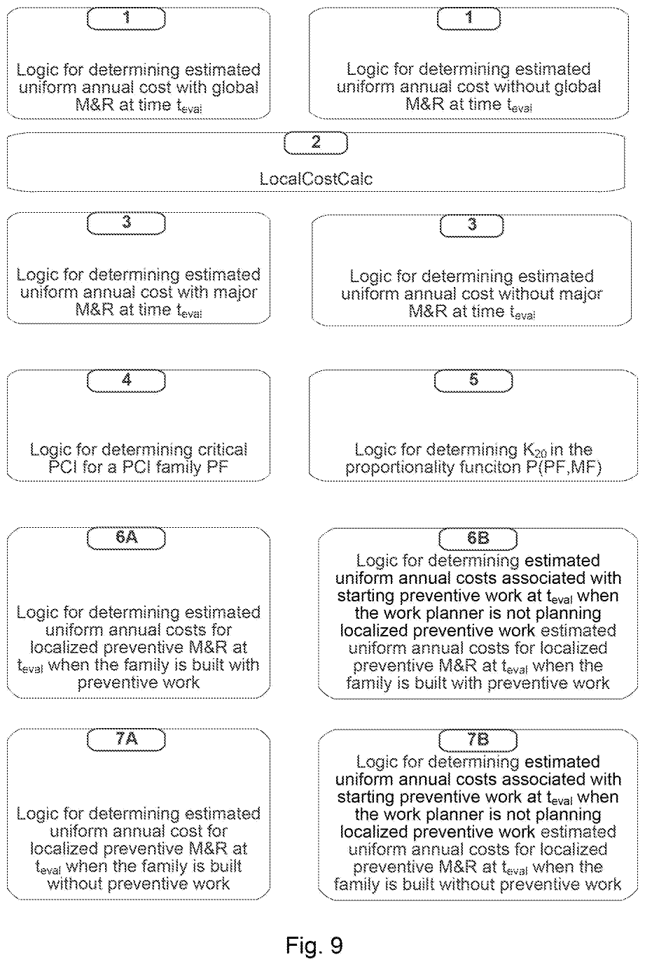

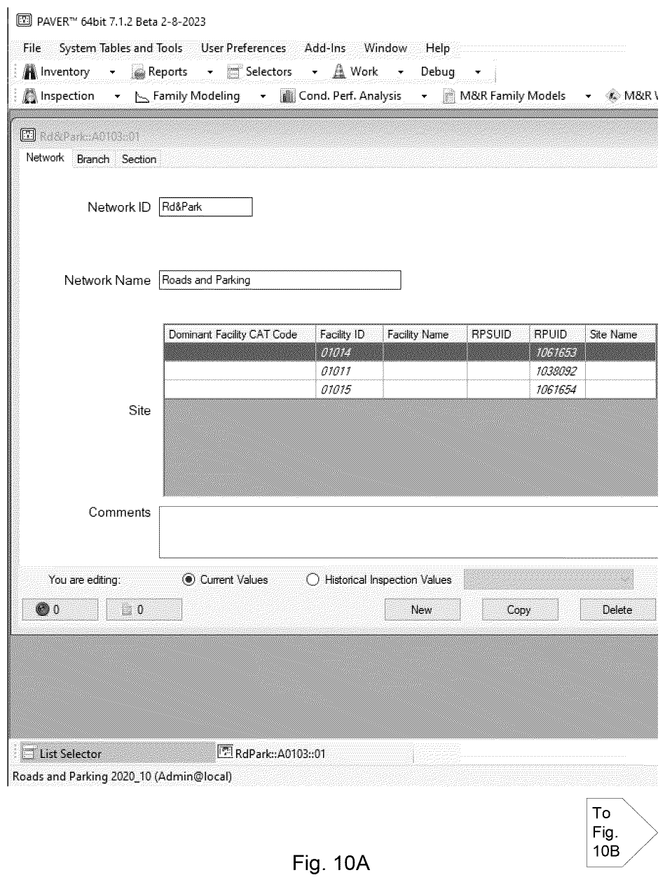

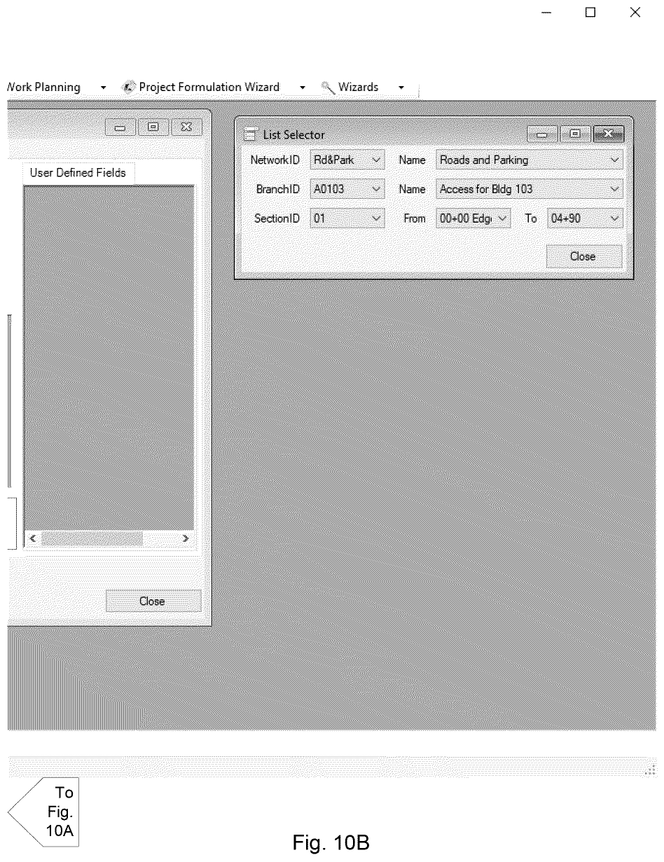

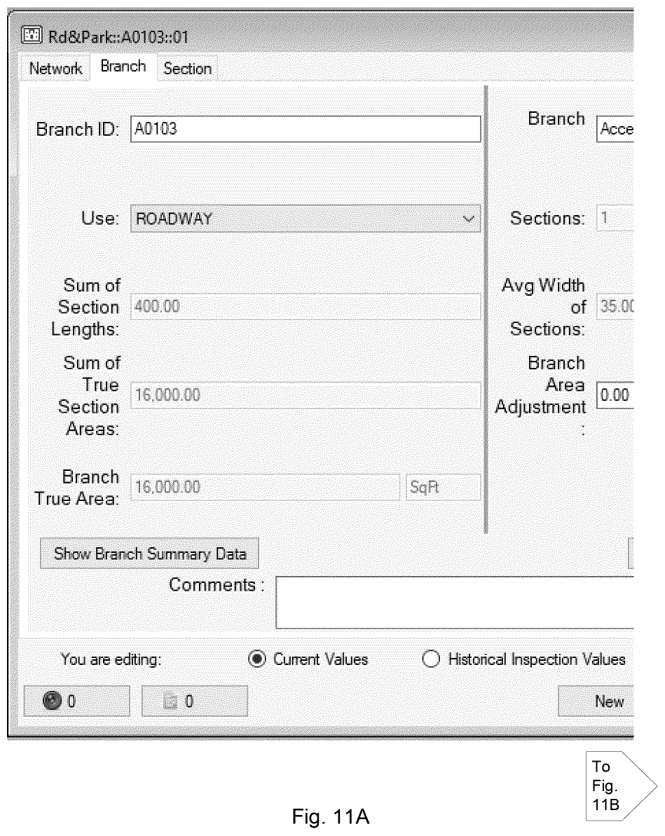

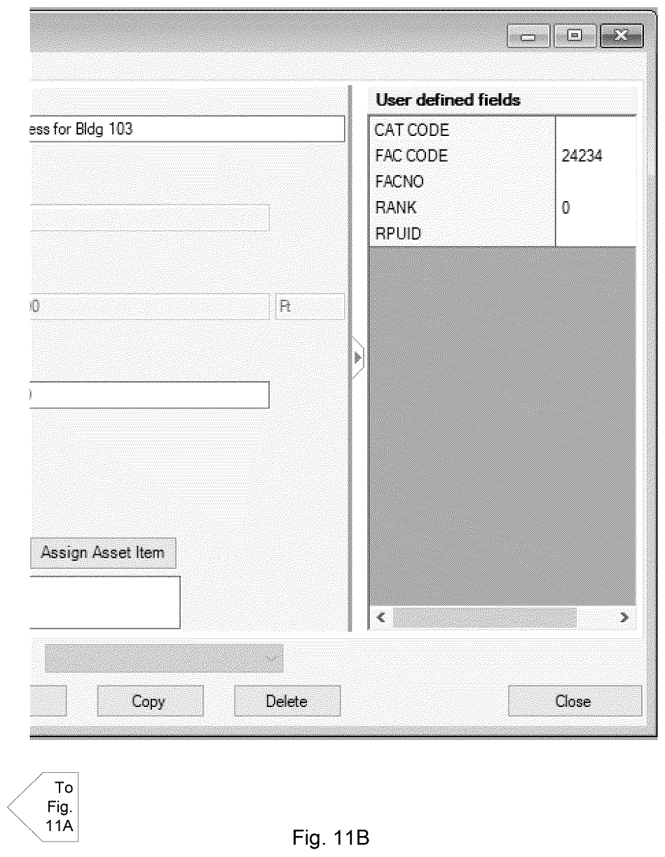

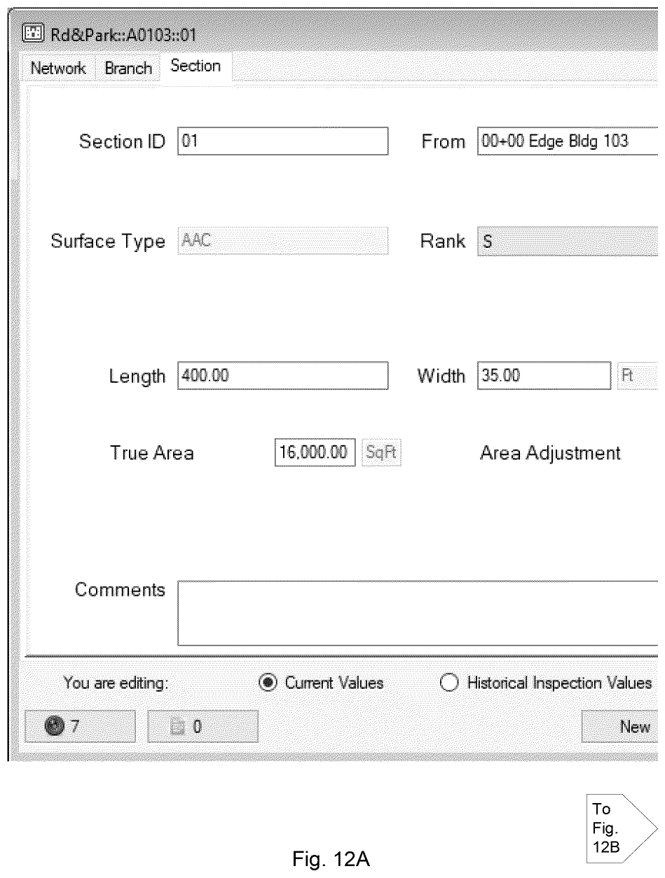

FIG. 9 shows an overall view of various algorithms that pavement management application (PMA) may be programmed to execute.

FIGS. 10A-10B shows an inventory window in pavement management application (PMA).

FIGS. 11A-11B show the inventory window of the branch tab, the branch tab may show branch properties.

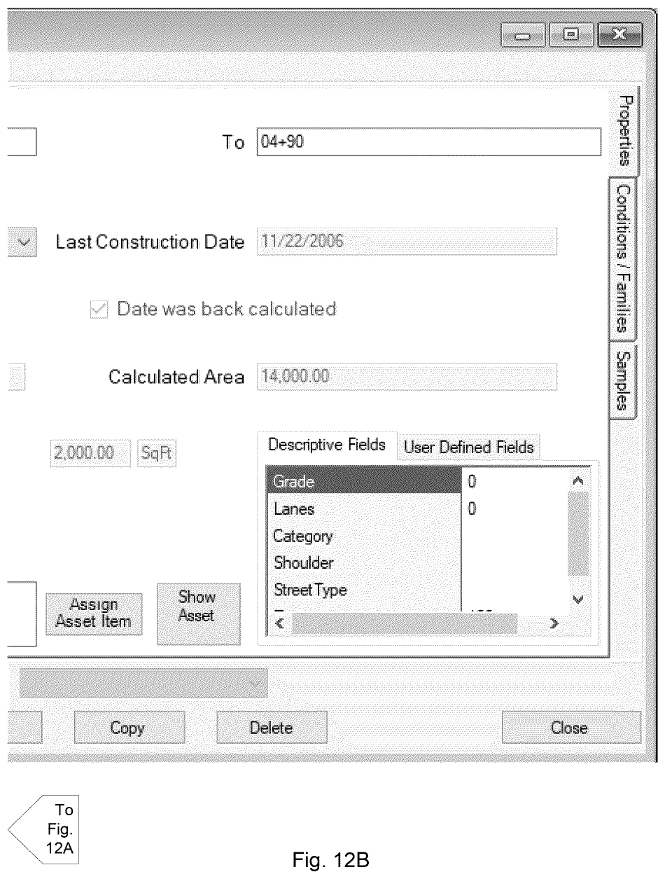

FIGS. 12A-12B shows the inventory window of the section tab.

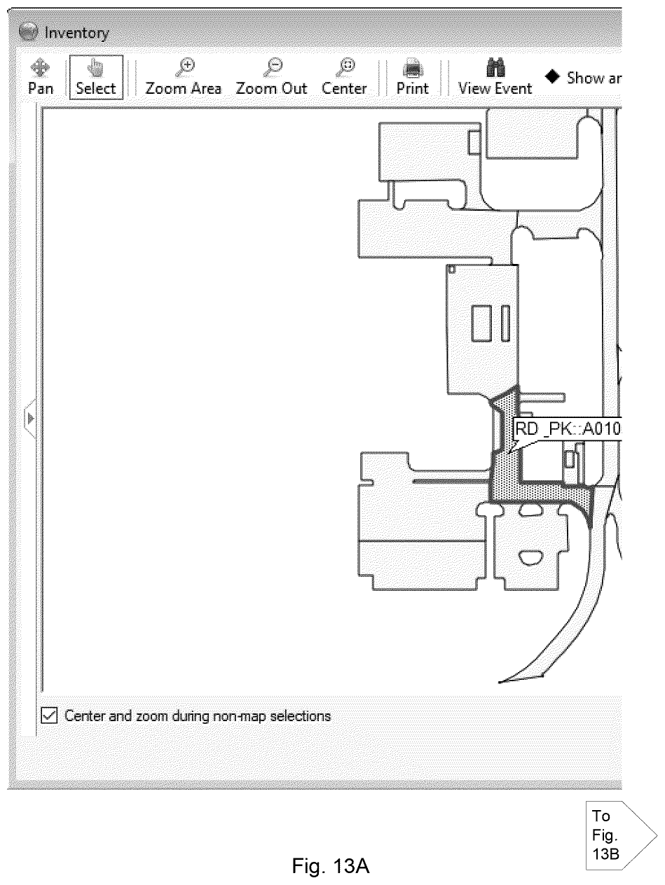

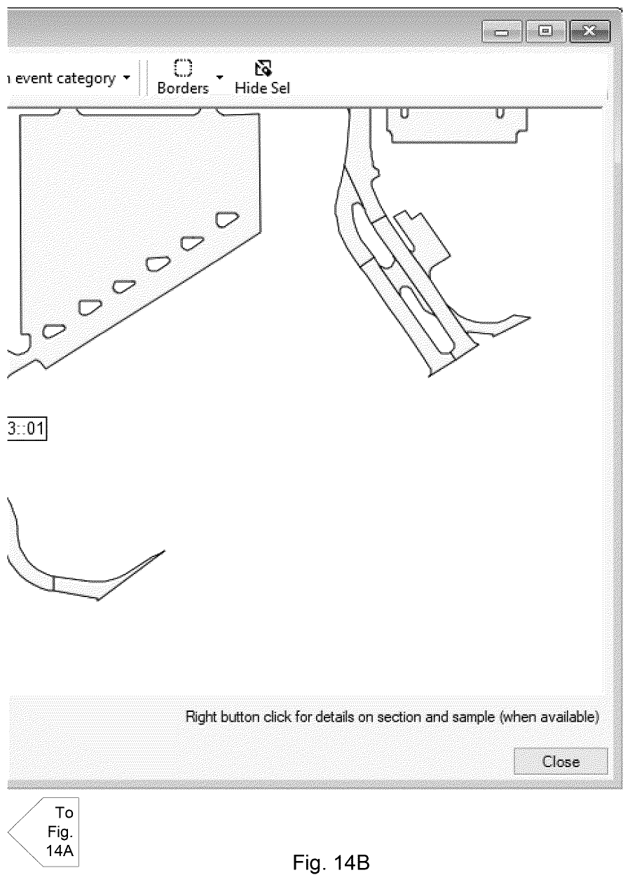

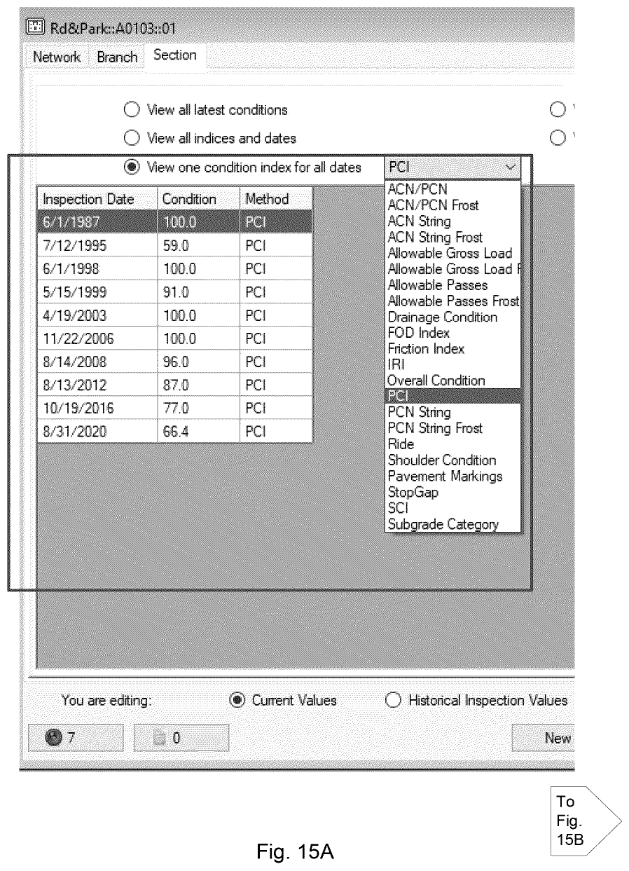

FIGS. 13A-13B shows a window of GIS maps. GIS Maps can be used to give context to the inventory. FIGS. 13A-13B show a current selection section.

FIGS. 14A-14B shows the inventory window with the conditions/families tab selected.

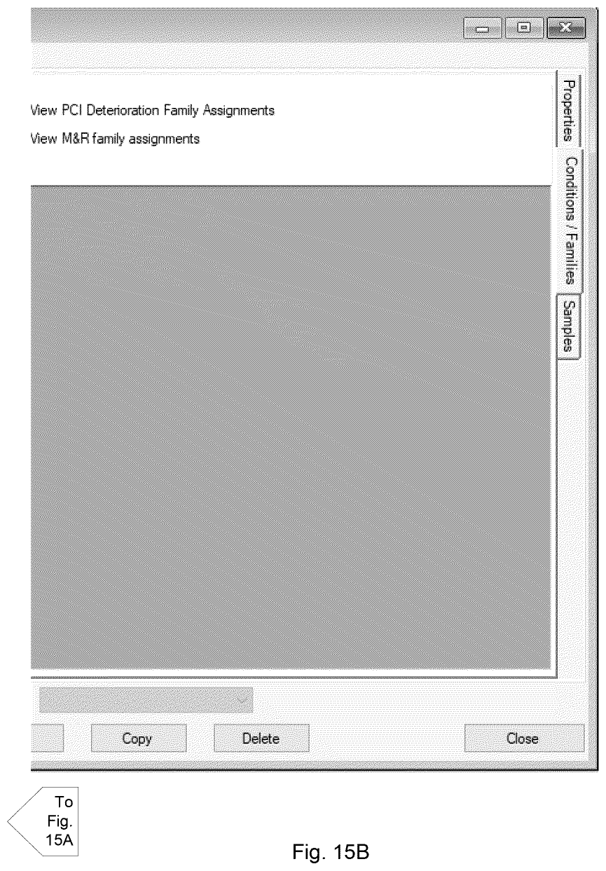

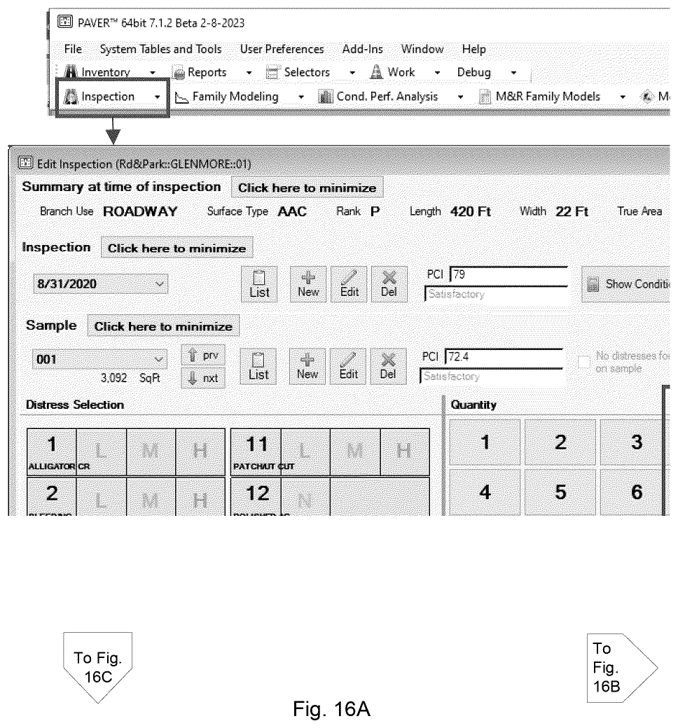

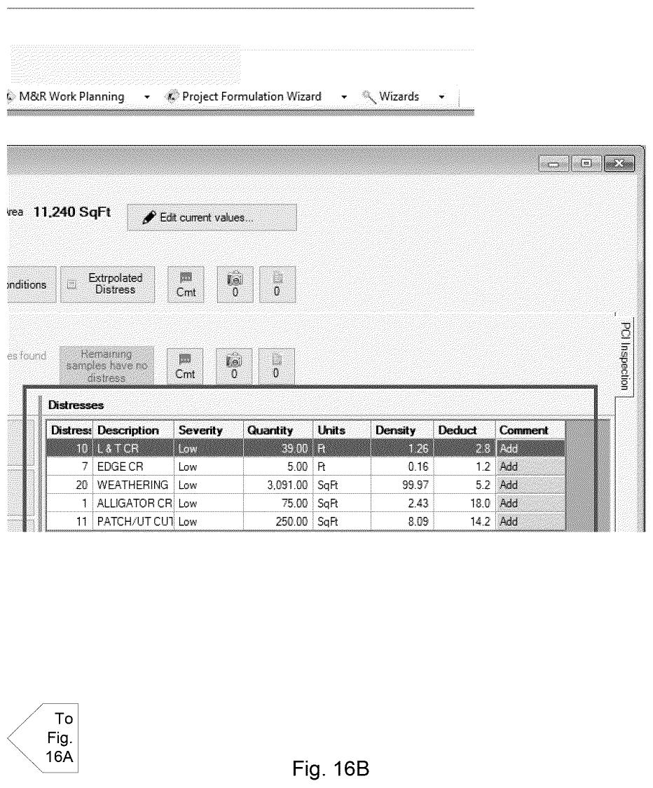

FIGS. 15A-15B shows the inventory window with the conditions/families tab selected and condition indices radio button is selected.

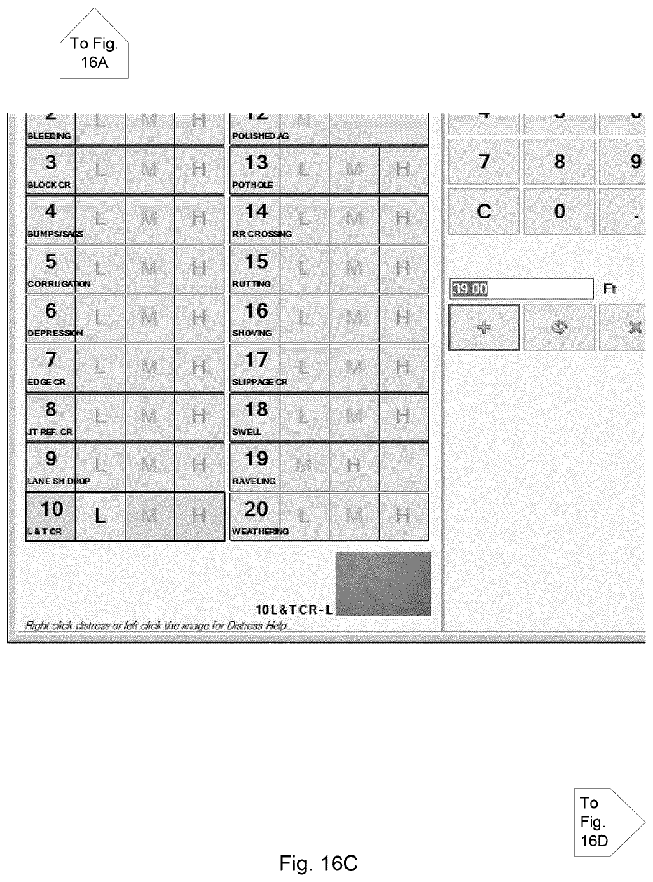

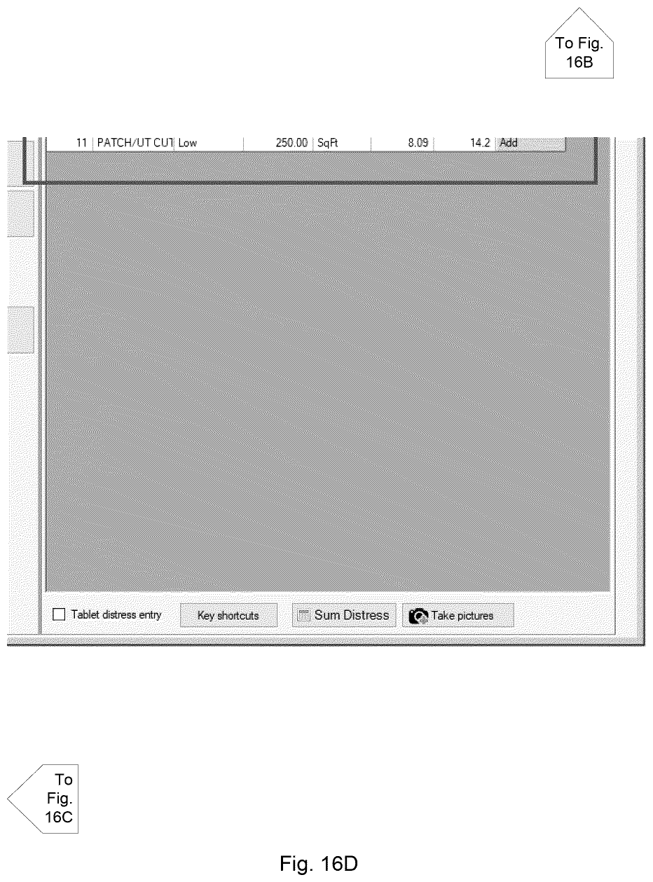

FIGS. 16A-16D shows an inspection window of the inspection submenu.

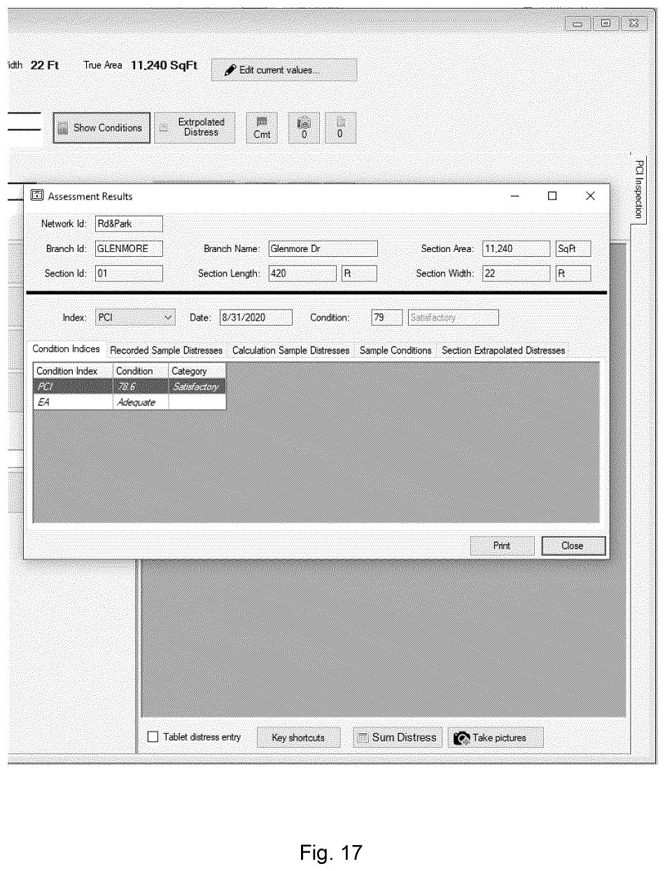

FIG. 17 shows a window called or displayed when the show conditions button is clicked.

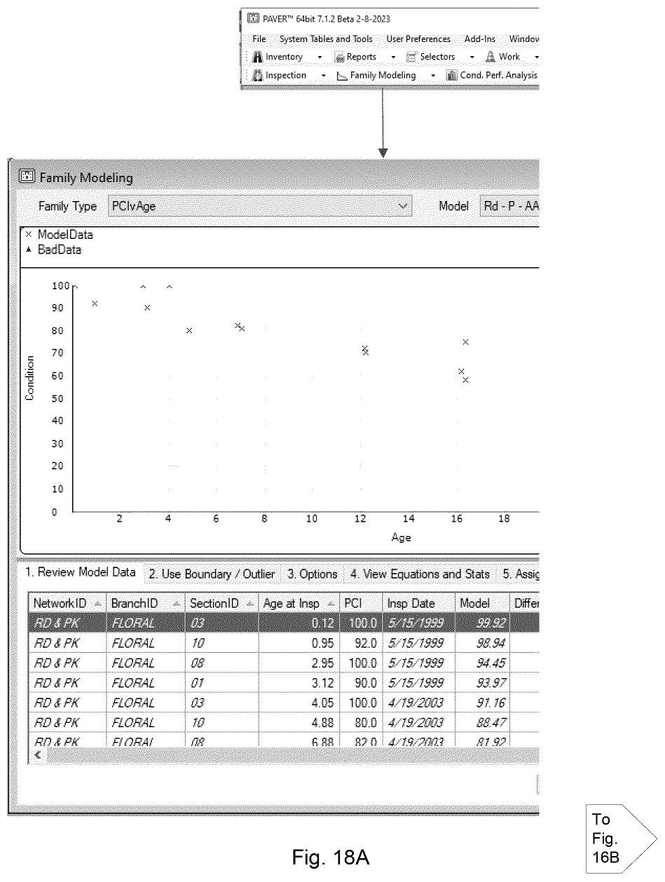

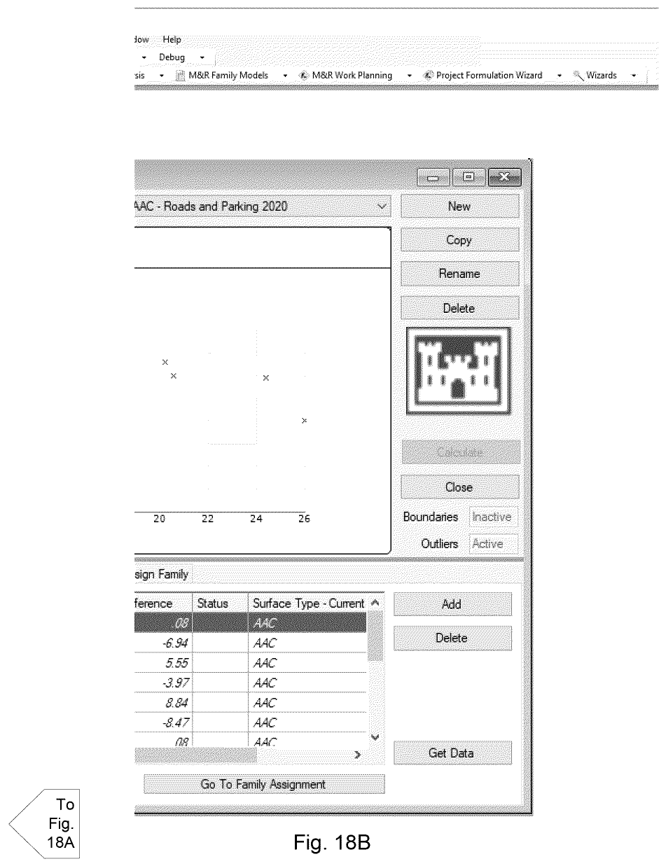

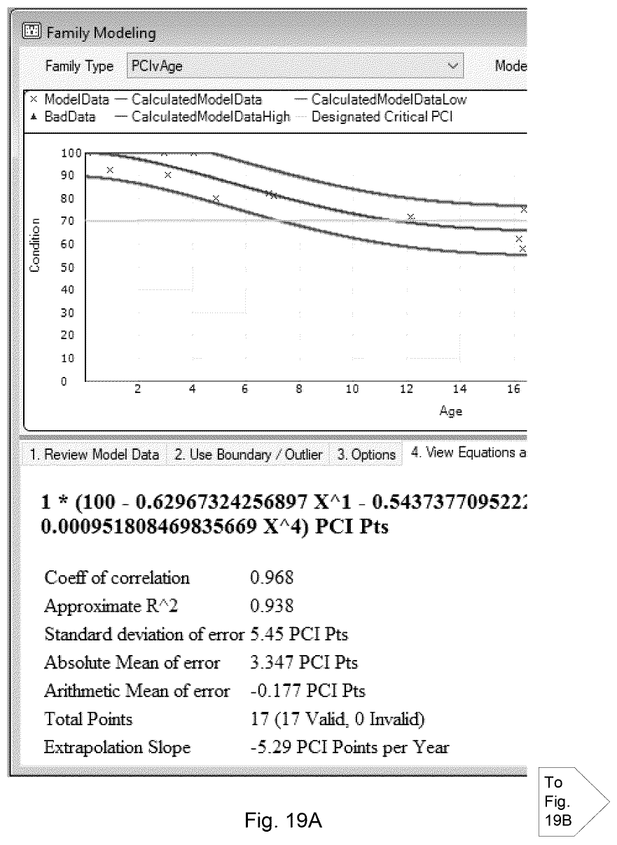

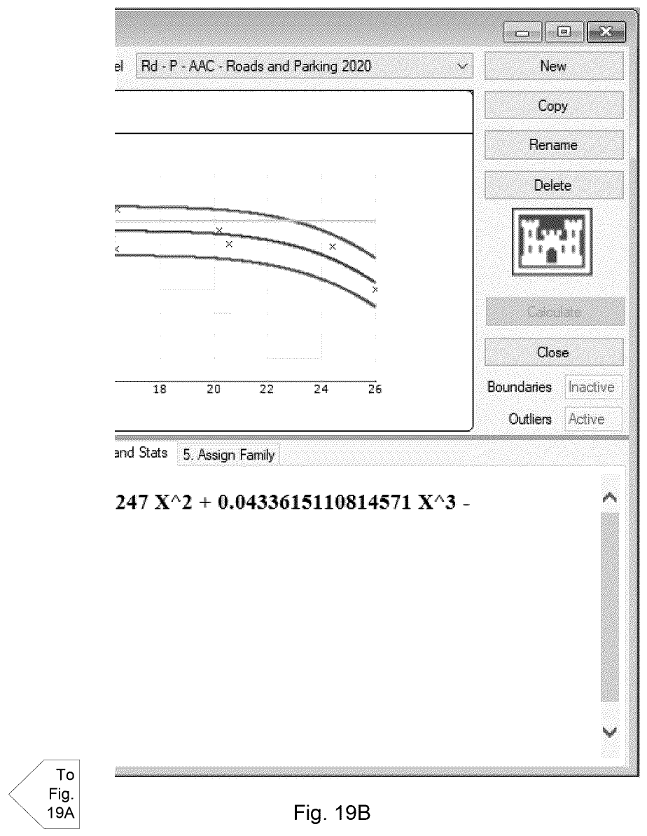

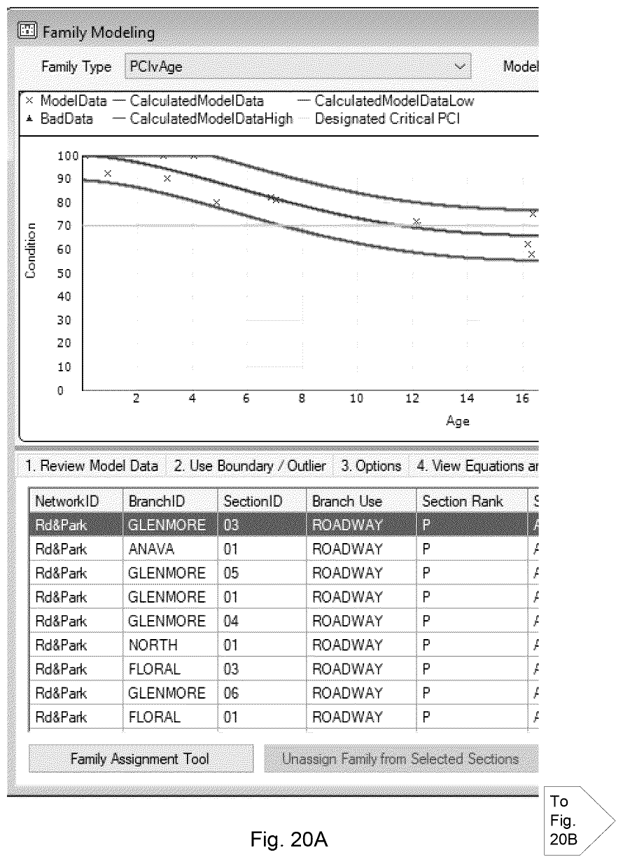

FIGS. 18A and 18B show a PCI Family Models (PF) window.

FIGS. 19A and 19B show the PCI family model window with the view equations and stats tab selected.

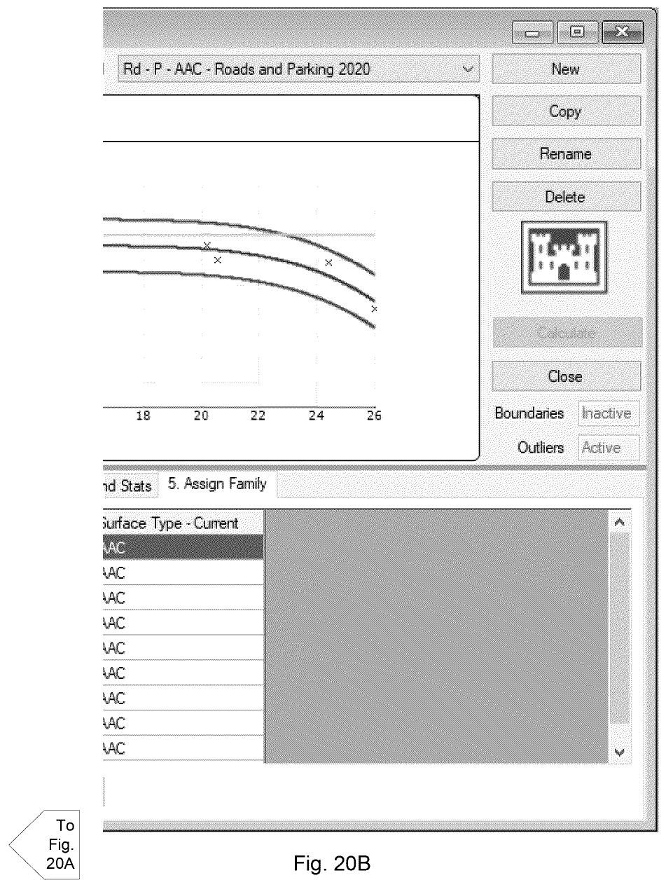

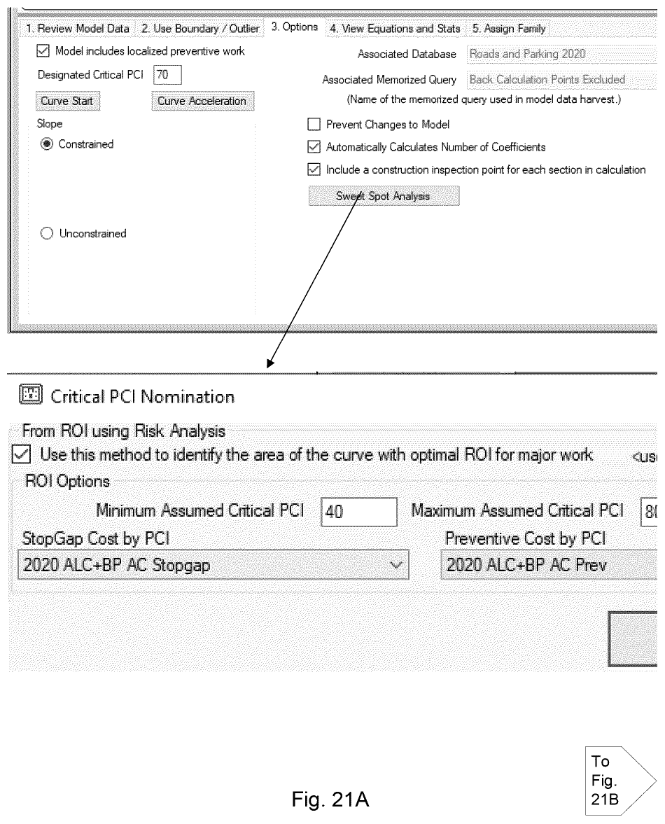

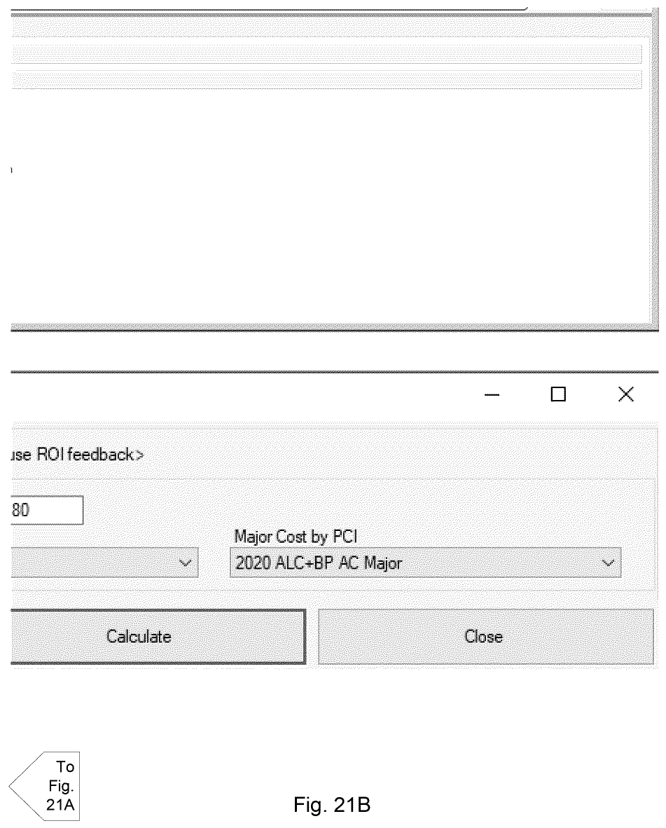

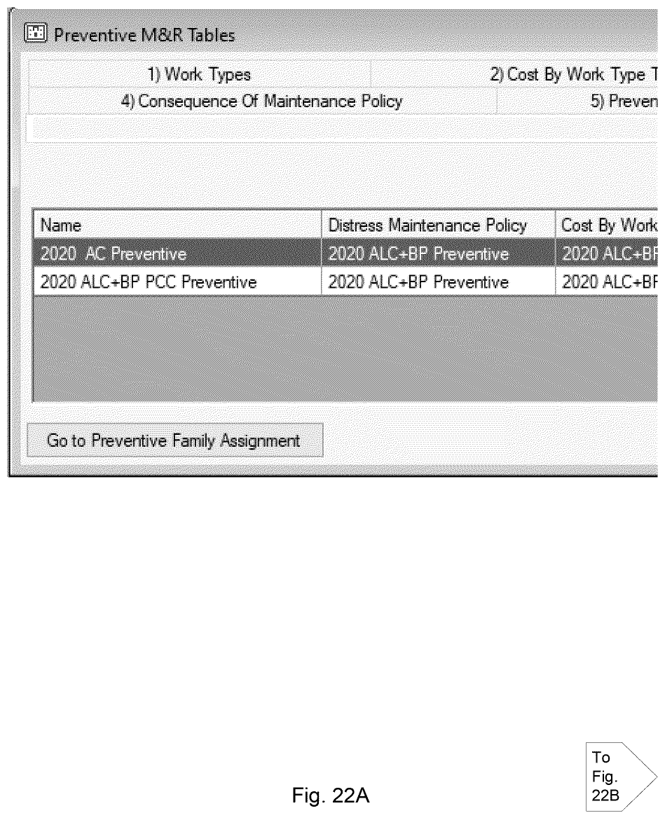

FIGS. 20A and 20B show the PCI family model window with the Assign Family tab selected.

FIGS. 21A and 21B show the options tab with additional detail regarding Critical PCI Nomination.

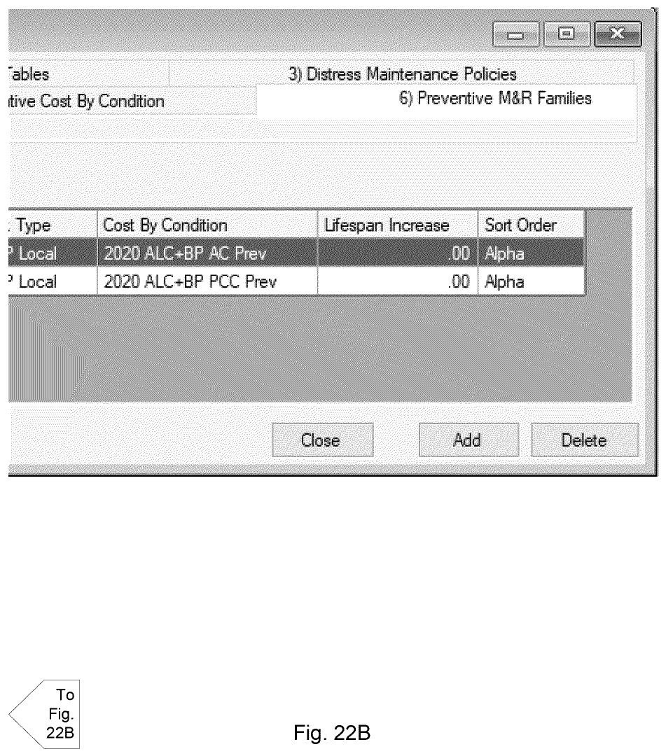

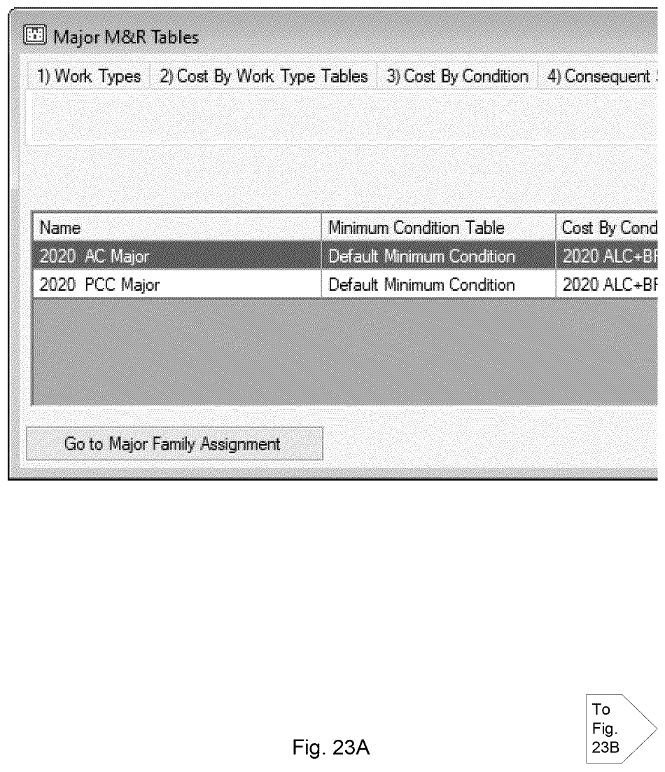

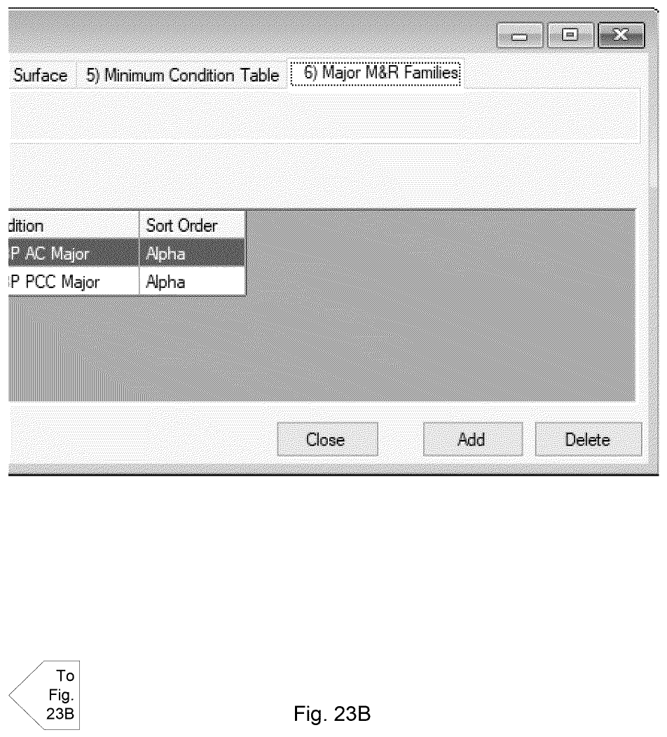

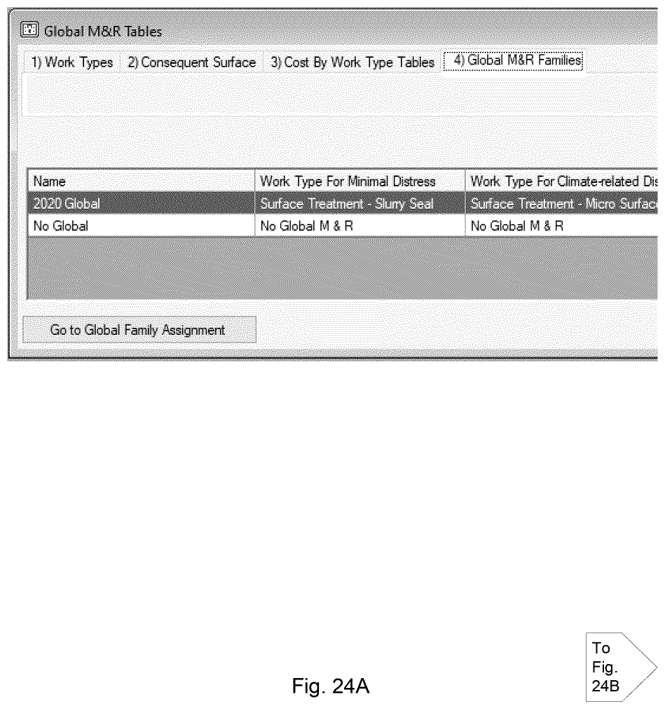

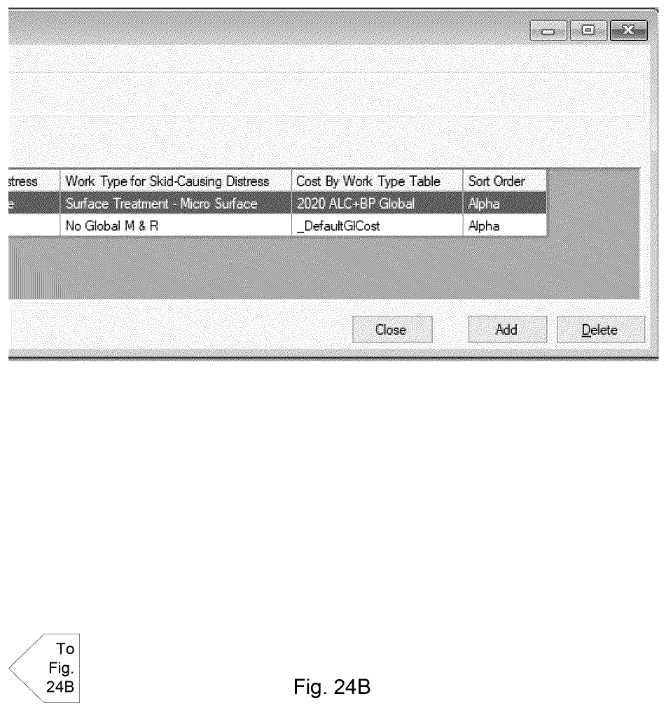

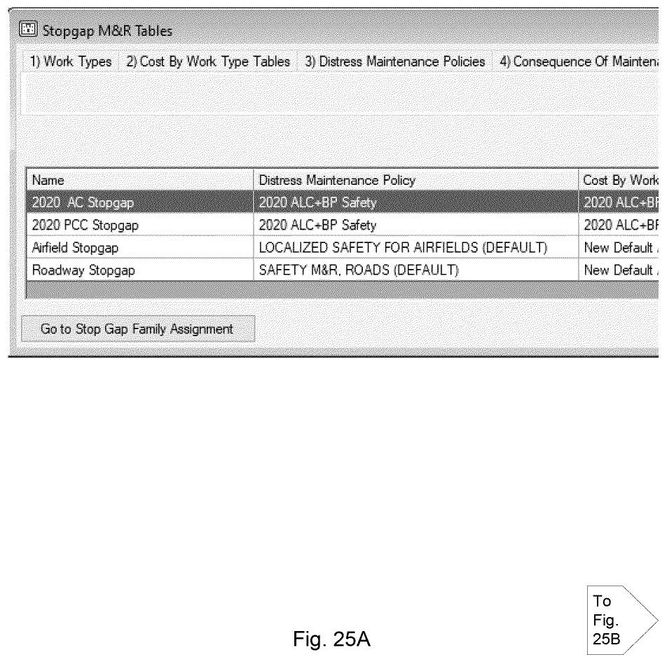

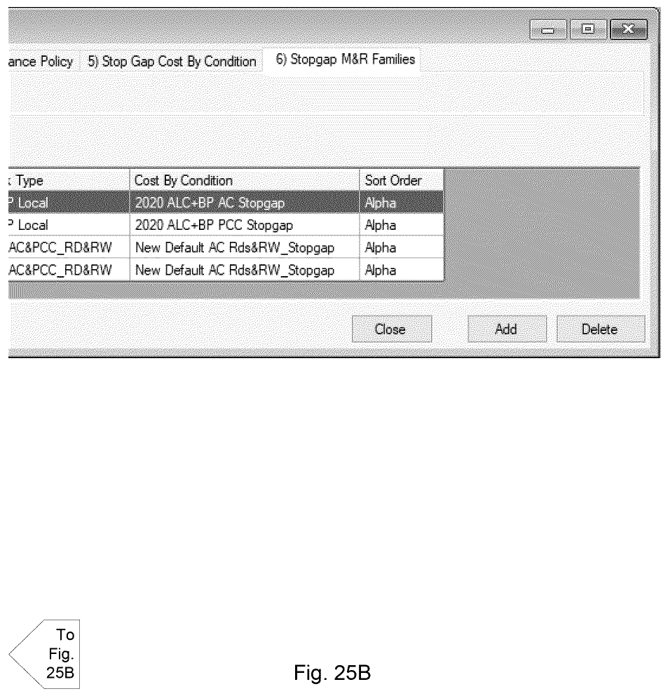

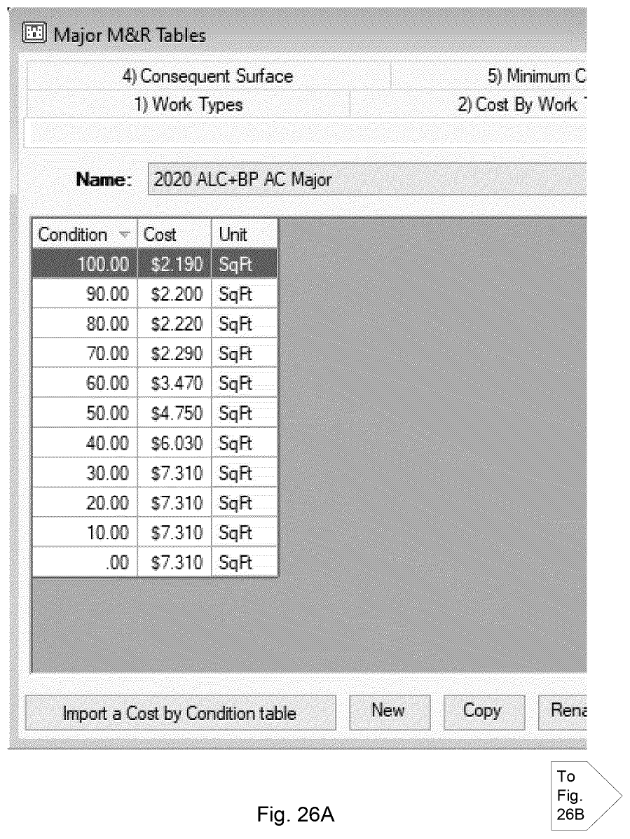

FIGS. 22A-22B, 23A-23B, 24A-24B, 25A-25B show examples of M&R Family windows.

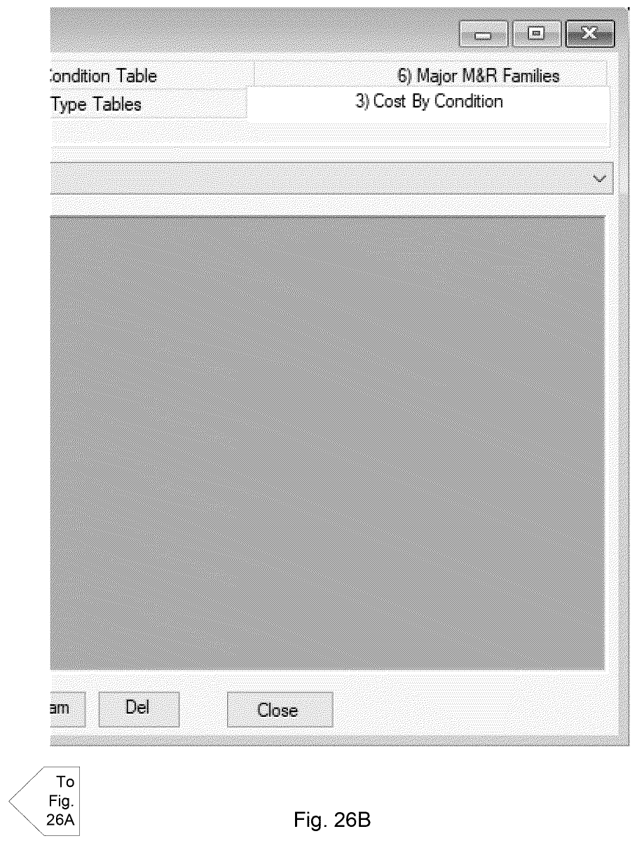

FIGS. 26A and 26B show a major M&R cost table window.

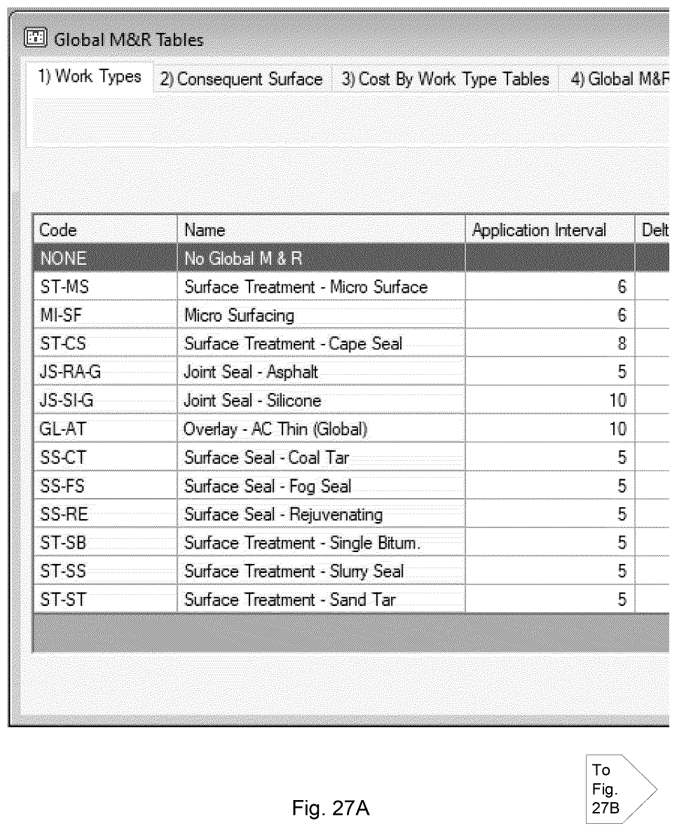

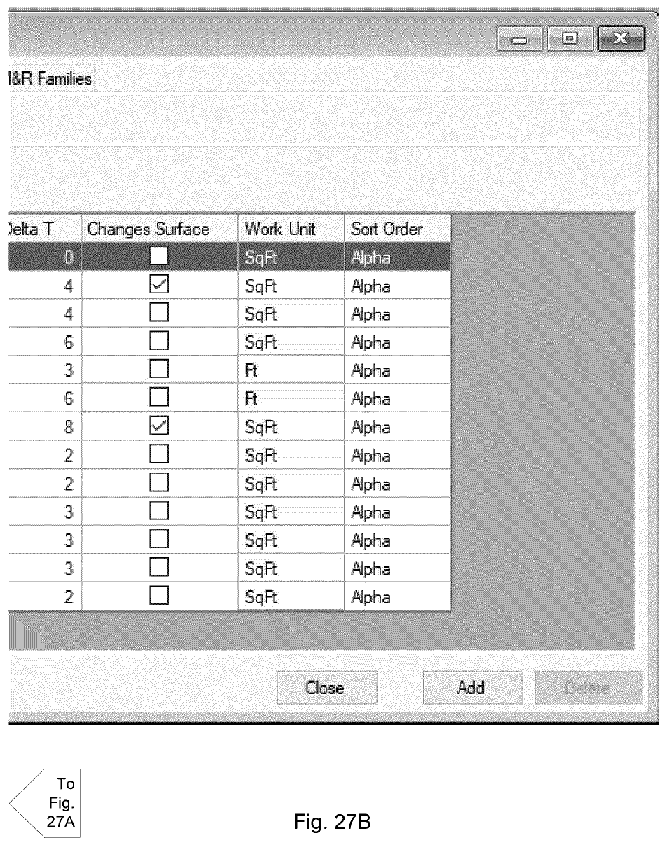

FIGS. 27A and 27B show a global M&R work type window.

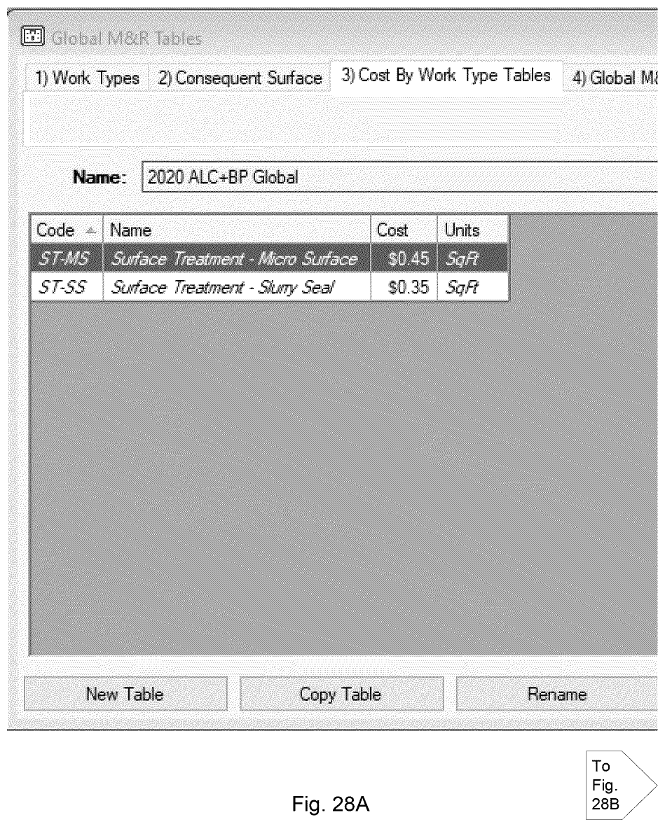

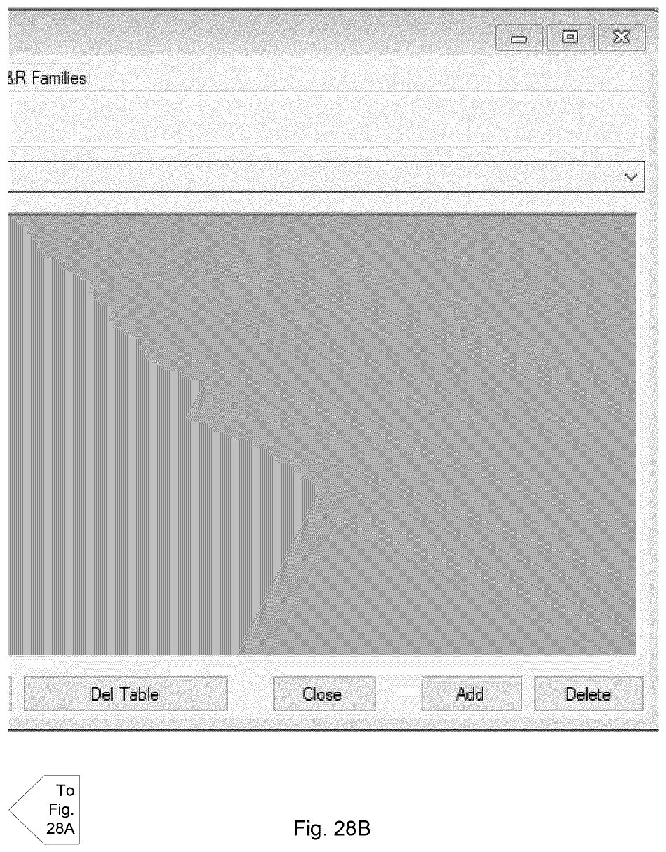

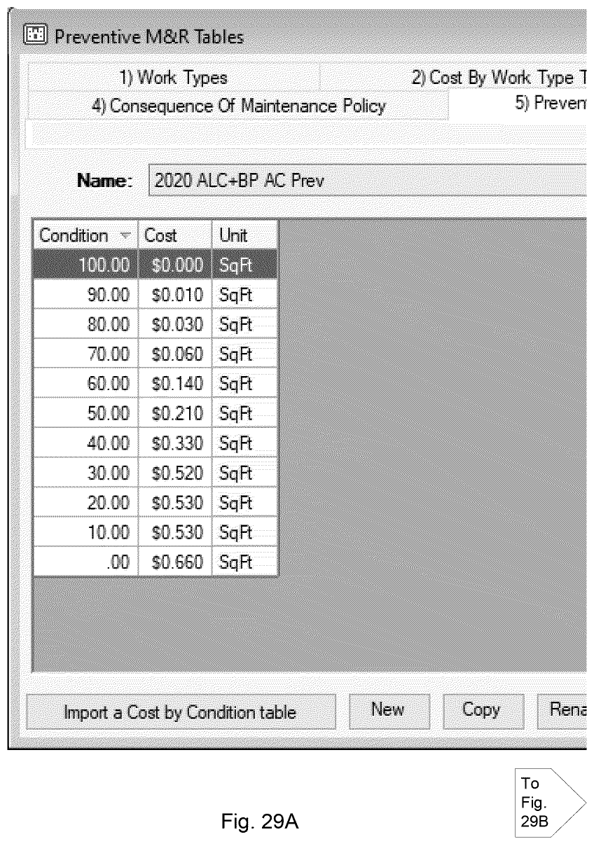

FIGS. 28A and 28B show a global work is priced by work types instead of condition.

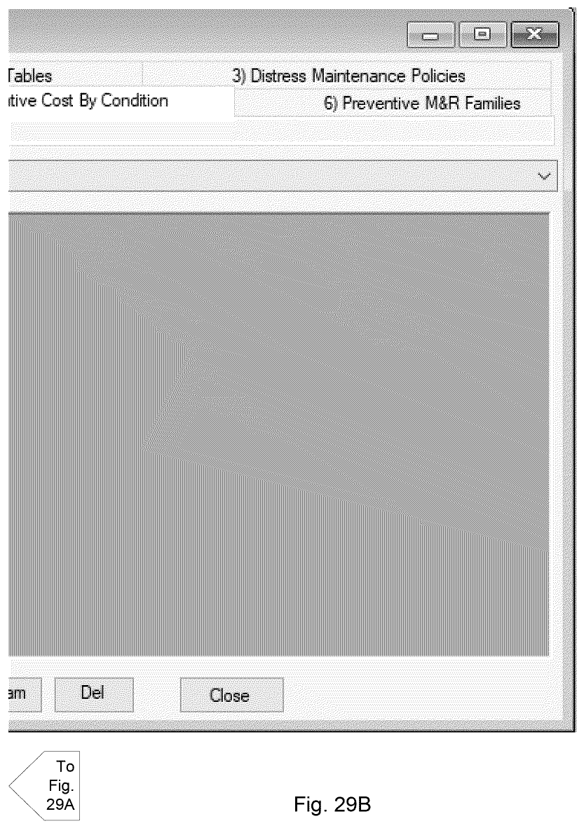

FIGS. 29A-29B shows a window for preventative cost by condition.

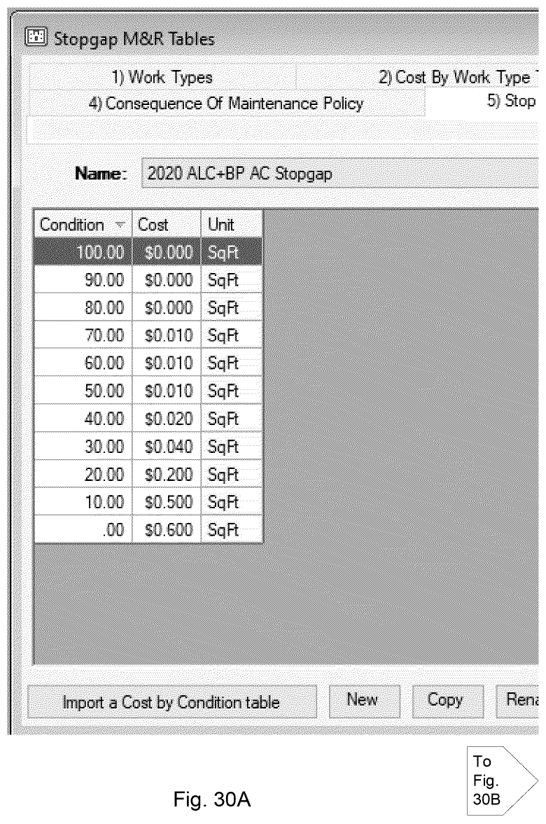

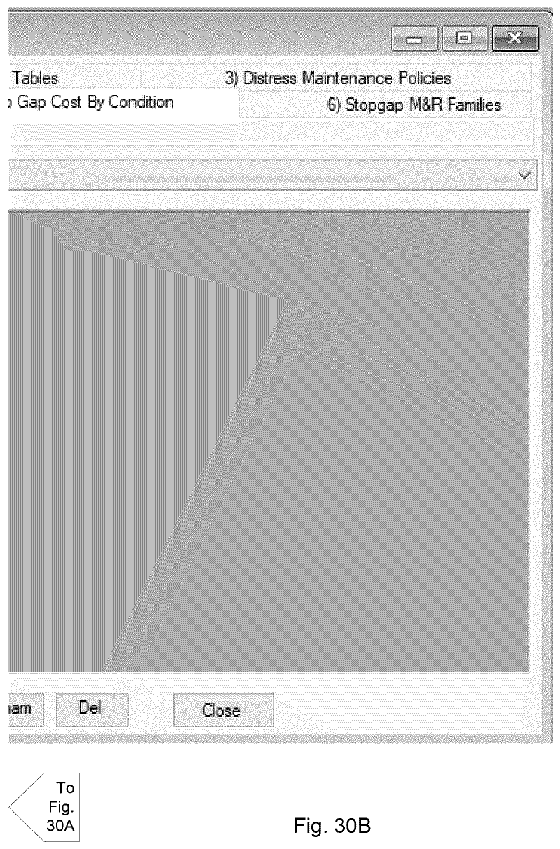

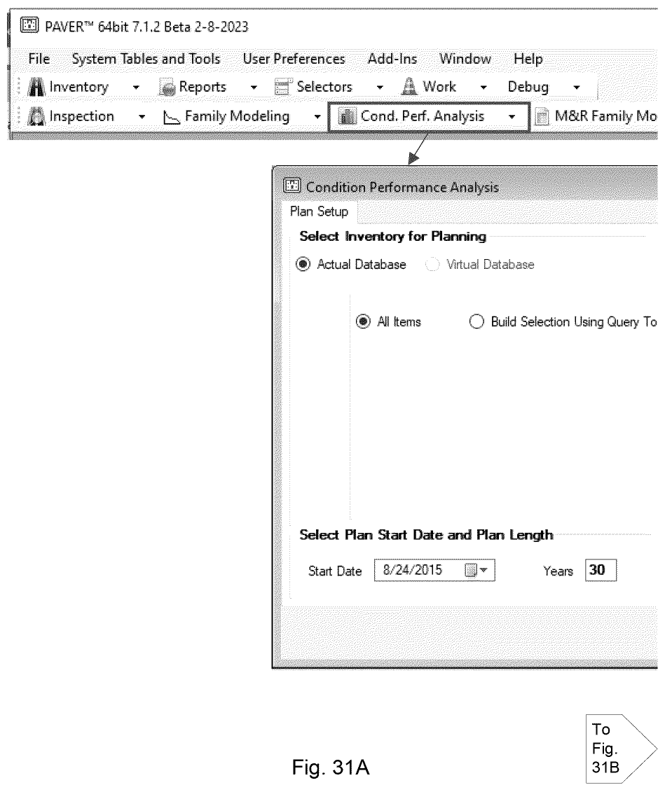

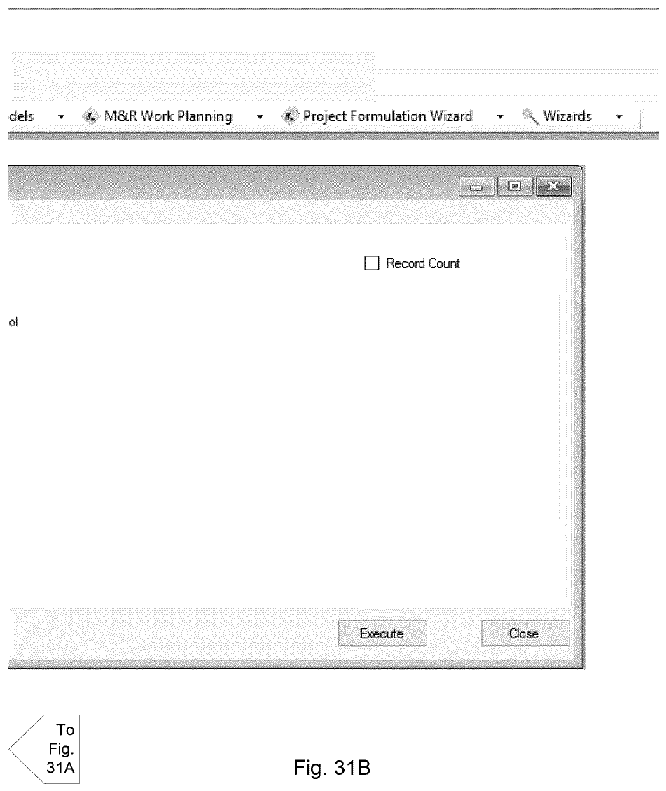

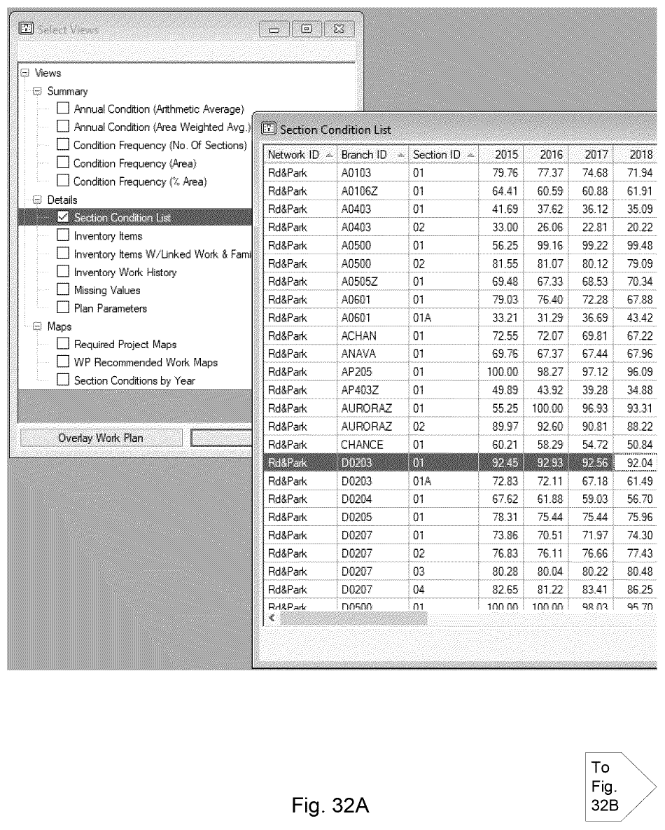

FIGS. 30A-30B shows a window for stopgap cost by condition.

FIGS. 31A-31B shows a condition performance analysis window.

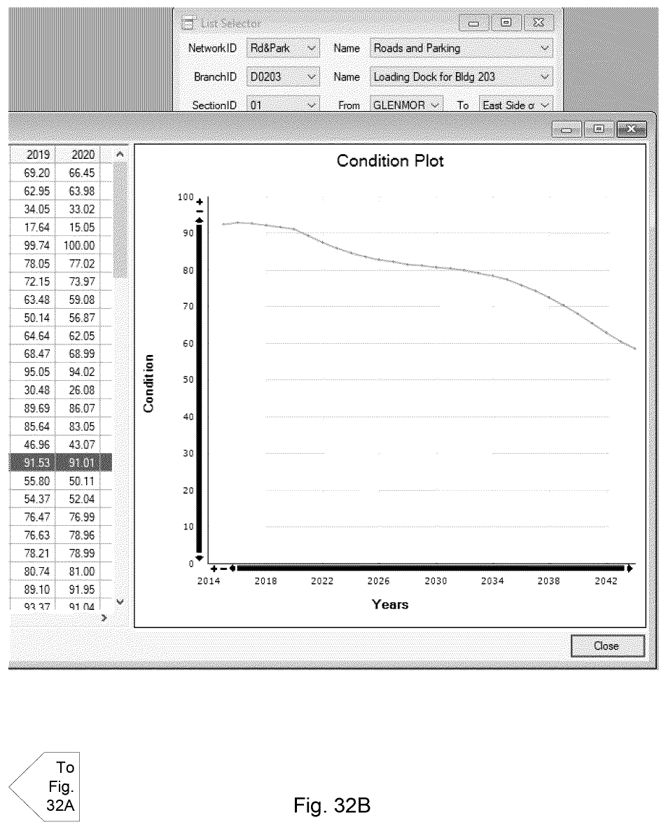

FIGS. 32A-32B shows a section condition list associated with the condition performance analysis window.

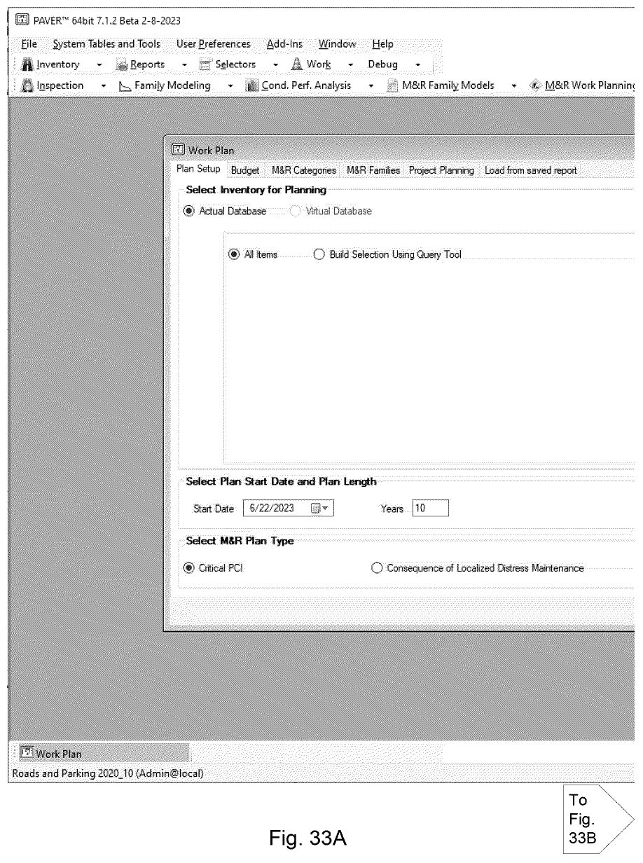

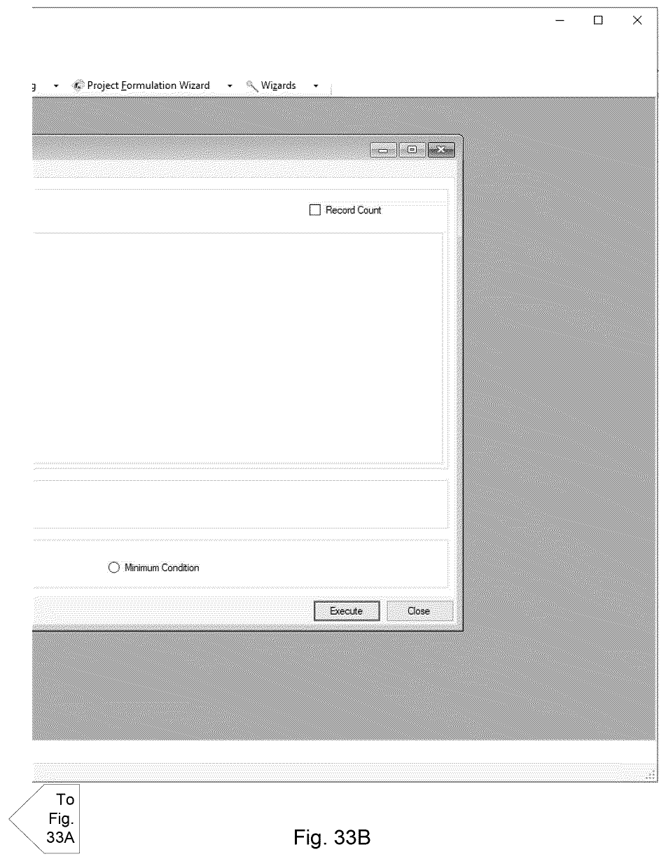

FIGS. 33A-33B shows a work plan analysis window.

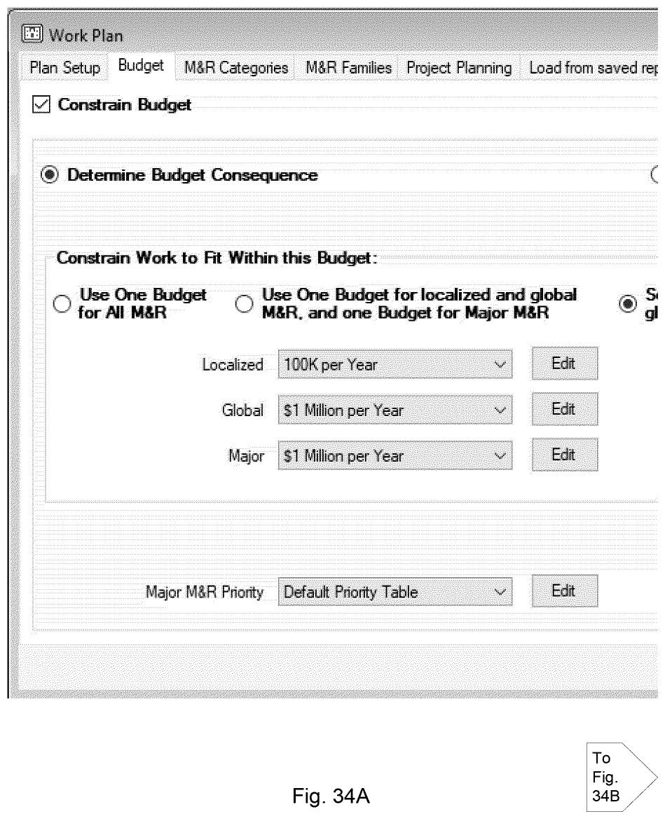

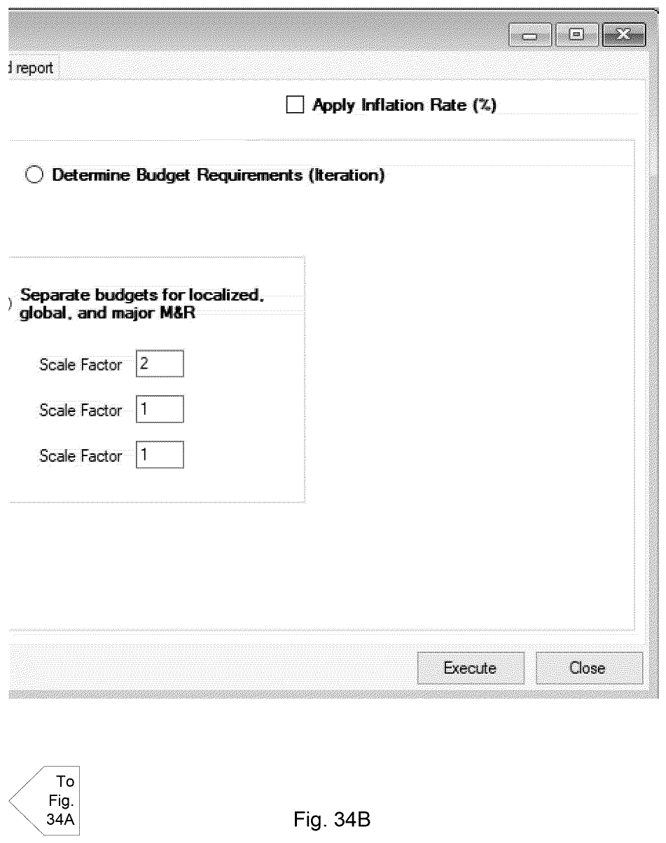

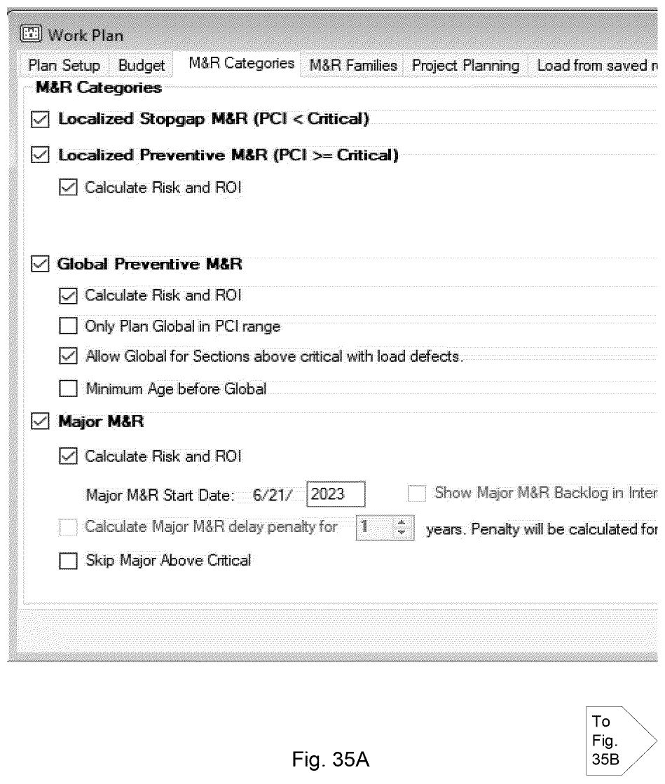

FIGS. 34A-34B shows a work plan analysis window with a budget tab selected.

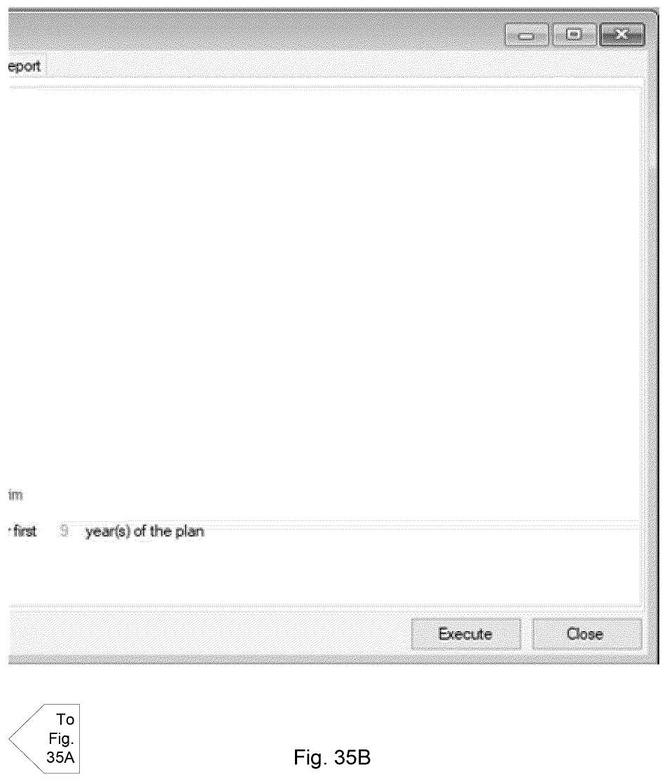

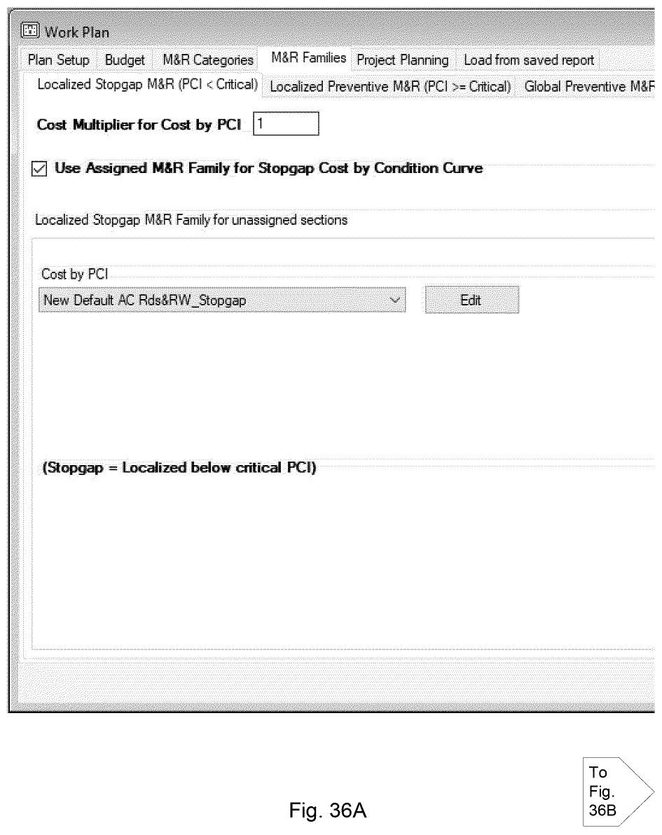

FIGS. 35A-35B shows a work plan analysis window with the M&R Categories tab selected; this includes settings for risk calculation.

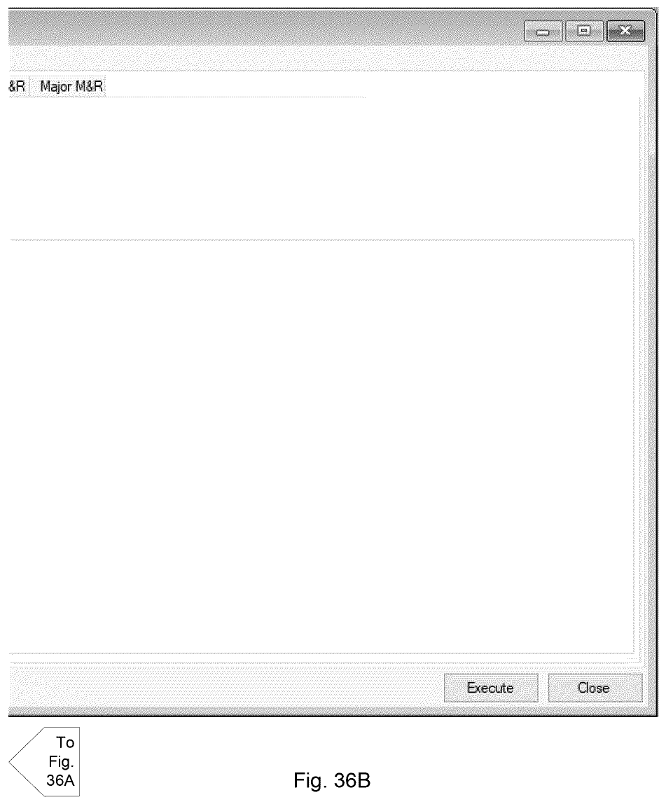

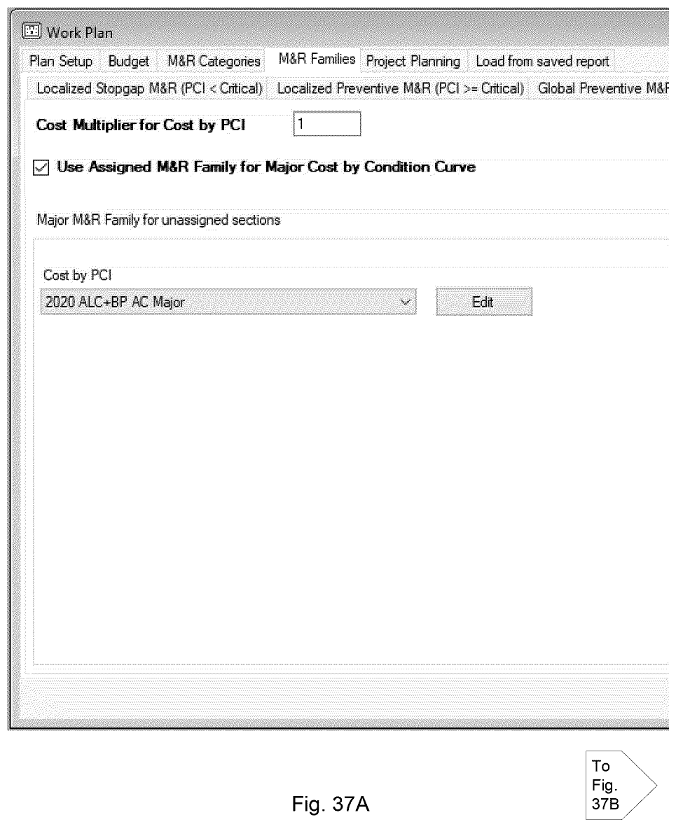

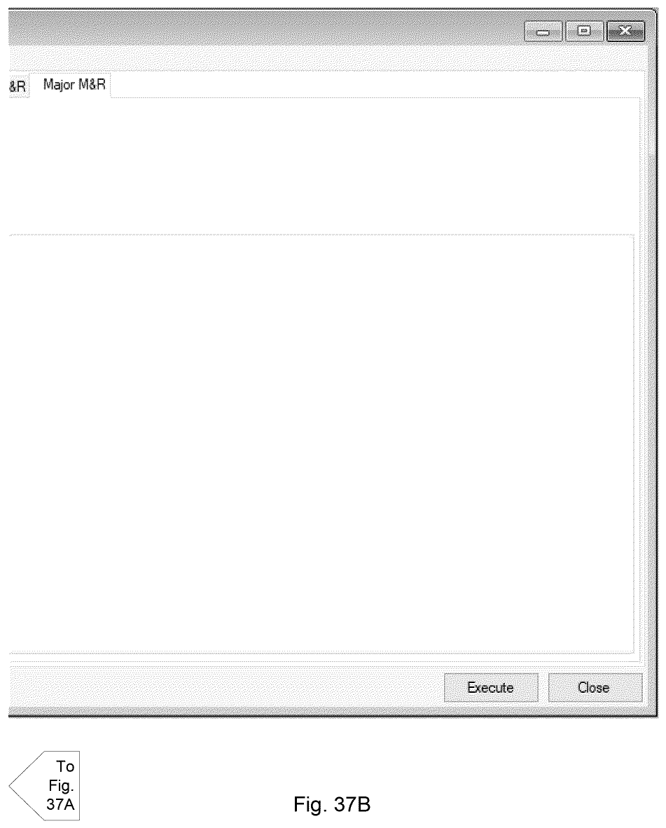

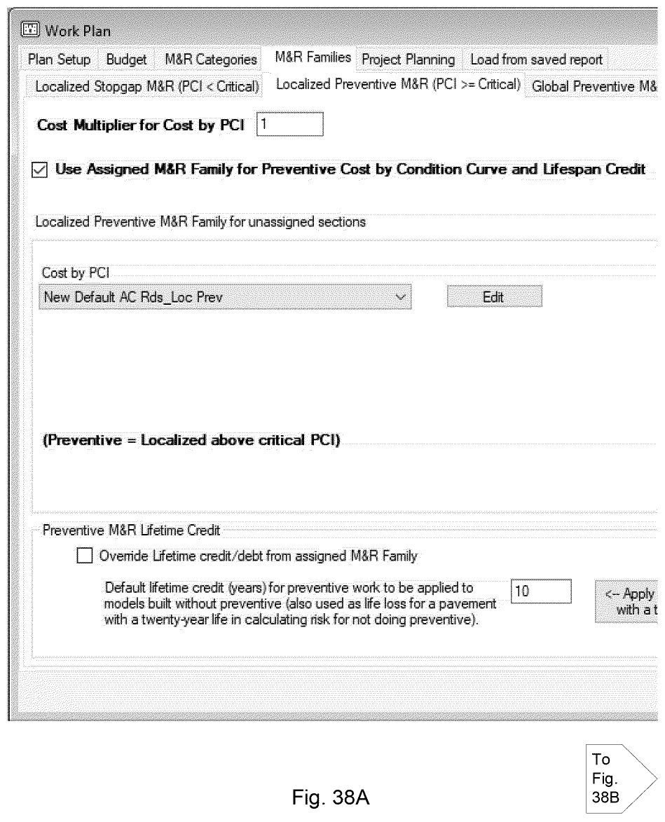

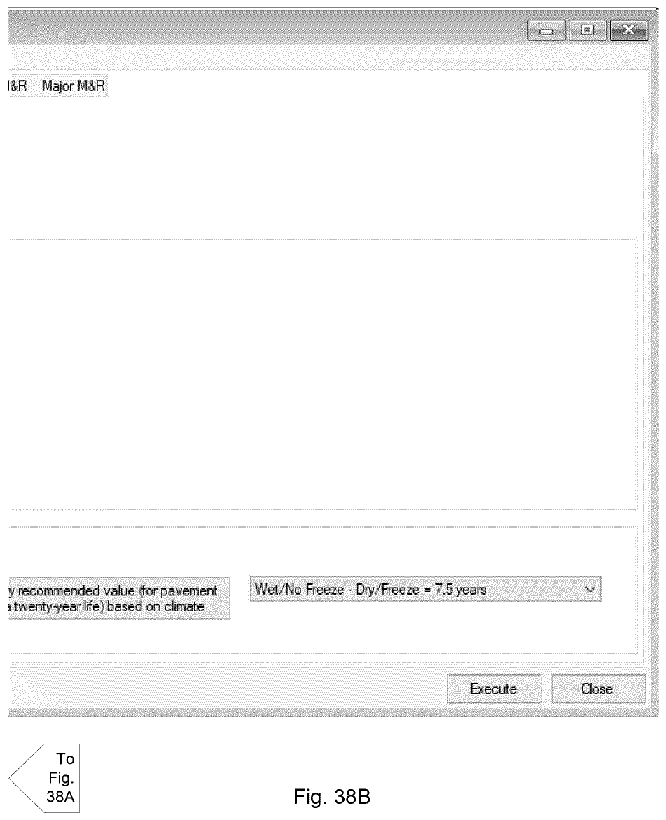

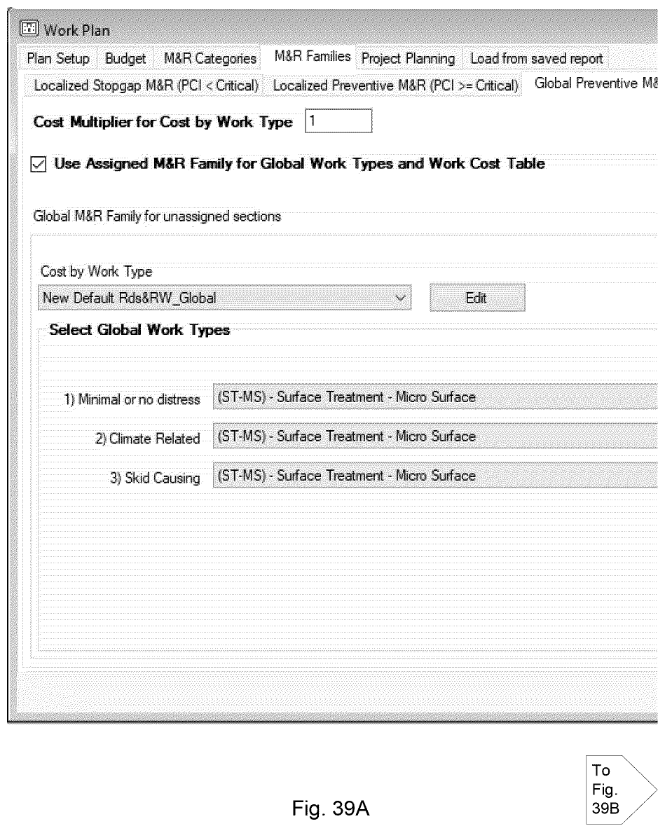

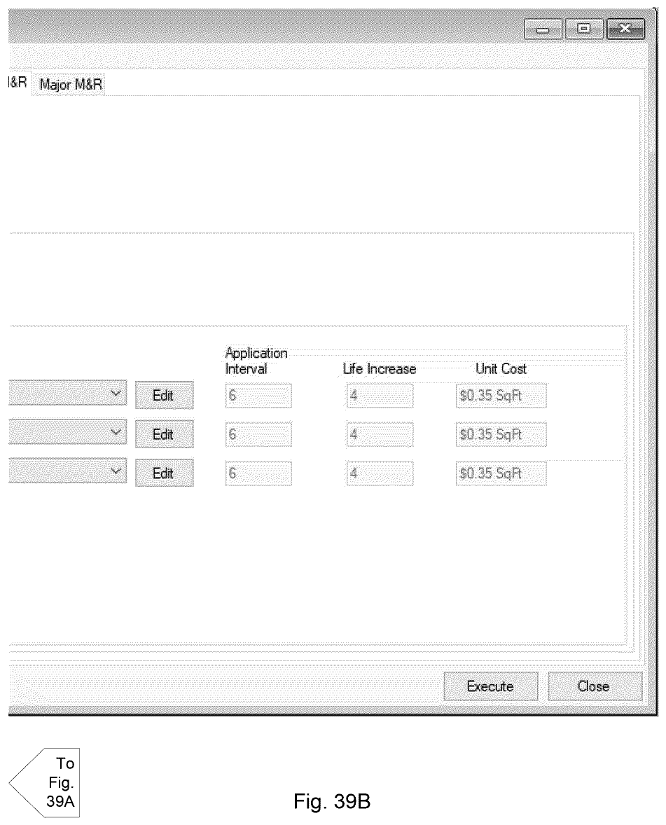

FIGS. 36A-36B, 37A-37B, 38A-38B and 39A-39B show risk calculation tabs

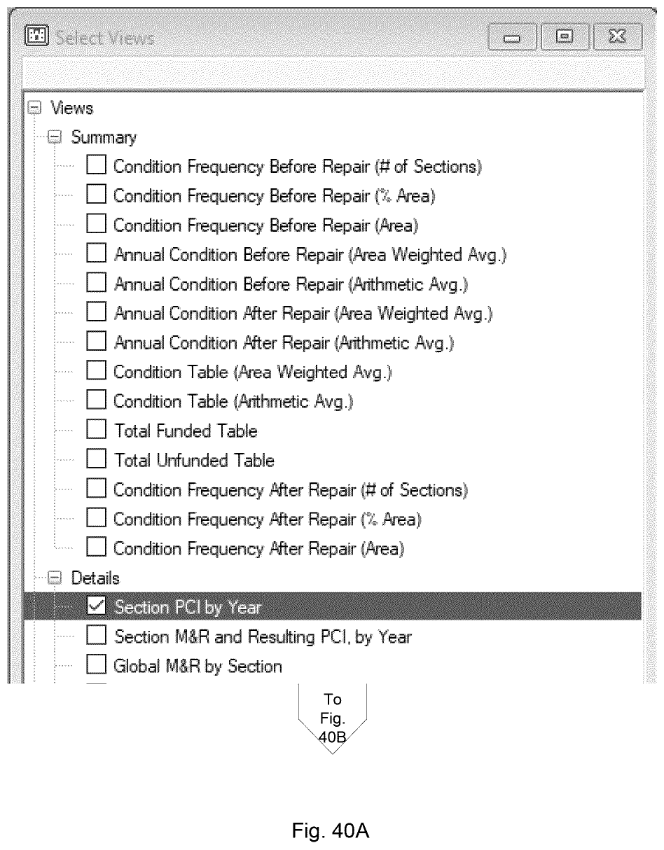

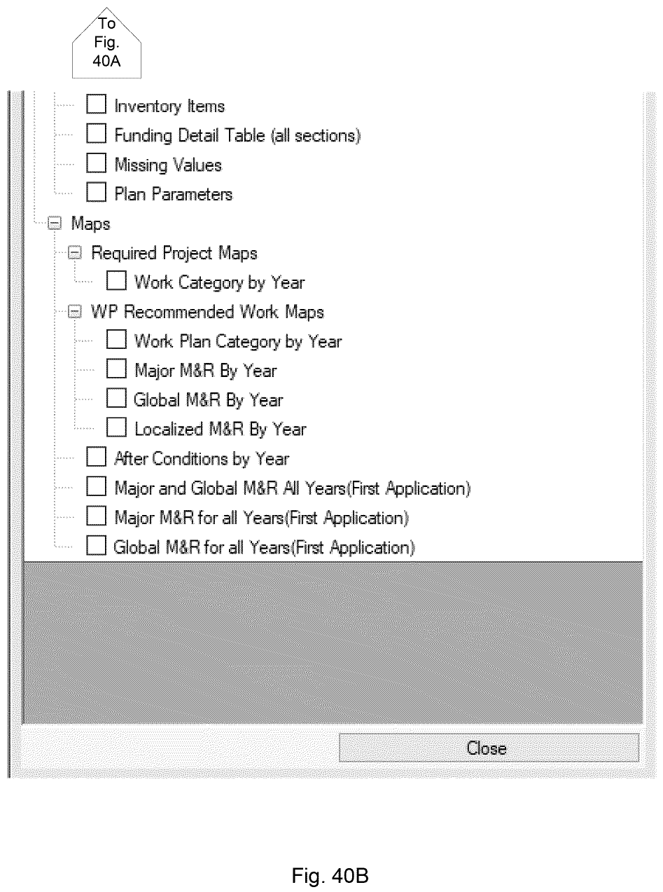

FIGS. 40A-40B show a results selection tool configured to cause pavement management application (PMA) to display a work plan result window such as a table, graph, map, menu, or display.

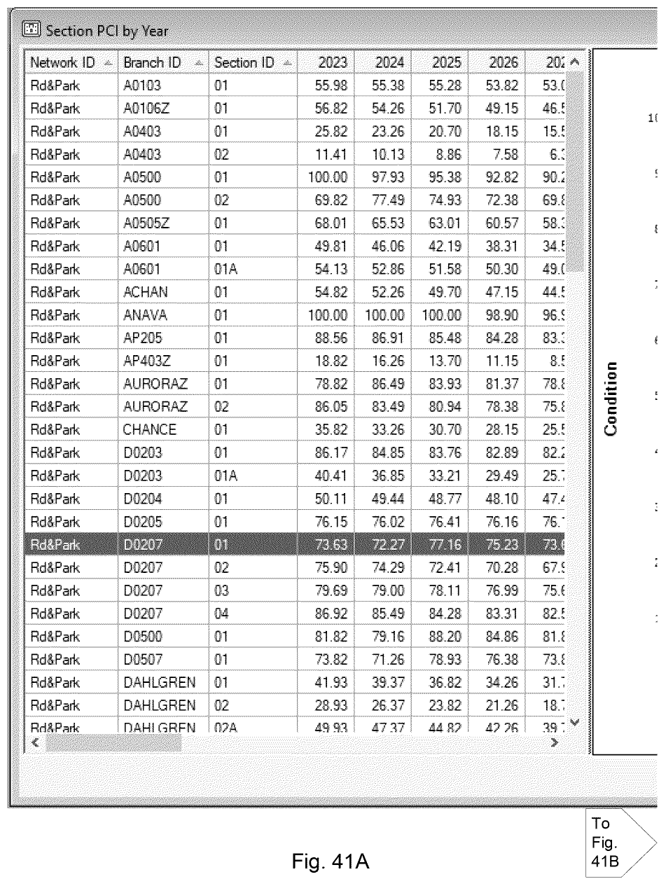

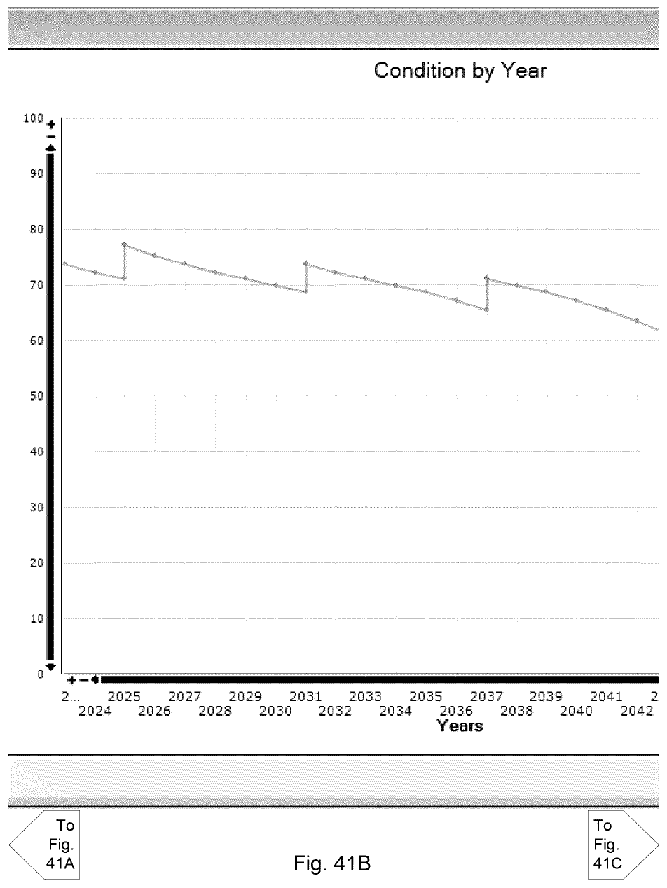

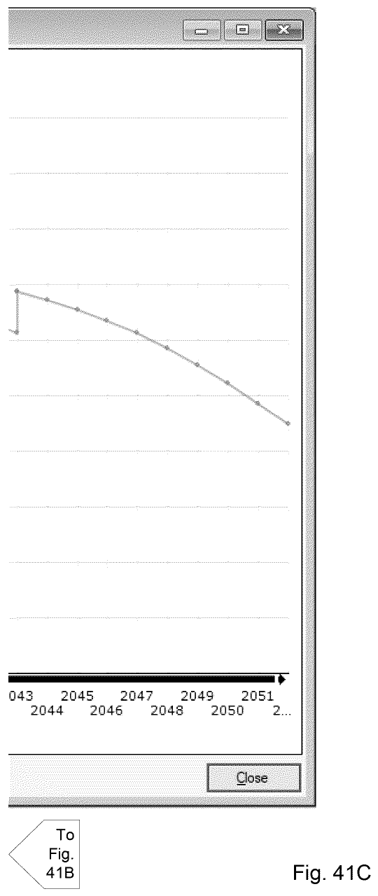

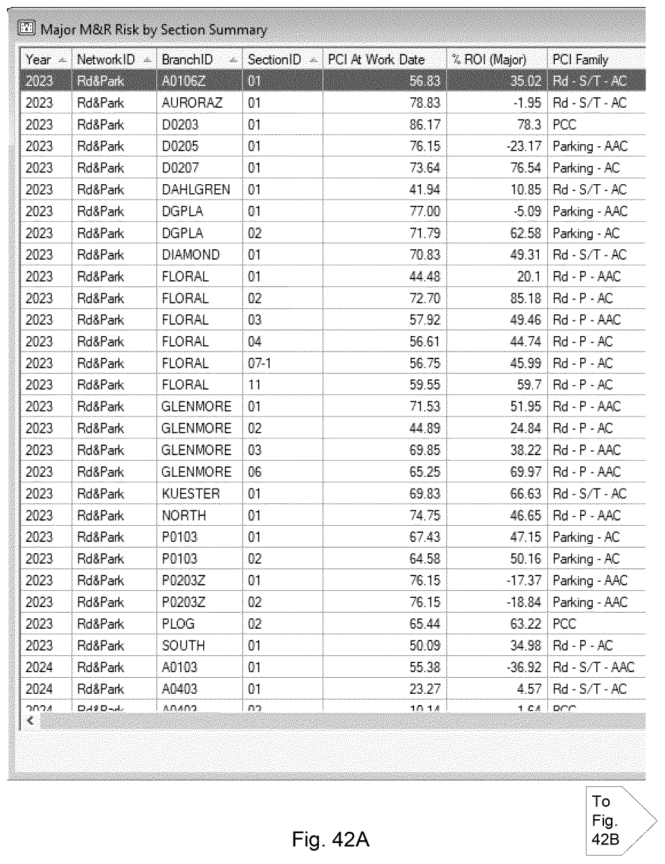

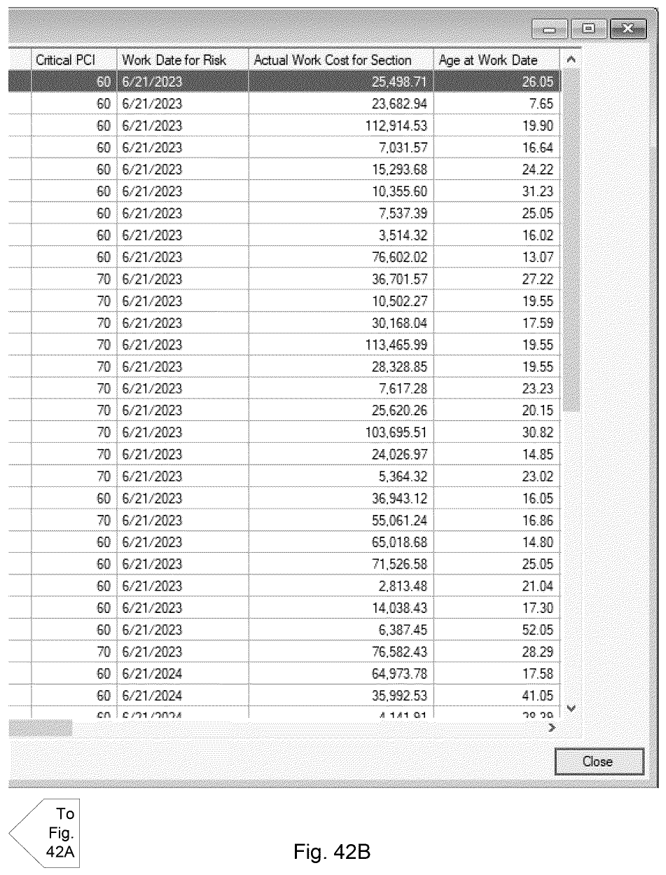

FIGS. 41A-41C show the results table Section PCI by Year table and graph.

FIGS. 42A-42B show a result window configured to display a major M&R risk by Section summary.

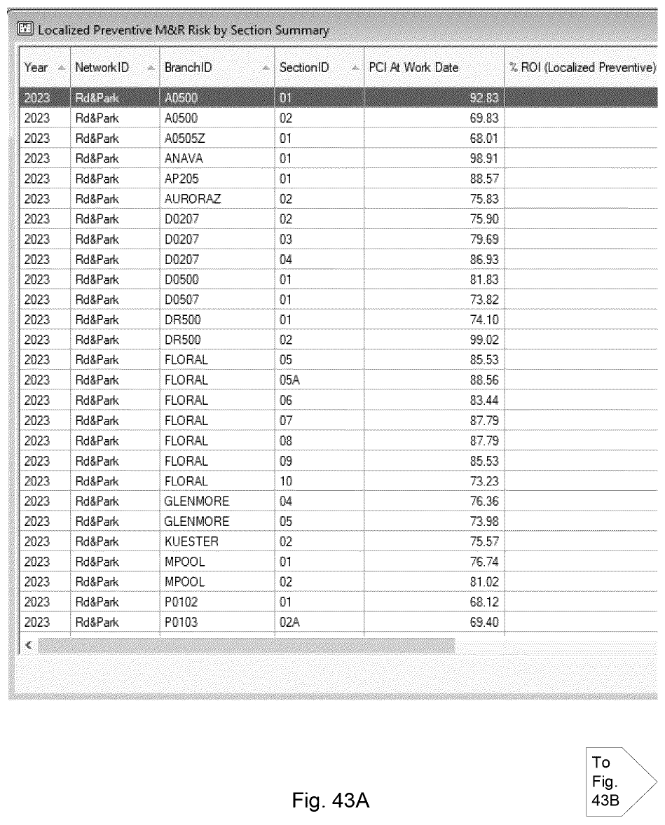

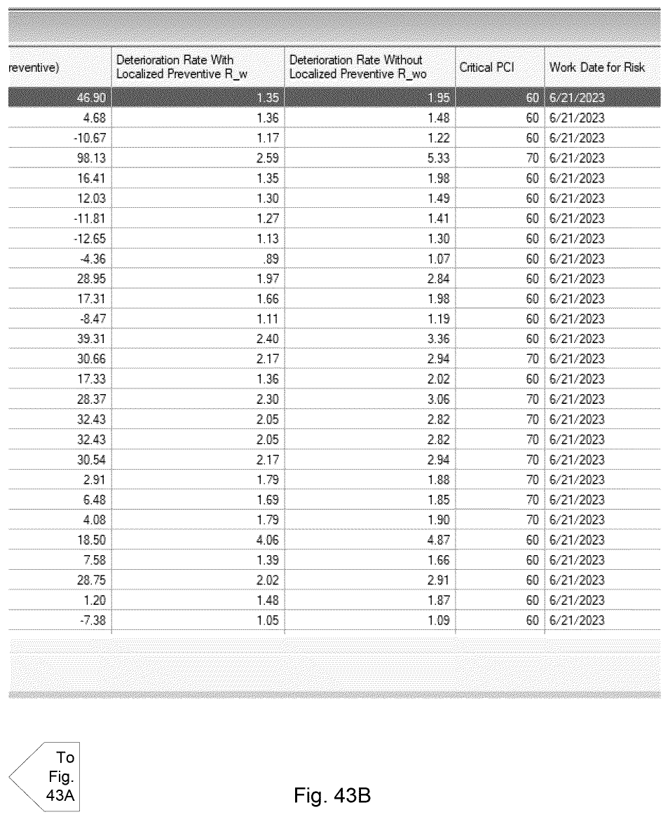

FIGS. 43A-43B show a result window configured to display a localized preventative M&R risk by section summary.

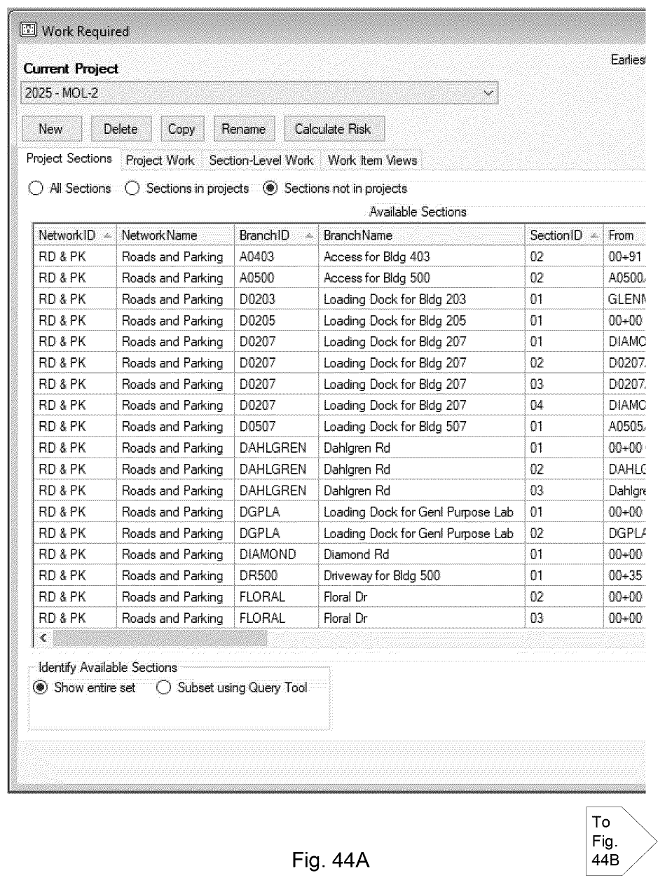

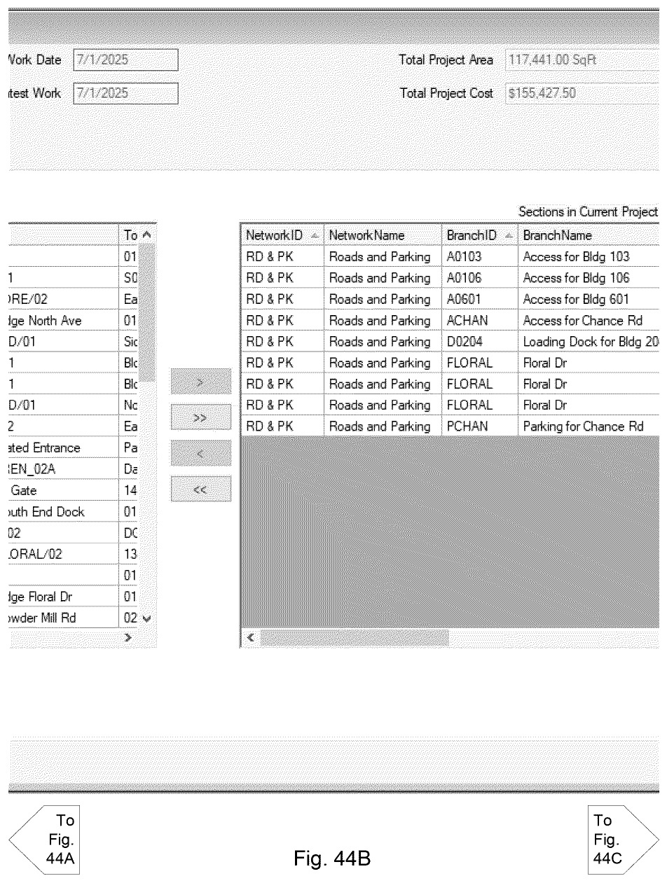

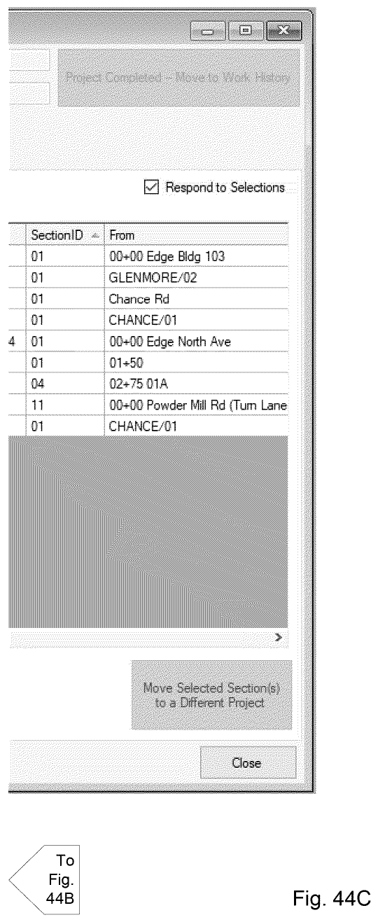

FIGS. 44A-44C show a project planning window.

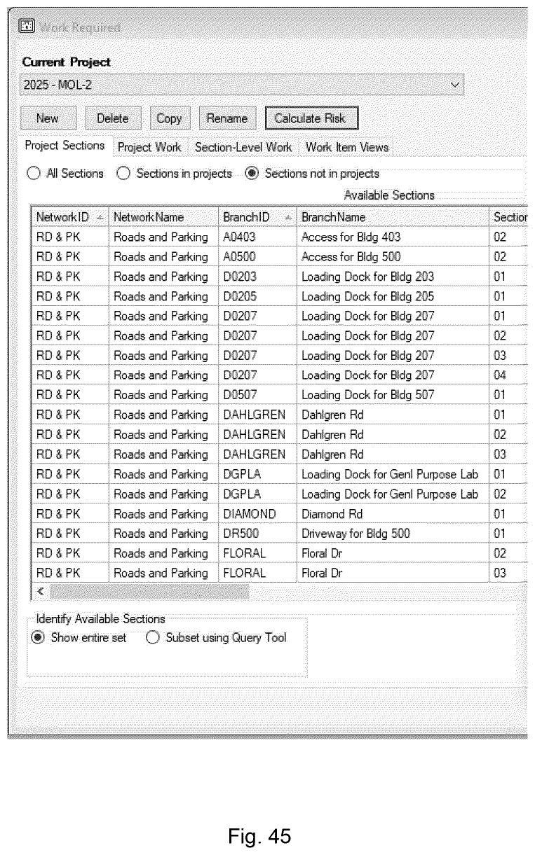

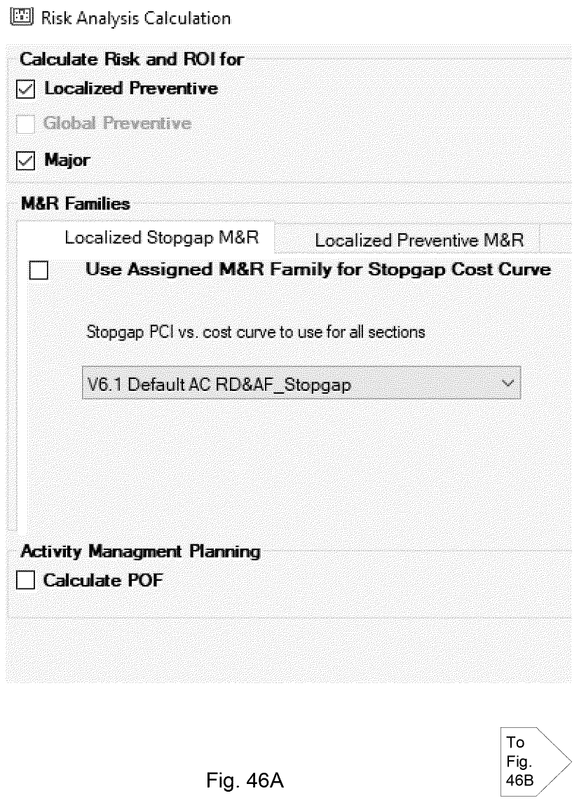

FIG. 45 shows a work required window.

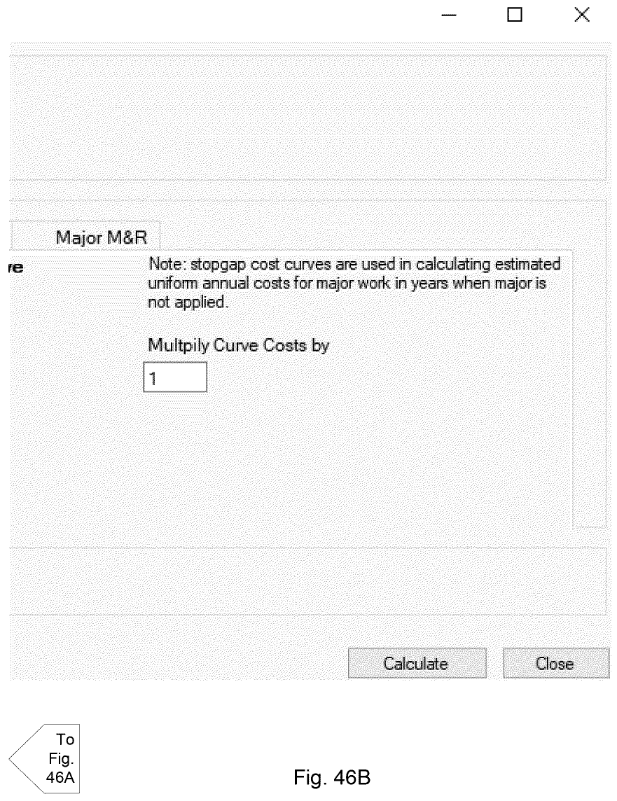

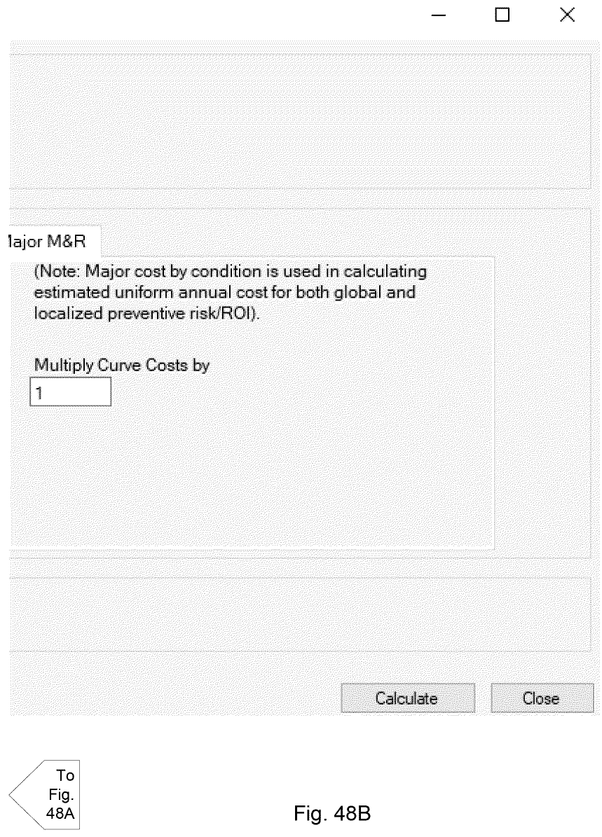

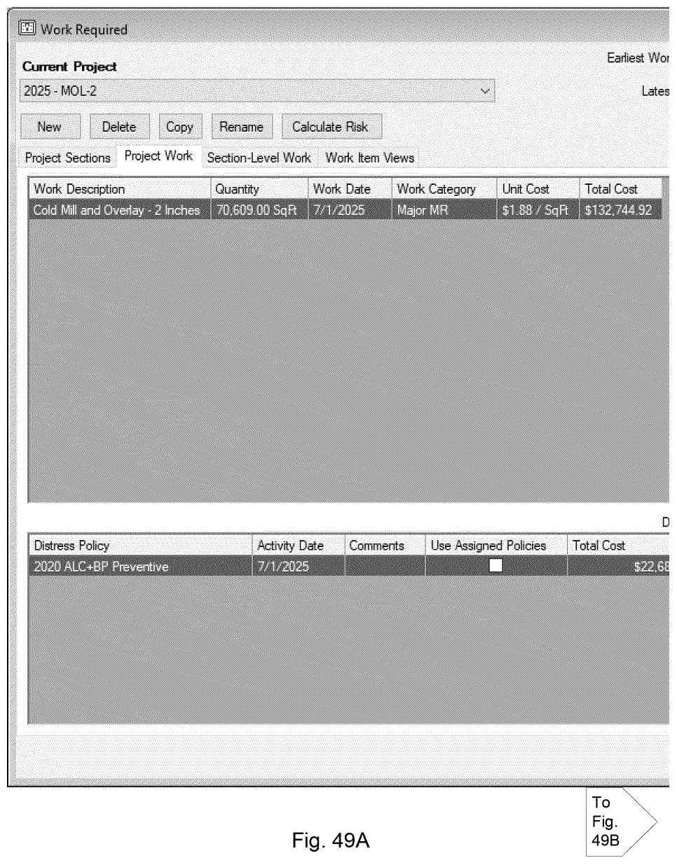

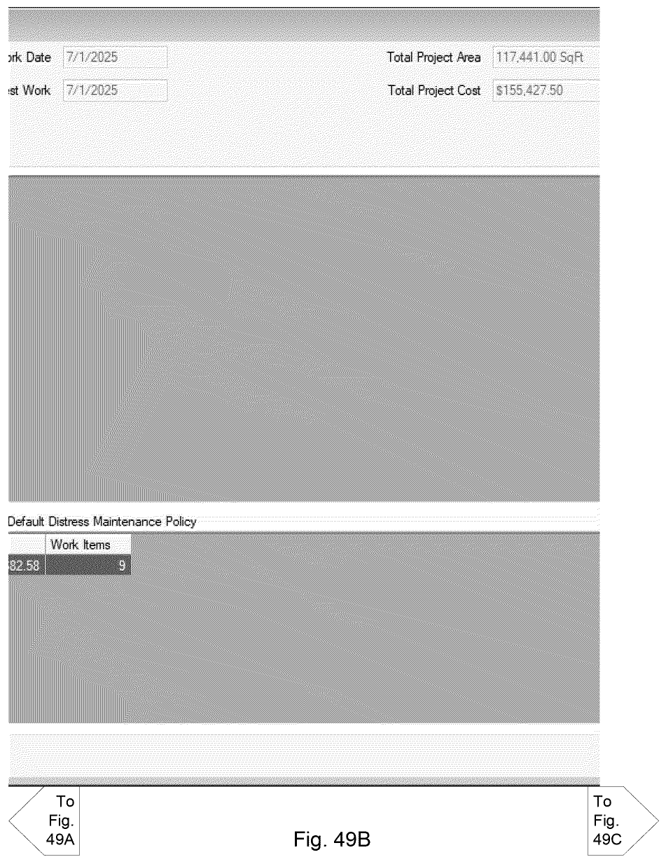

FIGS. 46A-46B, FIGS. 47A and 47B, and FIGS. 48A and 48B show additional risk calculation input windows.

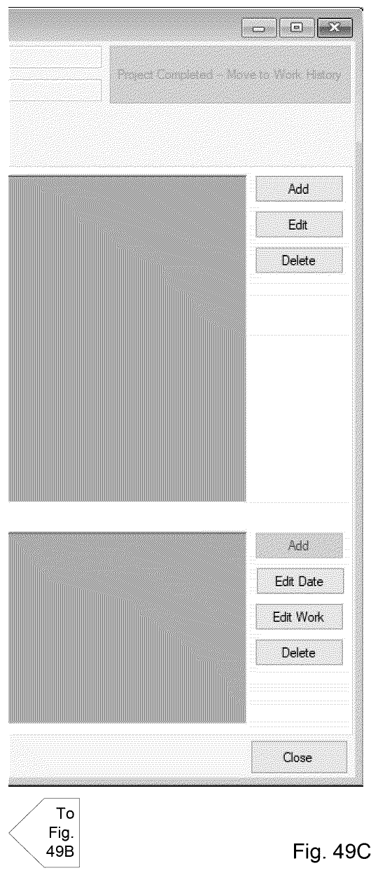

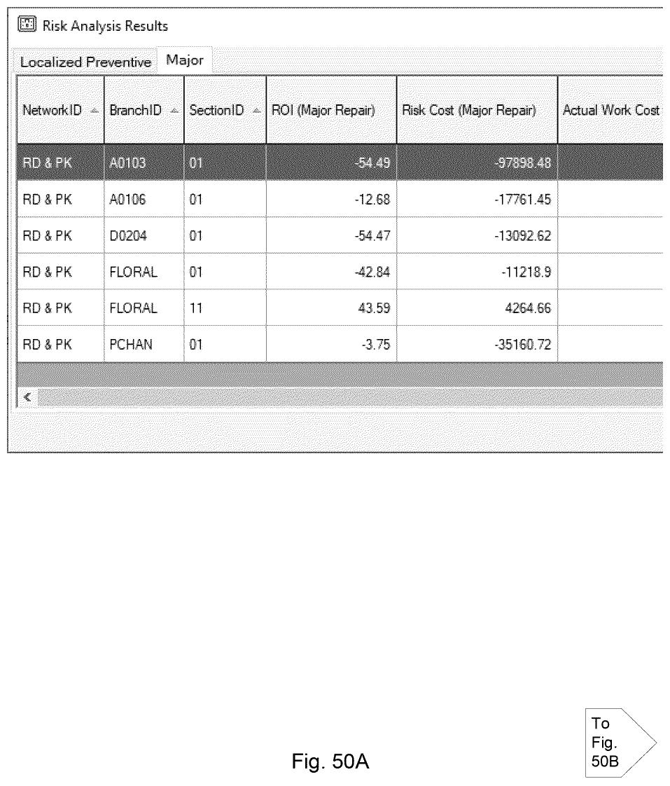

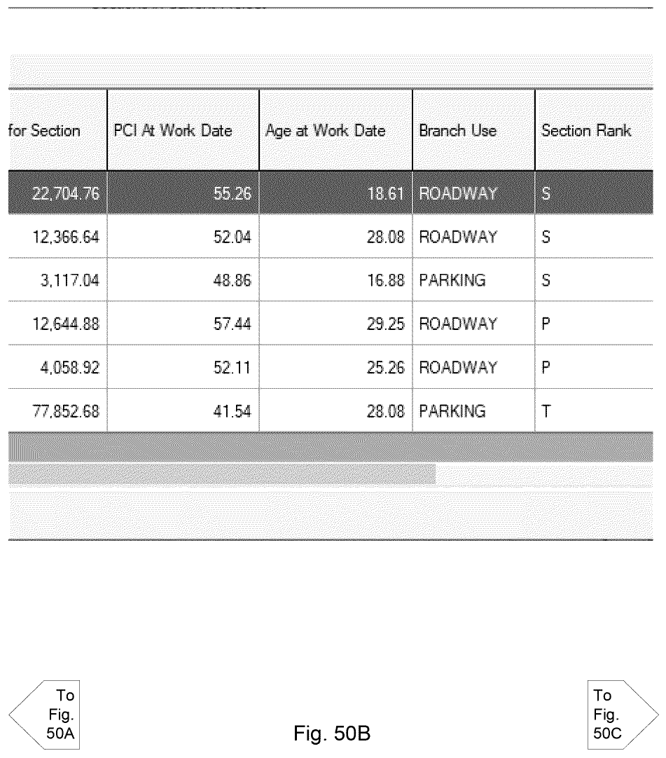

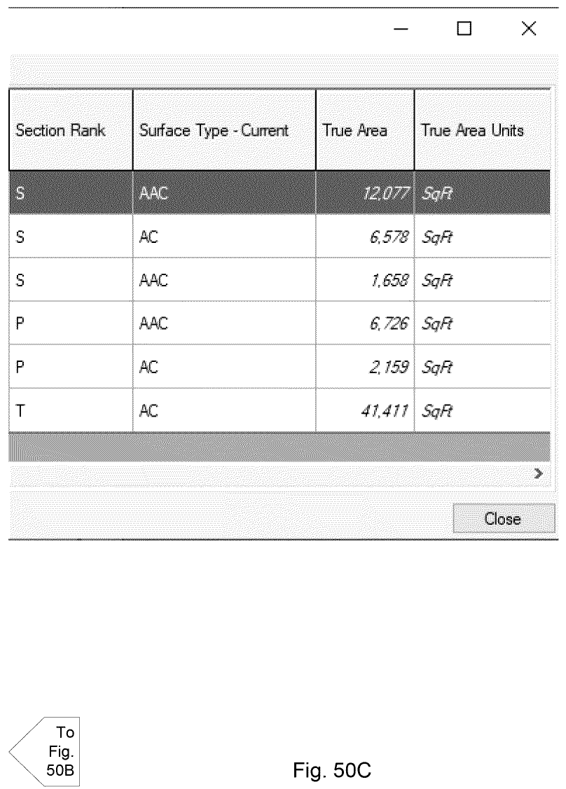

FIGS. 49A-49C and FIGS. 50A-50C show a risk analysis for project work window.

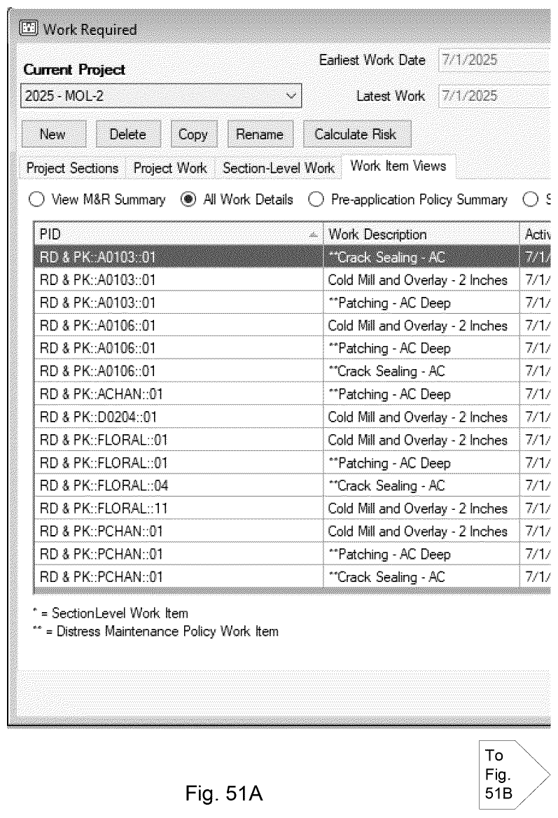

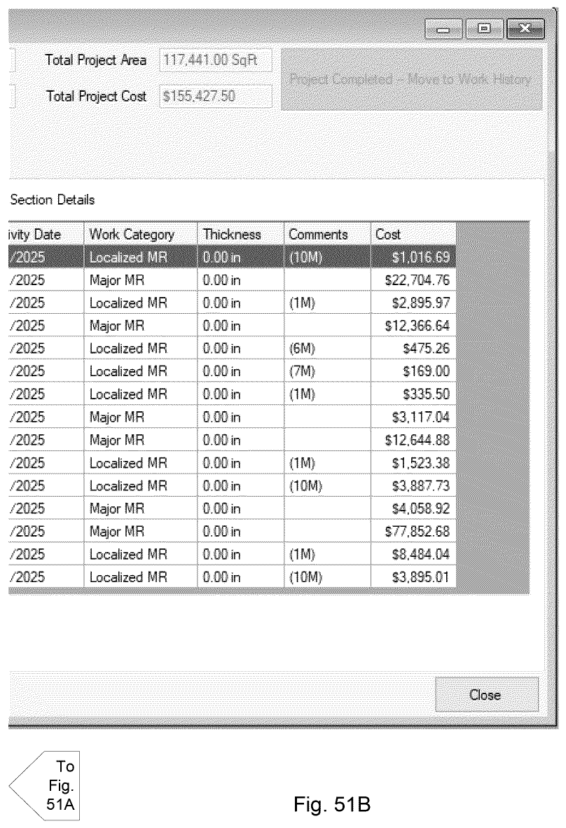

FIGS. 51A to 51B show a project work detail window.

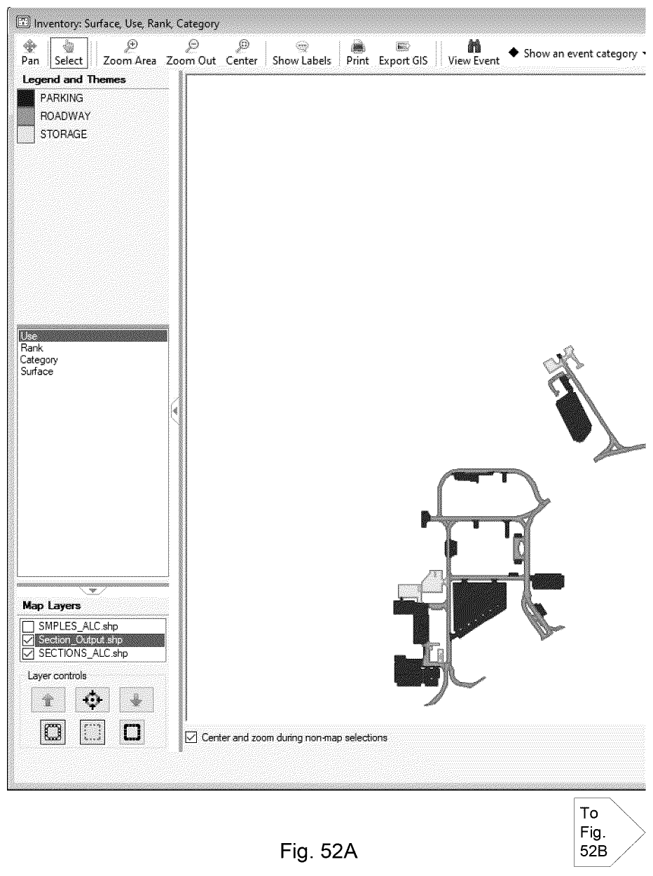

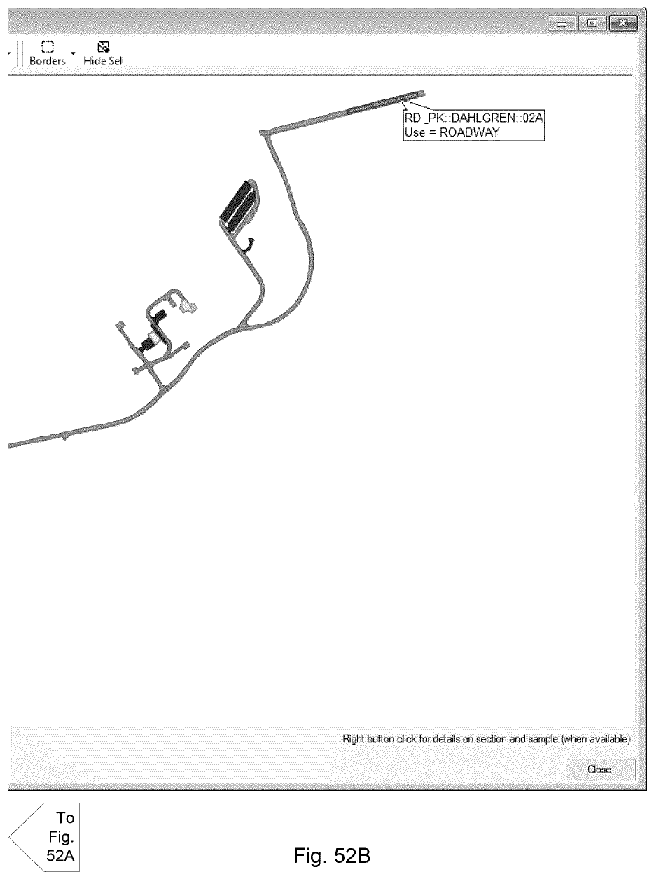

FIGS. 52A-52B show an inventory: surface, use, rank category window.

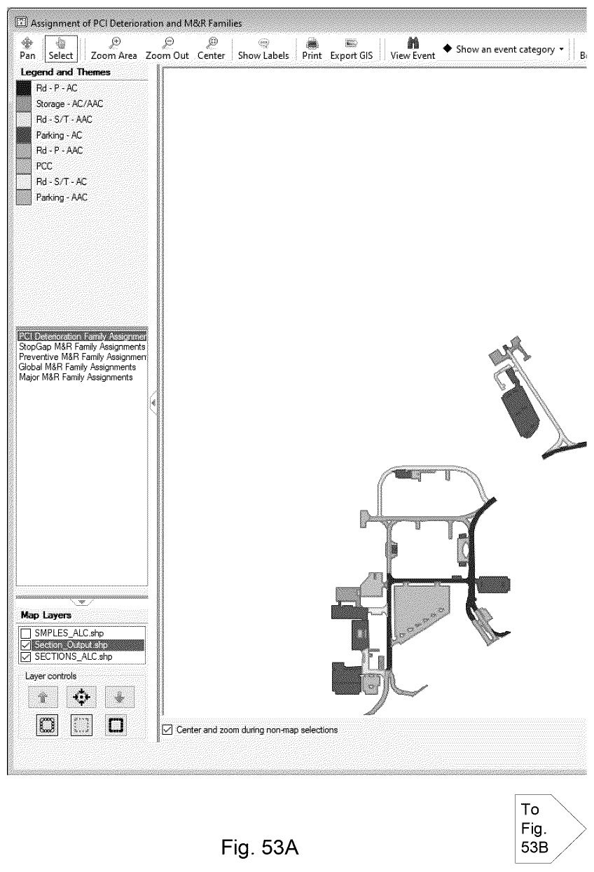

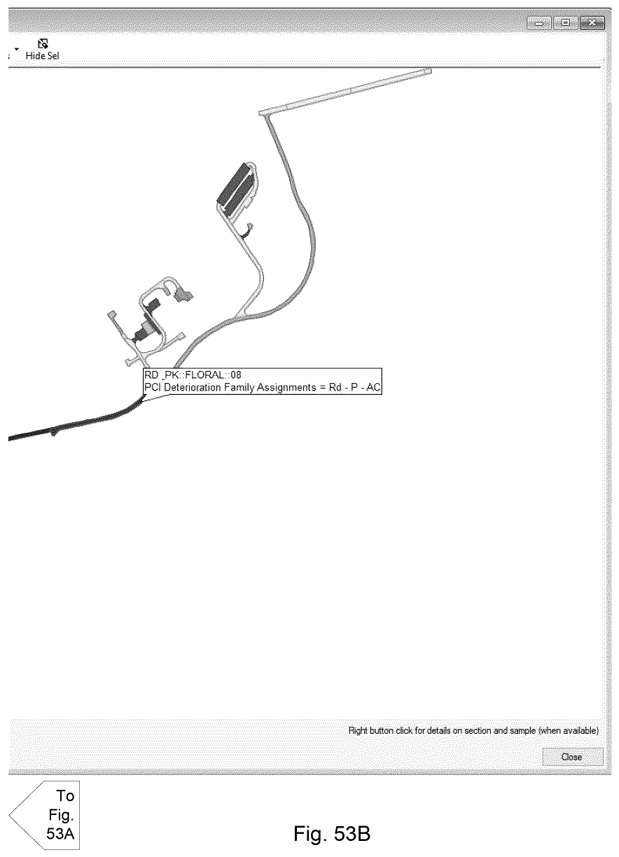

FIGS. 53A-53B show an assignment of PCI deterioration and M&R families window.

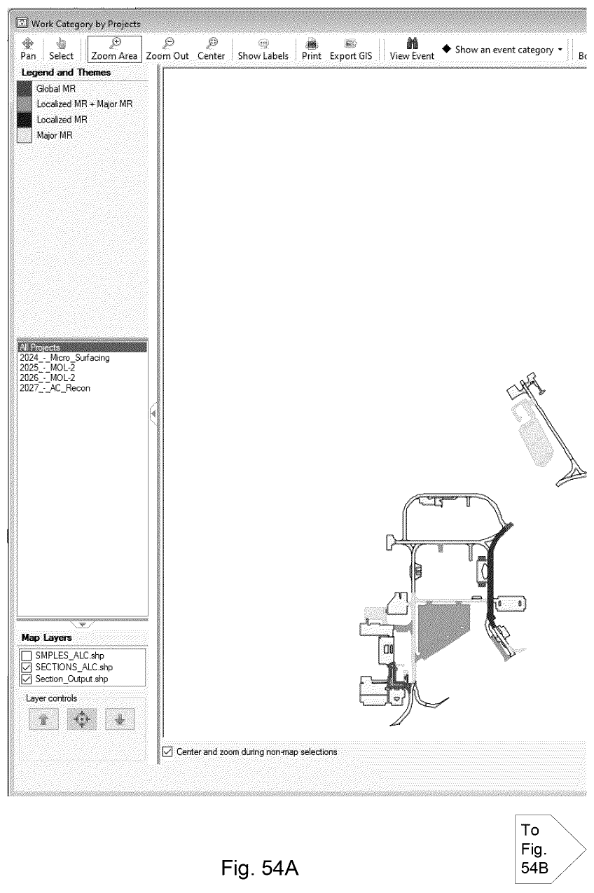

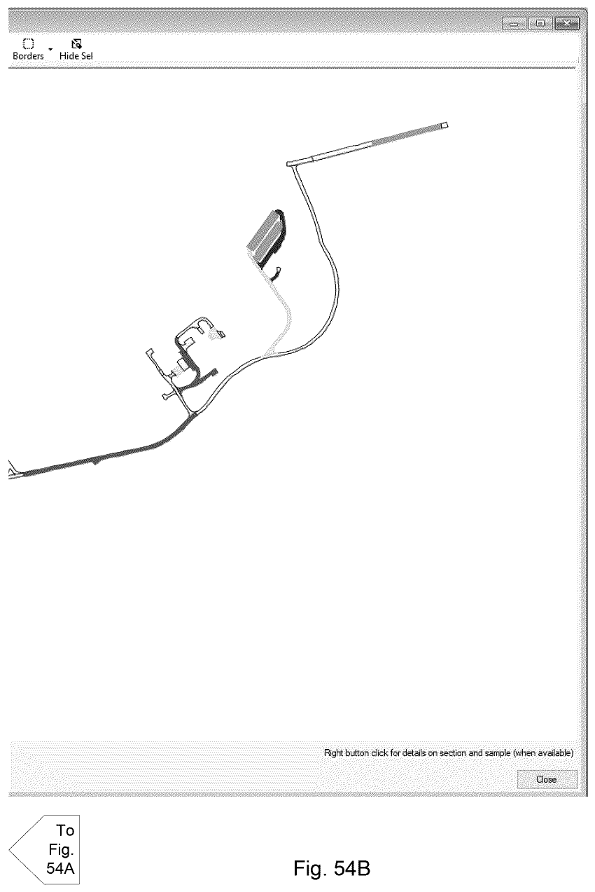

FIGS. 54A-54B show a work category by projects window.

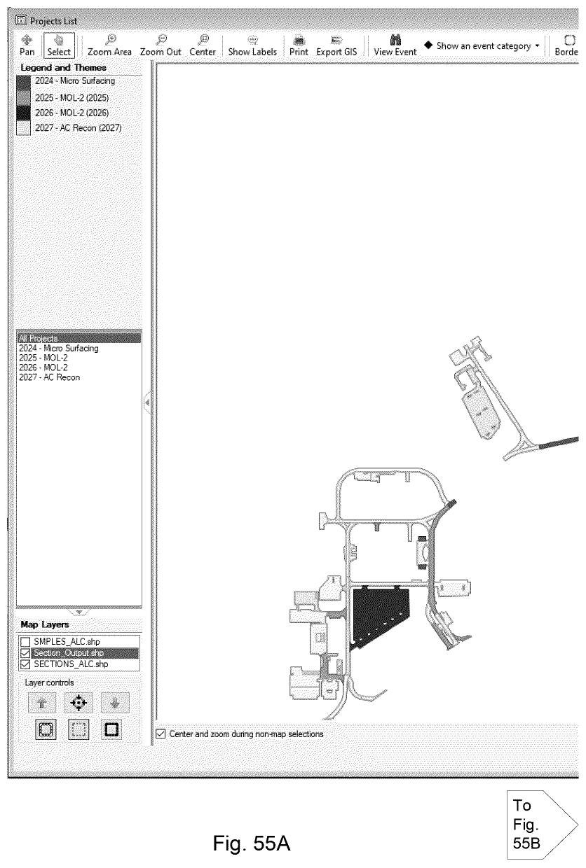

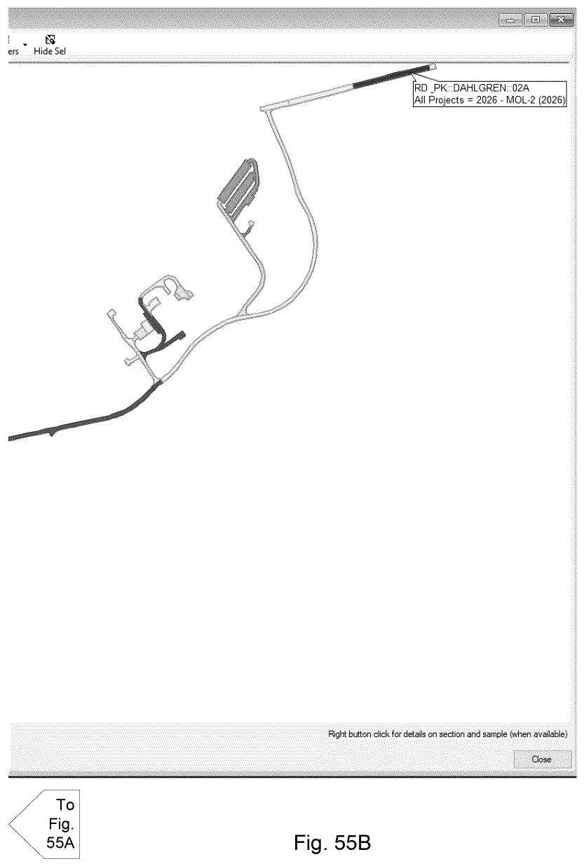

FIGS. 55A-55B show a projects list window.

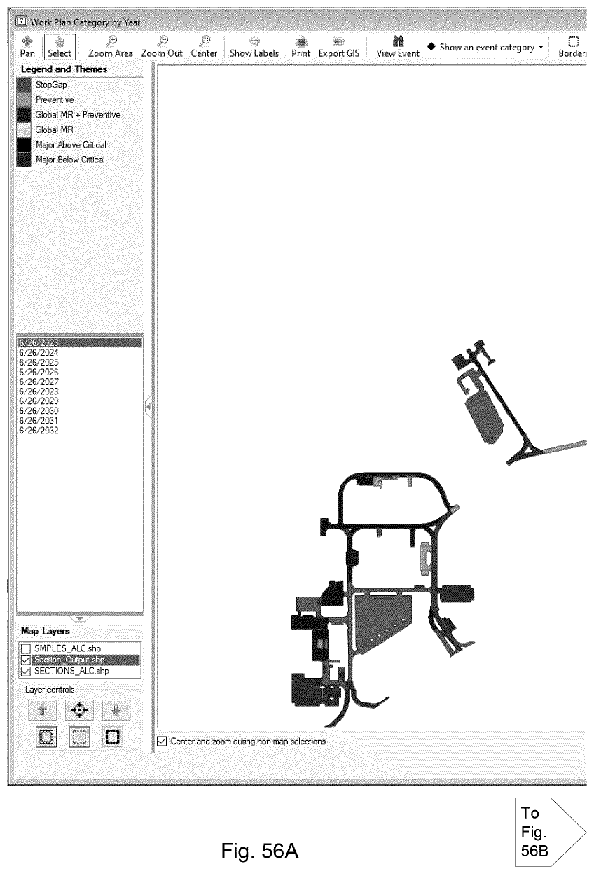

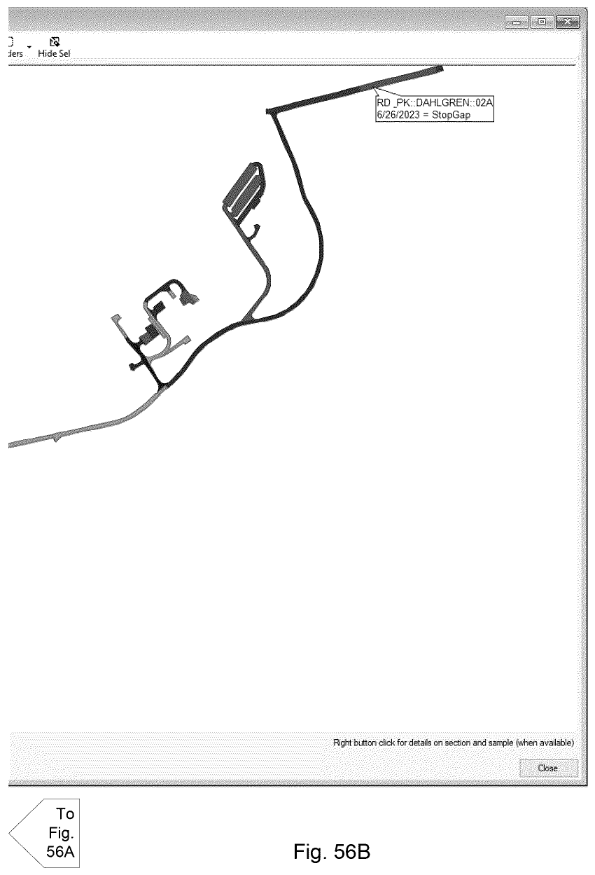

FIGS. 56A-56B show a work plan category by year window.

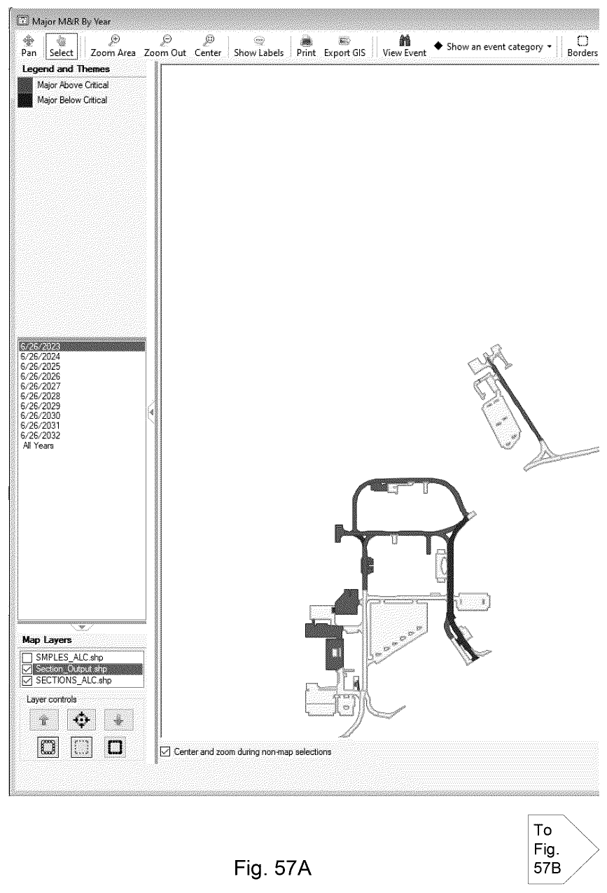

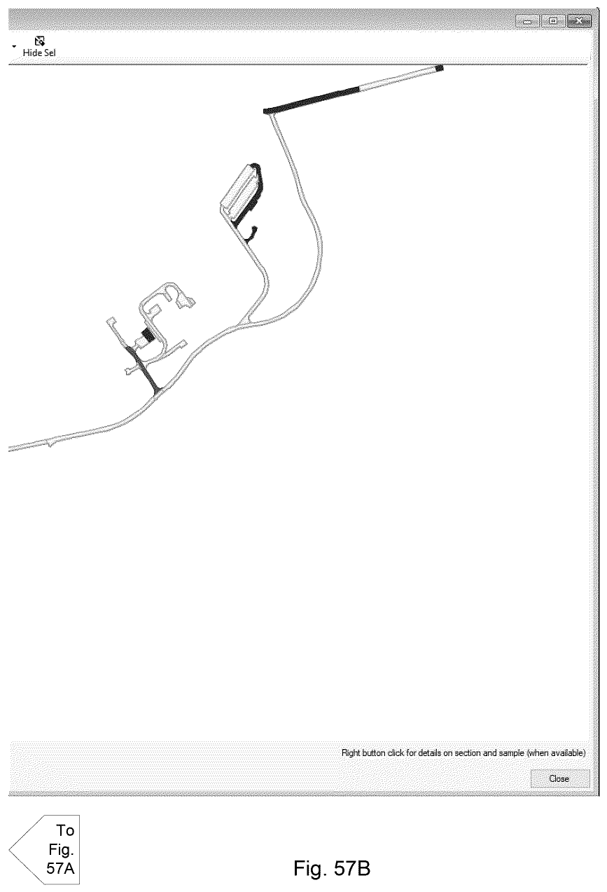

FIGS. 57A-57B show a workplan recommended for Major M&R by year window.

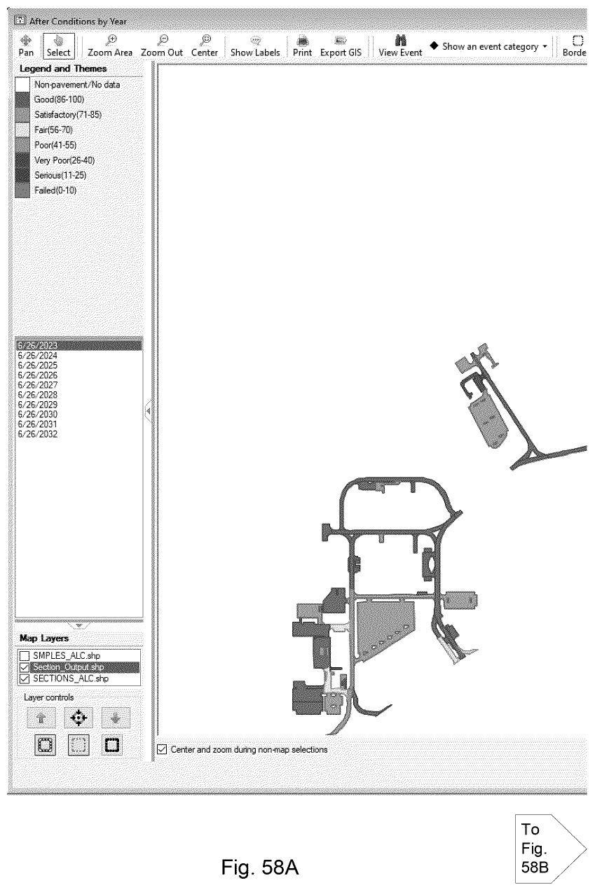

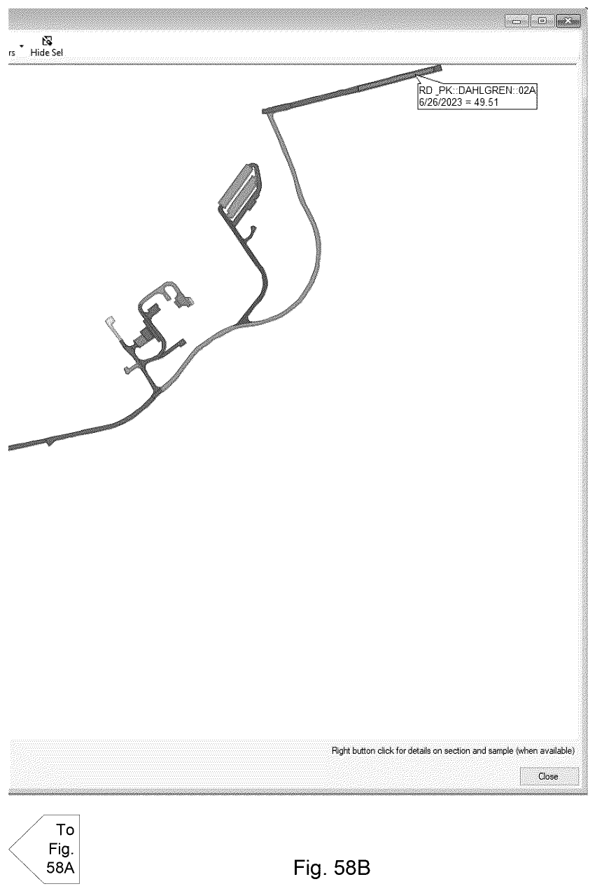

FIGS. 58A-58B shows a first year of an annual section PCI when a recommended workplan is performed window.

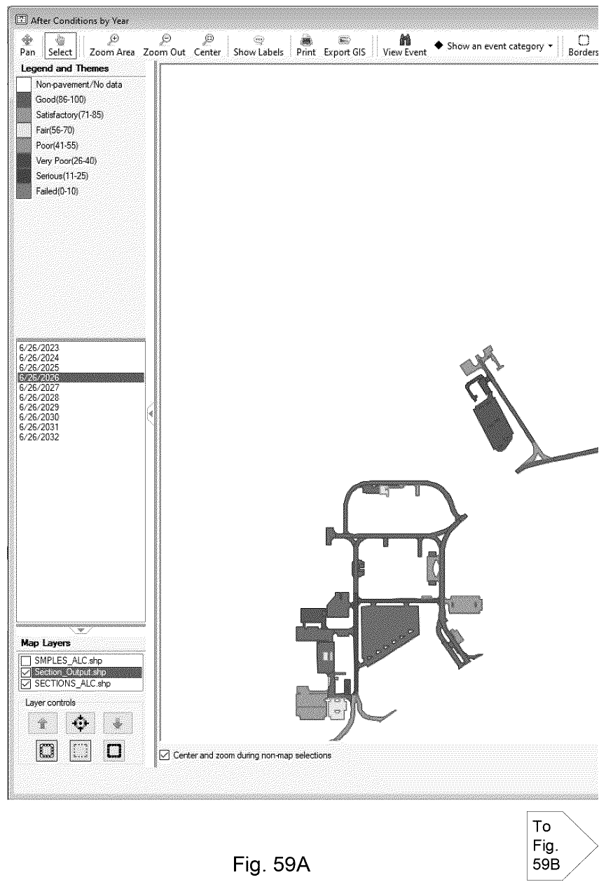

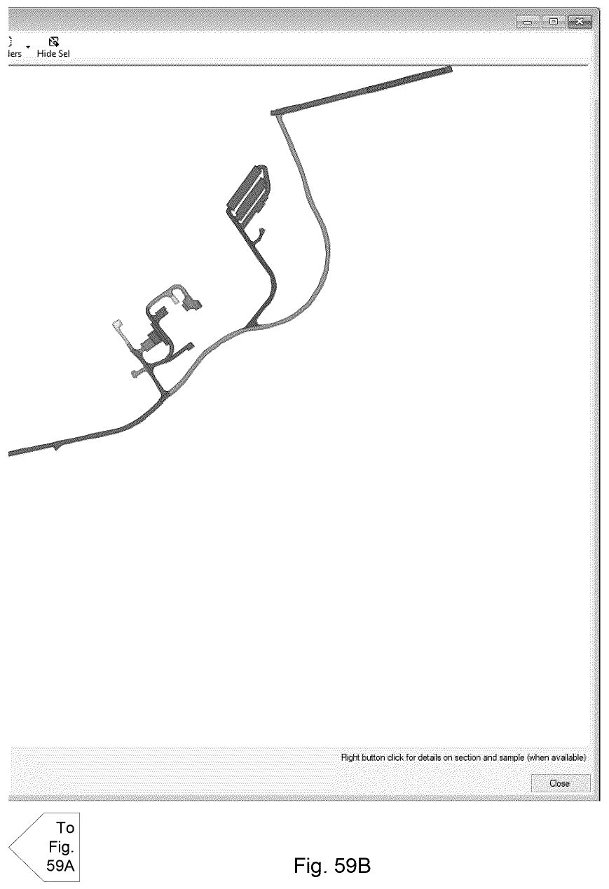

FIGS. 59A-59B show a second year of an annual section PCI when recommended workplan is performed window.

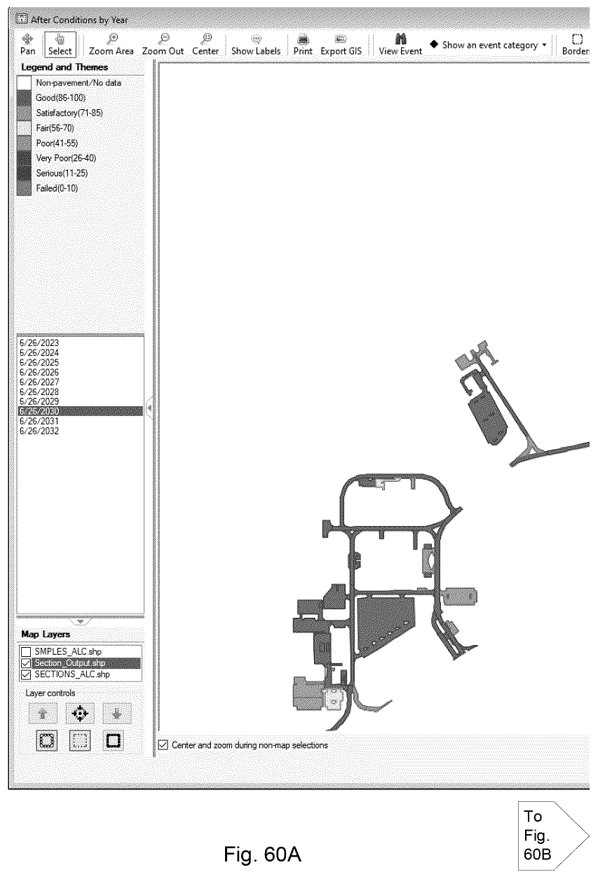

FIGS. 60A-60B show a third year of an annual section PCI when recommended workplan is performed window.

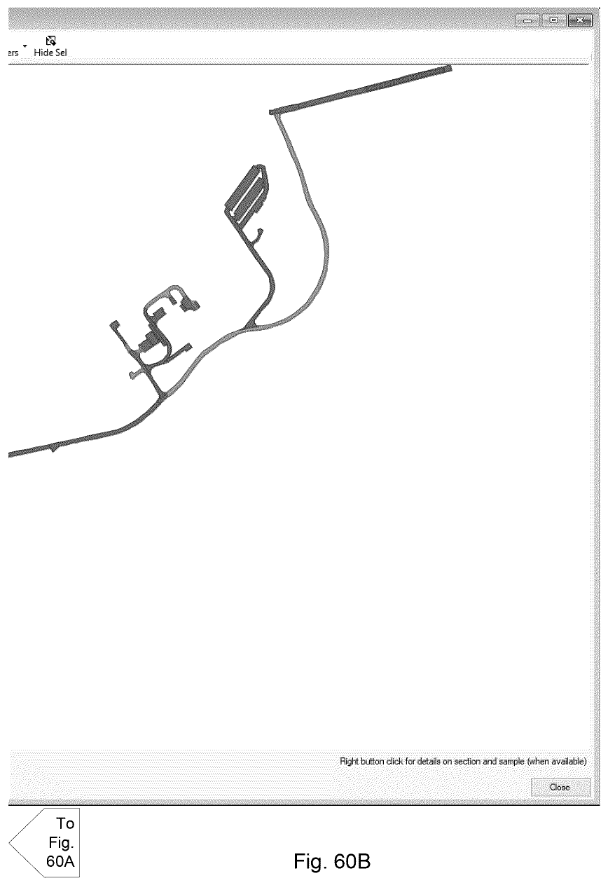

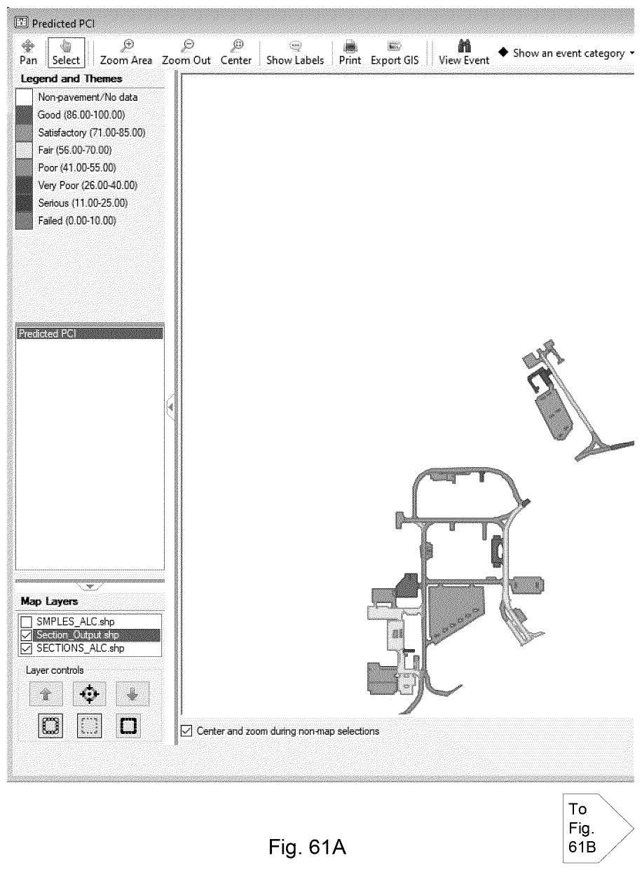

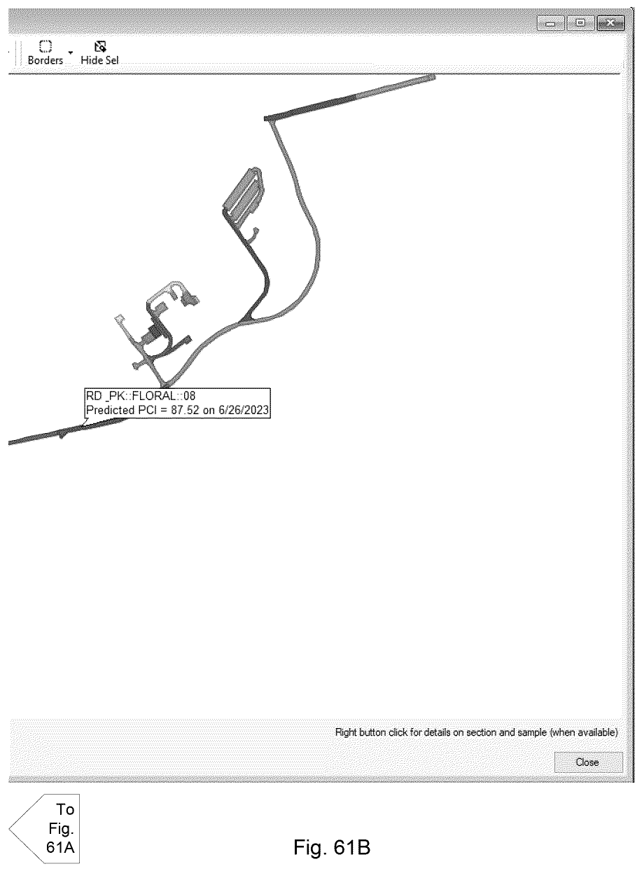

FIGS. 61A-61B show a predicted PCI when no work is performed window.

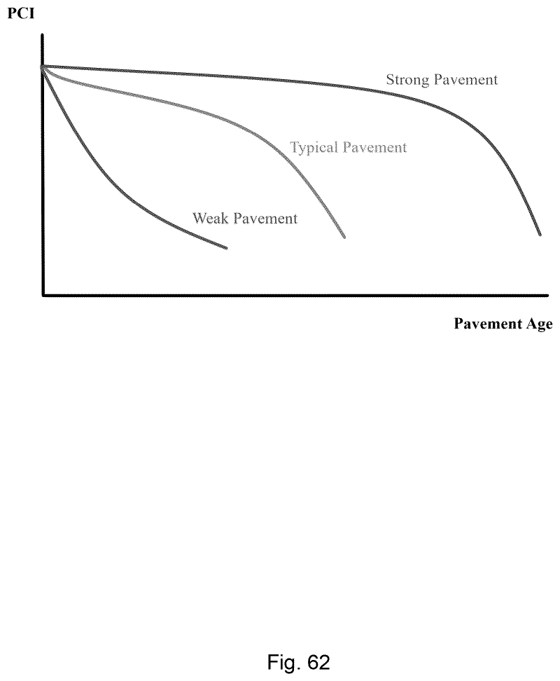

FIG. 62 shows a range of pavement performance.

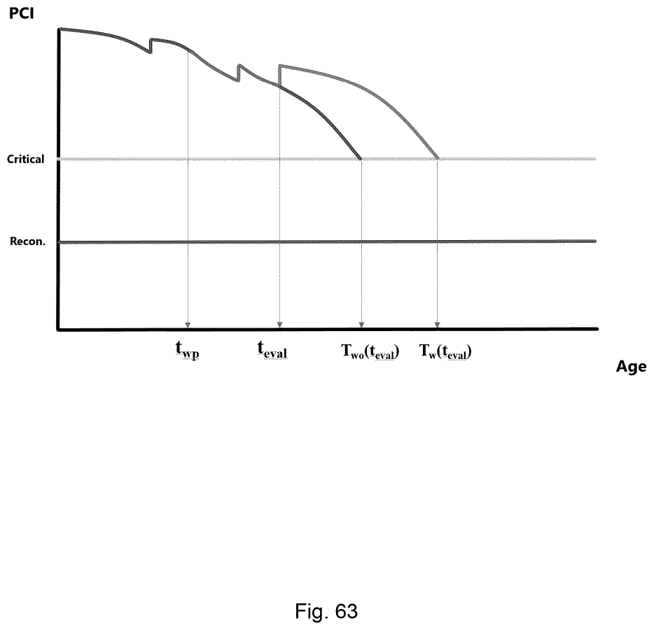

FIG. 63 shows a graph of pavement performance.

### DETAILED DESCRIPTION

Risk Cost (RC) and Return-On-Investment (ROI) provide useful data points for making investment decisions. These measures may be adapted to areas of application like pavement infrastructure maintenance management to be meaningful in those areas. For example, certain configurations of the invention provide methods and algorithms to determine an “estimated uniform annual cost” for repairing and maintaining a pavement section. Various equations can be used to facilitate estimations of costs and return on investments for maintenance and repair (M&R). A pavement management application (PMA) may be configured to apply RC and ROI to pavement maintenance activities.

A pavement management application (PMA) may be designed to make calculations of RC and ROI more accurate by considering pavement models (“families”). Use of pavement models may provide a more accurate outcome than, for example, using a linear-decay model or uniform pavement repair costs. A pavement management application (PMA) may be configured to calculate RC and ROI more accurately by including historical data about the particular pavement section being evaluated. A pavement management application (PMA) may be configured to make the RC and ROI numbers more usable by integrating these numbers into existing maintenance planning tools such as a section M&R Computer, Section Maintenance and/or Repair System, and/or an Inspection system.

A pavement management application (PMA) may be configured to resolve the pavement maintenance management question “what is the most economically effective maintenance and repair (M&R) actions to perform on my pavement infrastructure?” A pavement management application (PMA) may be configured to manage a pavement repair calendar for a small a network of roads (like a gated community), a military base, an airport, a city or county, or even an entire country of roads.

A pavement management application (PMA) may be configured to calculate estimated uniform annual cost (EUAC) of global, major and localized preventive M&R at a particular point in time, based on both pavement condition family and section history in which the pavement condition family may be adjusted based on historical work and inspections. The pavement condition family may be adjusted based on already planned work. The adjusted pavement condition family may be used to calculate the EUAC both when performing and not performing the particular type of M&R under consideration.

For localized preventive M&R, the method of calculating EUAC may be varied depending on (a) whether the pavement condition family was built including or not including preventive M&R, and (b) whether a work planning method is including localized preventive M&R or not.

A pavement management application (PMA) may be configured to determine a localized cost component of EUAC for Major M&R in which the cost calculation may be adjusted based on whether the condition family is built with or without preventive M&R. The cost calculation may also be adjusted based on whether the work planning method includes localized preventive M&R or not. The cost calculation may be adjusted based on whether the current estimated condition of the section is above or below the critical condition.

A pavement management application (PMA) may be configured to determine the critical condition for a condition family that employs an iterative algorithm to determine the PCI at which Major M&R has a maximum ROI and in which an initial estimated critical PCI may be used to begin the iteration. The ROI for major M&R may be calculated at each condition value using the configurations described above, and the maximum of which is used as the next estimate of critical PCI. The final estimated critical PCI may be the value at which the iteration stabilizes.

A pavement management application (PMA) may be configured to determine an effect of localized preventive M&R on a section's life that employs an iterative algorithm. The algorithm may be used either for estimating the life gain for doing preventive work on a section whose condition family does not include preventive, or for estimating the life loss for not doing preventive work on a section whose condition family does include preventive. A pavement management application (PMA) may generate an estimate of life gain/loss for a pavement with a twenty-year life is adjusted appropriately to estimate the life gain/loss for a particular pavement. A pavement management application (PMA) may adjust the algorithm based on the inspection and work history of the section by shifting the pavement condition family appropriately, then calculating an annual age adjustment needed to determine a proportionality factor to apply to a twenty-year life effect.

There may be three categories of M&R; Localized (spot maintenance such as patching or crack sealing), Global (pavement preservation by applying different types of seal coats to eth entire pavement surface), and Major (such as pavement overlay or reconstruction to bring the pavement to new condition). The RC and ROI methods for each of these categories are different and are included in this disclosure.

A pavement management application (PMA) may comprise a repair priority logic configured to prioritize repairs into three priority categories: low priority repairs, medium priority repairs, and high priority repairs; determine a repair priority for each of the pavements within a user's network; and adjust the repair priority of the pavements to maximize a user's return on investment.

A pavement management application (PMA) may comprise a return-on-investment calculator configured to prioritize different types of repairs as high, medium, and low priority. The return-on-investment calculator may be configured to set and modify these priorities to maximize a user's budget. The software can determine which roads should be repaired first and what kind of repairs should be made. The software may be configured to analyze all the possibilities a user has (e.g., what types of equipment for repairs) and provide the user with recommendations as to which repairs to make. The return-on-investment calculator may be configured to forecast deterioration of pavements if repairs are not made. The return-on-investment calculator may be configured to calculate an ROI for each section of each road in a network of roads. The return-on-investment calculator may include in its calculations, costs associated with making repairs versus costs of not making repairs.

A pavement management application (PMA) may comprise a pavement condition prediction engine. The pavement condition prediction engine may contain algorithms that analyze and predict pavement deterioration based on pavement type, pavement families, repair history, and deterioration history. The pavement condition prediction engine may be configured to perform this analysis on a pavement section level based on the actual history of that section of pavement. The pavement condition prediction engine may be configured to determine a cost curve for repairs for a pavement section and determine an exact point in time where repair costs get much more expensive. This point is known as the PCI Pavement Condition Index.

A pavement management application (PMA) may comprise budget & reports generation module (also referred to as a results module). The budget & reports module may be configured to optimize a user's budget if the software is given a budget to spend over the course of several years. The budget & reports module may be configured to generate a budget to maintain road condition (as specified by the user) at or above a certain pavement quality. The budget & reports module may be configured to generate various reports that contain recommendations on what roads to repair and how to repair them over a course of time (e.g., a 5-year plan.) The budget & reports module may be configured to generate digital color code maps to aid the user in understanding what roads to repair and what their roads will look like if roads are not repaired.

### Terminology

S: refers to a specific pavement section on which PMA may be configured to determine M&R risk cost and return on investments. In some configurations, critical properties of S such as its surface type and its area (Area^{S}) are known.

PF: refers to a PCI family. PMA may assign a PCI family to a Section under consideration or evaluation. A PCI family may comprise three properties. One, a deterioration curve from pavement age to pavement condition. Two, PCI_{crit}: a critical PCI value for the family. The critical PCI value may be the value below which global and localized preventive M&R (pavement preservation) are no longer performed, and safety M&R begins. Three, whether the deterioration curve is based on sections that have had localized preventive M&R performed.

PF^{S}(t) refers to the PCI family PMA may have assigned to a section S after PMA has made adjustments based on section history or predicted condition up to time/age t. Specifically, PMA may shift the deterioration curve for the family on the time axis so that the curve passes through a particularly observed (in the case of inspection) or calculated (in the case of global work or working planning) age×condition pair. It's possible that at different points in time t, the curve shift will be different, typically based on the latest work, inspection, or condition prediction prior to t.

MF: refers to an M &R family. PMA may assign an M&R family to a Section under consideration. The M&R family may have six properties. One, a cost curve from PCI to localized preventive M&R cost per unit area. Two, a cost curve from PCI to localized safety M&R cost per unit area. Three, a cost curve from PCI to major M&R cost per unit area. Four, the specific types of global work to perform for minimal, climate-related and skid-causing distresses. Five, a cost table specific global work type to cost per unit area. Six, the PCI at which sections in this M&R family are typically reconstructed (PCI_{recon}).

IH^{S}: refers to the inspection history for S. PMA may use each inspection in the section's history to identify the date, the age of the pavement at the time of inspection and its PCI value (based on observed distresses).

WH^{S}: refers to the work history of S. The work history of S may include the dates when the section received major or global M&R.

tₑᵥₐₗ: refers to the date at which PMA computes estimated uniform annual cost.

T^{S}_{w}(tₑᵥₐₗ): refers to the lifetime of section S from last Major M&R to PCI_{crit} when work of a particular category of M&R is performed by a third party on S at tₑᵥₐₗ.

t_{wp}: refers to the date at which M&R work planning begins.

PMA may be configured to integrate risk and ROI calculations into pavement work planning. PMA may be configured to use a work planning method incorporating PCI families assigned to a Section to estimate the Section condition in future years. The work planning method may include an algorithm for determining what work to do in which year. The work planning method may utilize the M&R work family assigned to the Section to estimate work costs for each plan year. The work planning method may be configured such that PMA can produce the following two outputs: WP^{S}(tₑᵥₐₗ): refers to work the work planner has planned for S from t_{wp} to tₑᵥₐₗ−1 and C^{S}(tₑᵥₐₗ): refers to the conditions the work planner has predicted for S from t_{wp} to tₑᵥₐₗ.

PMA may be configured with a date conversion module. The date conversion module may be configured to allow PMA to convert a Section's date (such as tₑᵥₐₗ) to a Section's age at that date. The date conversion module may utilize the information in the Section's work history WH^{S} to convert between Section data and Section age at that date. Throughout the application, date and ages are generally expressed in terms of fractional years, so an expression such as tₑᵥₐₗ−1 means “one year before the date/age given by tₑᵥₐₗ.”

PMA may be programmed to use the above elements to determine risk cost and return on investment.

EUAC^{S}_{w}(tₑᵥₐₗ): refers to an estimated uniform annual cost per unit area for S when performing work (w) of a particular category at time/age tₑᵥₐₗ.

EUAC^{S}_{wo}(tₑᵥₐₗ): refers to an estimated uniform annual cost per unit area for S without (wo) performing work of a particular category on S at time/age tₑᵥₐₗ.

ΔEUAC^{s}(tₑᵥₐₗ)=EUAC^{s}_{WO}(tₑᵥₐₗ)−EUAC^{s}_{W}(tₑᵥₐₗ): refers to the change in estimated uniform annual cost per unit area between doing work and not doing work of a particular category on S at time/age tₑᵥₐₗ.

$${ROI}^{s} ( {t}_{e v a l} ) = [ \frac{Δ E U A {C}^{s} ( {t}_{e v a l} )}{E U A {C}_{w}^{s} ( {t}_{e v a l} )} ] \times 100 :$$

refers to a return on investment for performing work of a particular category on S at tₑᵥₐₗ.

RC^{s}(tₑᵥₐₗ)=ΔEUAC^{s} (tₑᵥₐₗ)×Area^{s} is the annual risk cost for performing work of a particular type on S at tₑᵥₐₗ. This is definition of risk cost based on estimated uniform annual cost includes a multiplier by section area. Since EUAC is expressed in terms of unit area, PMA may be configured to multiply the EUAC by the area of S to resolve risk cost.

PMA may be configured to use the equations for ΔEUAC, ROI and RC to accurately determine EUAC^{S}_{w}(tₑᵥₐₗ) and EUAC^{S}_{wo}(tₑᵥₐₗ) for a particular work category for a pavement section S at time/age tₑᵥₐₗ.

PMA may be configured to determine methods for each of three M&R categories: Global M&R, Localized Preventive and Major.

### Global M&R

Referring to FIG. 1, PMA may comprise logic to calculate EUAC^{S}_{w}(tₑᵥₐₗ) and EUAC^{S}_{wo}(tₑᵥₐₗ) for global M&R by executing the algorithm shown in FIG. 1. PMA may comprise input logic configured to receive certain information from a user or system database for determining EUAC^{S}_{w}(tₑᵥₐₗ) and EUAC^{S}_{wo}(tₑᵥₐₗ). The input information may include: S: Section being evaluated; PF: PCI family assigned to S; PCI_{crit}: the critical for PF^{S}. MF: M&R family assigned to S; IH^{S}: Inspection history for S; WH^{S}: Work history for S; t_{wp}: work plan start; tₑᵥₐₗ: Time of evaluation; WP^{S}(tₑᵥₐₗ): Work-planned for S before tₑᵥₐₗ; and C^{S}(tₑᵥₐₗ): Work-plan predicted conditions up to tₑᵥₐₗ.

Step 1.1. PMA may be configured so that both EUAC^{S}_{w}(tₑᵥₐₗ) and EUAC^{S}_{wo}(tₑᵥₐₗ) include Common$. PMA may calculate the Commons by adding the cost for work done before tₑᵥₐₗ (G$_{before})+the cost for reconstructing the section Major$_{crit} when the Section reaches critical PCI. PMA may be configured so that actual global work costs G$ₚᵣₑ are recorded in WH^{S} and do not need to be calculated (step 1.1.1.1). PMA may be configured so that the work planner calculates the cost of planned global work and stores it in WP^{S} (step 1.1.1.2). PMA may be configured so that it can determine Major$_{crit} directly from PCI_{crit} and the major M&R cost curve in MF (step 1.1.2).

As shown in step 1.2, PMA may be configured to determine EUAC^{S}_{wo}(tₑᵥₐₗ). Determining EUAC^{S}_{wo} (tₑᵥₐₗ) may require (in addition to Common$), the localized costs when not performing doing global M&R (L$_{wo}), and the total pavement life when not performing global (T^{S}_{wo} (tₑᵥₐₗ)). Step 1.2.1. PMA can be configured to use PF^{S} (tₑᵥₐₗ) to determine T^{S}_{wo} (tₑᵥₐₗ), the life (time to critical condition) for S without doing global work at tₑᵥₐₗ. Step 1.2.2. PMA may be configured to use PF^{S} (t) to determine the condition C_{wo} for each t from tₑᵥₐₗ to T^{S}_{wo} (tₑᵥₐₗ). Step 1.2.3, PMA may be configured to determine the localized cost component (L$_{wo}). PMA may determine the localized cost component via a separate algorithm or method LocalCostCalc for period t=0 to T^{S}_{wo} (tₑᵥₐₗ).

As shown in step 1.3, to determine EUAC^{S}_{w} (tₑᵥₐₗ), PMA may be configured to determine Common$, the cost for doing global work at tₑᵥₐₗ (G$_{curr}), the cost for doing localized work after doing global work at tₑᵥₐₗ (L$_{w}), and the lifespan for S when doing global work at tₑᵥₐₗ (T^{S}_{w} (tₑᵥₐₗ)). PMA may be configured to determine localized work cost after global (global M&R) at tₑᵥₐₗ by processing the following three steps.

Step 1.3.1.1, PMA may identify the global work type in MF. The global work type may include a lifespan increase that results when the global work type is applied. PMA may be configured to use PF^{S} (tₑᵥₐₗ) to convert that lifespan increase to a new PCI P_{after} for S at tₑᵥₐₗ after the global work is done.

Step 1.3.1.2, PF^{S} (t) for t>tₑᵥₐₗ may be shifted to pass through tₑᵥₐₗ, P_{after}. PMA may be configured to use P^{S}(tₑᵥₐₗ+1) to determine T^{S}_{w} (tₑᵥₐₗ), the lifespan for S with global work at tₑᵥₐₗ. PMA may be configured to use P^{S} (t) to compute the condition C_{w} for S in each year from tₑᵥₐₗ+1 to T^{S}_{w} (tₑᵥₐₗ).

Step 1.3.1.3, PMA may execute the LocalCostCalc method to determine localized cost up to T^{S}_{w} (tₑᵥₐₗ).

Finally, to determine G$_{curr} (part of the formula to determine EUAC^{S}_{w}(tₑᵥₐₗ)) PMA may be configured to use the global work types identified in MF and whether the distresses recorded in IH^{S} are climate-related, skid-causing or other.

The estimated uniform annual cost for global may include the costs needed for localized M&R. The same is true for Major M&R (discussed next). Both methods use the method for calculating localized cost (LocalCostCalc). The method for calculating the localized cost component of EUAC involves accounting for three separate time periods involved and for each of those time periods the localized costs are calculated slightly differently. The end date/age t_{end} is a parameter to the method. In all three time periods, t_{end} may or may not be prior to the “normal” endpoint of the period.

### Localized Cost Component

Referring to FIG. 2, there are three columns of processes. The leftmost column 2.1 (historical period), a middle column 2.2 (planned period), and a rightmost column 2.3 (future period). PMA may comprise a historical calculator for determining costs for the historical period, a planned calculator for determining costs for the planned period, and a future calculator for determining costs for the future period. A cost calculator may be configured to calculate a result cost generated by summing a first cost vector, a second cost vector, and a third cost vector.

Referring to column 2.1, the “historical” period from last major M&R (t=0) until work planning starts (t=t_{wp}−1). PMA may be configured to merge data calculated from the following three steps. One (2.1.1), PMA may use PF^{S} (t) to calculate the PCI for each year in the interval from 0 to min (t_{end}, t_{wp}−1). Two (2.1.2), PMA may be configured to resolve L$₁ (t) as the preventive cost from MF for PCI(t) if PF includes preventive and PCI(t)≥ PCI_{crit}. Three (2.1.13), PMA may be configured to resolve L$₁ (t) as the safety cost from MF at PCI(t) if PF does not include preventive and PCI(t)≥ PCI_{crit}.

Referring to column 2.2, the “planned” period from work plan start (t=t_{wp}) until before the current evaluation time (t=tₑᵥₐₗ). PMA may resolve the condition PCI(t) in this interval from C^{S}(t) (2.2.1). PMA may compute C^{S} (t) as part of work planning. PMA may compute L$₁ (t) as the preventive cost from MF for PCI(t) if the work plan includes preventive and PCI(t)≥ PCI_{crit} (2.2.2). PMA may compute L$₂ (t) as the safety cost from MF at PCI(t) if the work plan does not include preventive and PCI(t)≥ PCI_{crit} (2.2.3).

Referring to column 2.3, the “future” period from t=tₑᵥₐₗ to the year before reconstruction (t=t_{recon}−1). PMA may resolve PF^{S} (tₑᵥₐₗ) to determine the PCI for each year in the interval from [tₑᵥₐₗ, min (t_{recon}−1, t_{end})] (2.3.1). PMA may compute L$₃ (t) as the preventive cost from MF for PCI(t) if PF includes preventive maintenance and PCI(t)≥ PCI_{crit} (2.3.2). PMA may compute L$₃ (t) is the safety cost from MF at PCI(t) if PF does not include preventive maintenance and PCI(t)≥ PCI_{crit}. (2.2.3).

### Major M&R

The PMA computer may be configured to calculate EUAC^{S}_{w} (tₑᵥₐₗ) and EUAC^{S}_{wo} (tₑᵥₐₗ) for Major M&R. FIG. 3 provides the algorithm to calculate EUAC^{S}_{w} (tₑᵥₐₗ) and EUAC^{S}_{wo} (tₑᵥₐₗ) for Major M&R. The inputs for the Major M&R algorithm/method may be the same as those used in Global M&R algorithm except the Major M&R algorithm may also utilize PCI_{recon} (the default PCI at which S is reconstructed) from MF. Both EUAC^{S}_{wo} and EUAC^{S}_{w} may comprise three components: major cost, global cost, and local cost. So, the input information may include: S: Section being evaluated; PF: PCI family assigned to S; PCI_{crit}: the critical for PF^{S}. MF: M&R family assigned to S; PCI_{recon}: reconstruction PCI for S from MF; IH^{S}: Inspection history for S; WH^{S}: Work history for S; t_{wp}: work plan start; tₑᵥₐₗ: Time of evaluation; WP^{S} (tₑᵥₐₗ): Work-planned for S before tₑᵥₐₗ; and C^{S} (tₑᵥₐₗ): Work-plan predicted conditions up to tₑᵥₐₗ.

PMA may be configured to determine EUAC^{S}_{wo} (tₑᵥₐₗ) (3.1). Determining EUAC^{S}_{wo} (tₑᵥₐₗ) may comprise: determining the cost for reconstructing the section at PCI_{recon} (Major$_{recon}), the cost for doing global work through t_{recon}−1 (G$_{wo}), and the cost for doing local through t_{recon}−1 (L$_{wo}). PMA may be configured to determine t_{recon} (3.1.1), the age at which S will reach the reconstruction PCI PCI_{recon}. t_{recon} can be determined using PF^{S} (t_{wp}). PMA may be configured to determine Major$_{recon} directly in the major cost curve from MF (3.1.2). PMA may be configured to look up the global costs from t=0 to t_{wp}−1 in WH^{S} (3.1.3). PMA may be configured to look up WP^{S} from t_{wp} to tₑᵥₐₗ−1. In some cases, PMA may assume t_{recon} to be less than PCI_{crit}, so for t≥t_{recon}, global costs will be zero. PMA may calculate L$_{wo} using the LocalCostCalc method described with reference to FIG. 2 with t_{end}=t_{recon}−1 (3.1.4).

PMA may be configured to determine EUAC^{S}_{w} (tₑᵥₐₗ) (3.2). Determining EUAC^{S}_{w} (tₑᵥₐₗ) may comprise determining the cost for reconstructing the section at tₑᵥₐₗ (Major$ₑᵥₐₗ), the cost for doing global work through tₑᵥₐₗ−1 (G$_{w}) and the cost for doing local through tₑᵥₐₗ−1 (L$_{w}). PMA may be configured to use C^{S} (tₑᵥₐₗ) and MF to calculate Major$ₑᵥₐₗ (3.2.1). PMA may be configured to look up the global costs from t=0 to t_{wp}−1 in WH^{S} to determine G$_{w} (3.2.3). PMA may calculate L$_{w} using the LocalCostCalc method described with reference to FIG. 2 with t_{end}=tₑᵥₐₗ−1 (3.2.3).

Referring to FIG. 4, PMA may be configured to use major ROI calculations (such as may be generated by the process discussed with reference to FIG. 3) to determine critical PCI for a PCI family PF. As shown, the PMA computer may receive (4.0) certain inputs (PF, Cᵢₙᵢₜ, Δh, B, [Cₘᵢₙ,Cₘₐₓ]). The PMA computer may determine major maintenance and repair costs (4.0.1), use a calculated value of critical PCI to determine an ROI calculation (4.0.2), and determine EUAC for major repairs (4.0.3).

Referring to FIG. 5, PMA may be configured to calculate the value of k₂₀ and k_{w} to determine a proportionality relationship of PF (PCI Family) & MF (Maintenance and Repair Family). K₂₀ being equal to ((Major$_{crit}+s$_{wo})/(Major$_{crit}+p$_{w})) use major ROI calculations (such as may be generated by the process discussed with reference to FIG. 3) to determine critical PCI for a PCI. As shown, PMA may be configured to:
1. Determine major maintenance and repair costs (Major M&R) (5.0.1);
2. Analyze two different scenarios depending on whether the PCI family assigned to S was built using data from sections on which localized preventive was performed regularly (“family built with preventive maintenance”) or not (“family built without preventive maintenance”) (5.0.2);
3. For scenarios involving a PCI family built with preventive maintenance, the pavement repair program may be configured to: use the PCI family to determine EUAC^{S} w (tₑᵥₐₗ); and estimate a lifespan loss of the Section for not doing preventive maintenance (5.0.3);
4. For scenarios involving a PCI family built without preventive maintenance, the pavement repair program may be configured to estimate the lifespan gain for doing preventive maintenance (5.0.4); and
5. The repair program may be configured to calculate K₂₀ for calculating a proportionality relationship of PF (PCI Family) & MF (Maintenance and Repair Family). K₂₀ being equal to ((Major$_{crit}+s$_{wo})/(Major$_{crit}+p$_{w})) use major ROI calculations (such as may be generated by the process discussed with reference to FIG. 3) to determine critical PCI for a PCI. (5.0.5)

To determine these costs, PMA may utilize certain input information and determine certain costs in performing the calculations.

Referring to FIG. 6, PMA may be configured to determine an estimated uniform annual cost for localized preventive M&R at tₑᵥₐₗ when the family is built with preventive to compute the ROI for continuing to do preventive work at tₑᵥₐₗ. To determine the annual cost, PMA may:
1. estimate uniform annual cost for localized preventive M&R at tₑᵥₐₗ when the family is built with preventive to compute the ROI for continuing to do preventive work at tₑᵥₐₗ (6.0.1);
2. determine both EUAC^{S}_{wo} and EUAC^{S}w, by determining Common$, the sum of global work cost up to tₑᵥₐₗ (G$_{before}), localized work costs before work planning (L$ₚᵣₑ₁), localized work costs from work plan start to tₑᵥₐₗ (L$ₚᵣₑ₂) and the cost for major at PCI_{crit} (Major$_{crit}) (6.0.2);
3. calculate localized costs before the workplan starts (L$ₚᵣₑ₁) from conditions by using the family curve shifted based on inspection and work history (6.0.3);
4. obtain localized costs L$ₚᵣₑ₂ from workplan start to tₑᵥₐₗ (6.0.4);
5. determine the localized cost term L$_{w} (6.0.5);
6. resolve T^{S}_{wo} (tₗᵢ), the lifespan loss for not doing preventive on S after tₗᵢ (6.0.6);
7. calculate an annual age increase Δa as Δt^{S}(tₗᵢ) divided by the interval from tₗᵢ to T^{S}_{wo} (tₗᵢ) (6.0.7); and
8. use the safety cost curve of MF to compute L$_{wo} and finally EUAC^{S}_{wo} (tₑᵥₐₗ) (6.0.8).

PMA may be configured to determine an estimated uniform annual cost for localized preventive M&R at tₑᵥₐₗ when the family is built with preventive to compute the ROI for starting to do preventive work at tₑᵥₐₗ.

Referring to FIG. 7, PMA may be configured to determine estimated uniform annual cost for localized preventive M&R at tₑᵥₐₗ when the family is built without preventive to compute the ROI for continuing to do preventive work at tₑᵥₐₗ. PMA may be configured to:
1. determine Global cost G$_{before} by summing two elements;
   a. determine G$ₚᵣₑ as the cost of actual global work recorded in the section work history WH^{S};
   b. determine global work included in work plan results WP^{S} (tₑᵥₐₗ) before tₑᵥₐₗ.
2. calculate localized costs before the workplan starts;
3. resolve localized costs L$ₚᵣₑ₂ from workplan start to tₑᵥₐₗ;
4. For families built without preventive, PMA may be configured to use the family curve to calculate the inputs for EUAC^{S}_{wo} (tₑᵥₐₗ);
5. For families built without preventive, PMA may be configured to determine T^{S}_{w} (the life of S when doing preventive on and after t_{wp}) and L$_{w} (the cost for localized work from tₑᵥₐₗ to T^{S}_{w});
6. PMA may be configured to use the preventive cost curve of MF to compute L$_{w} and finally EUAC^{S}_{w} (tₑᵥₐₗ) when C_{w} has been resolved.

PMA may be configured estimated uniform annual cost for localized preventive M&R at tₑᵥₐₗ when the family is built without preventive to compute the ROI for starting to do preventive work at tₑᵥₐₗ. To determine the annual cost, PMA may utilize certain input information and determine certain costs in performing the calculations.

### PMA Configurations

Referring to FIG. 8, a user may operate a computer comprising a processor 802, memory 804, system bus 806, network interface 808, storage media 810, display 812, and controls 814 (like a mouse and keyboard). The processor 802 may run or execute a program stored in the storage media and/or memory to cause the processor to execute a sequence of steps and/or algorithms, i.e., run the program PMA 820. PMA is a software program that may be configured to analyze and prioritize repairs of Sections(S). PMA may comprise a data input module 822, solver 824, and result module 826 capable of determining optimized maintenance and repair schedules for a network of Sections. As shown, the computer operating PMA may be connected to a database 830 and a second computer—the Section M&R computer 850 (also having processor, memory, system bus, network, storage media, display, mouse, and keyboard).

The database 830 may be a component in the PMA computer 800 or be its own server. As a database, the server may comprise database management software capable of sorting, updating, retrieving, and manipulating records stored in the database. The server may comprise standard hardware found in servers such as processors, memory, network interface, storage media, etc.

The Section M&R computer may have a section maintenance and/or repair scheduler 852 configured to schedule maintenance and/or repairs on a section. The Section M&R Computer 850 may interface with a section maintenance and/or repair system. The section maintenance and/or repair system 860 may comprise various trucks 862, computers 864, supplies 866, paving equipment 868, and pavement repair technology 870 useful for paving and repairing roads. In some configurations, the PMA computer and the Section M&R computer can be a single computer.

An inspection system 880 may be a machine configured to inspect a condition for one or more sections. The inspection system may comprise computers 882 and cameras 884. The computer may comprise specialized software for determining pavement condition from images obtained by the cameras. An inspection system may be mounted in a plane, helicopter, truck, car, or other vehicle 886. An inspection system may contain controls 888 for local or remote operations of the inspection system by an inspector. An inspection system may be configured to generate inspection records. Inspection records may contain information recorded and/or obtained about distresses (such as degree and quantity) of a Section. PMA may be configured to store these records. PMA may be configured to display these records in the inspection ribbon. PMA may be configured to allow a user to manage, change, sort, and manage an inspection history of a Section. An inspection history is a collection of inspection records of the Section.

A Section is a portion of a branch. Branches may include pavement, roads, streets, parking lots, highways, parkways, runways. PMA, taxiways, or aprons. A section may be surfaced with asphalt, concrete, brick, aggregate, or mat. Paver may be configured to manage sections as its primary unit.

PMA, like many programs/applications, may comprise a plurality of windows. A window may comprise one or more buttons, fields, labels, toggles, select boxes, drop down boxes, radial boxes, etc. Each window in PMA may comprise underlying or associated logic, algorithm, or software routine configured to accept inputs, process inputs, generate results, stores results, display results, and/or issue instructions to other logic and/or windows and/or systems. For example, the inspection window may comprise an inspection logic. The inspection logic may be configured to store inspections records for a Section. Or in another example, the inventory window may comprise an inventory logic. The inventory logic may be configured to divide a large area of pavement into groupings.

PMA may have a main menu and a ribbon menu. These menus may be configured organized various windows. The ribbon menu may have an inventory, reports, selectors, work, debug, inspection, family modeling, conditions performance analysis, M&R family models inventory, M&R work planning, project formulation wizard, and wizards. FIGS. 10A-10B shows the inventory ribbon menu.

FIG. 9 shows an overall view of various algorithms that PMA may be programmed to execute. FIG. 9 contains elements 1, 3, 4, 5, 6A, 6B, 7A and 7B. More details on each of these elements may be found in FIGS. 1-7B and in the other two co-pending applications incorporated by reference above.

FIGS. 10A-61B are screenshots of an embodiment of PMA. In these embodiments, PMA may be a software program running a specialized PMA computer. The PMA computer may comprise optimized hardware to more efficiently run the PMA software program. The PMA computer may comprise a monitor to display these screenshots to a user.

FIGS. 10A-10B shows an inventory window in PMA. PMA may have inventory. The inventory may be stored on the computer and/or remote database. The inventory can be used to divide a large area of pavement into groupings. As shown, the inventory window may have 3 tabs: a5 network tab, branch tab, and a section tab. FIG. 10A-FIG. 10B show the network tab in detail. The largest of these groupings may be a network such as a town or city. Within a network, there may be branches like a street. Branches may contain sections, i.e., a portion of a street reaching from one intersection to the next.

FIGS. 11A-11B show the inventory window of the branch tab, the branch tab may show branch properties. Example properties include branch ID, use, sum of section lengths, sum of true section areas, brand true area.

FIGS. 12A-12B shows the inventory window of the section tab. The section tab may show a table of the section's properties. Sections(S) are represented by variable S in various algorithms in the application. The section tab may have several subtabs including: properties, conditions/families, and samples. FIGS. 12A-12B show the properties subtabs.

FIGS. 13A-13B shows a window of GIS maps. GIS Maps can be used to give context to the inventory. The GIS map shows a map of roadways in this figure, but may also be configured to show a map of an airfield. FIGS. 13A-13B show a current selection section.

FIGS. 14A-14B shows the inventory window with the conditions/families tab selected. The box indicates the inspection (IH^{S}) of a current Section. FIGS. 14A-14B show a radio buttons including: view all latest conditions, view all indices and dates, view one condition index for all dates, view PCI Deteriorations Family Assignments, View M&R family assignments. The view one condition index for all dates is selected in FIGS. 14A-14B.

FIGS. 15A-15B shows the inventory window with the conditions/families tab selected and one condition index for all dates, The box indicates M&R families (MF) assigned to this section. The window shoes inspection dates, conditions, and method.

FIGS. 16A-16D shows an inspection window of the inspection submenu. Sections may be inspected by a user on a regular basis. An inspection system may be configured to record the distresses and their quantity. Inspections give us the condition across time (IH^{S}). Distresses may include a distress identifier, distress descriptions, distress severity, quantity, units (for the quantity), density, deduct, and/or comment. PMA may be configured to take, accept, and store pictures/video of distresses and sum distresses. The inspection system may be configured to capture images and/or videos of distresses. The inspection system may automatically transfer captured images and/or videos of section distresses to PMA. In some configurations, an algorithm executed a computer in the inspection system may be configured to determine which images and or video to transfer to PMA. In some configurations, the inspection system may comprise a selection tool configured to allow an inspector to make and/or override images and/or video to transfer to PMA. The Distresses selections shows 20 exemplary distresses such as alligator cracks, bleeding, block cracks, bumps, sags, corrugation, edge cracks, JT Ref. Cr, lane sh drop, L&T Crack, patch/UT cut, polished AG, pothole, rutting, shoving, slippage crack, swell, raveling, and weathering. JT=Joint; Ref.=Reflection; Cr=Crack; sh=Shoulder; L&T=Longitudinal and Transverse; UT=Utility; AG=Aggregate.

The inspection windows may contain a low, medium, and high selector although other ratings systems are contemplated (such as a number scale or star scale). The inspection window contains a quantity selector configured to receive distance/quantity information about a distress and store that distance/quantity information in PMA.

FIG. 17 shows a window called or displayed when the show conditions button is clicked. PMA may be configured to calculate multiple different condition values from the recorded distresses and quantities. PMA may be configured to use PCI for risk analysis. The window shows a network ID, branch ID, and section ID. It also shows section area, section width, and section length. The PCI index and condition value are also displayed.

FIGS. 18A and 18B show a PCI Family Models (PF) window. Records may be stored within a PCI family model. PMA may store conditions of similar sections across time as groups. PMA may use the groups to graph a point cloud of Age vs PCI. A point cloud of Age vs PCI is shown in FIGS. 18A and 18B. The PCI Family Models window may comprise tabs: review model data, use boundary/outlier, options, view equations and stats, and assign family.

FIGS. 19A and 19B show the PCI family model window with the view equations and stats tab selected. The PMA software may be configured to fit a curve to the point cloud. The equation of this curve is representative of how the condition of a section will change over time. In other words, the curve of the line models or is a prediction the condition of the section as a function of age of the road.

FIGS. 20A and 20B show the PCI family model window with the Assign Family tab selected. As the behavior of a Section's condition may depend on several factors, PMA may provide multiple models of the pavement's lifespan with a network. PMA may assign Sections to models built with data from similar Sections.

FIGS. 21A and 21B show the PCI family model window with the Options tab selected, but the top graph is not shown for illustration purposes. However, FIGS. 21A and 21B show the Critical PCI Nomination window (accessible by clicking the sweet spot analysis button). PMA may be configured to use risk calculations to perform a sweet spot analysis. PMA may be configured to compute ROI many times. PMA may change the PCI at time of work and the Critical PCI of the family to identify a combination (of PCI at time of work and the Critical PCI of the family) that generates a maximized (highest potential) ROI.

FIGS. 22A-22B, 23A-23B, 24A-24B, 25A-25B show examples of M&R Family windows. PMA may use M&R Families to group together M&R data that may be shared to all the Sections assigned to that M&R Family. The M&R data may include Cost by Condition, Cost by Work Type, and work types. PMA may use this M&R data when planning work.

FIGS. 26A and 26B show a major M&R cost table window. For major work, PMA may be configured to model a cost table. The cost table may be used by PMA to approximate a cost of doing road work on a Section based on the condition of the Section at the time of the work.

FIGS. 27A and 27B show a global M&R work type window. Global work types may have a Delta ΔT value. The Delta T value may be the expected life gain from application of the roadwork (e.g., completing recommended roadwork). The global M&R work type window may be configured to calculate a section specific Delta T value in the current fiscal year.

FIGS. 28A and 28B show a global work is priced by work types instead of condition. A table in the window displays a code, name, cost, and units.

FIGS. 29A-29B shows a window for preventative cost by condition. A table shows condition, cost, and unit area.

FIGS. 30A-30B shows a window for stopgap cost by condition. A table shows condition, cost, and unit area.

FIGS. 31A-31B shows a condition performance analysis window. PMA may be configured to generate condition analysis models. Condition analysis models may be configured to determine how Sections are going to decay if no M&R work is performed. PMA may be configured to shift the assigned PCI family to the latest inspection point for each section and compute the condition year by year for the duration of the work plan.

FIGS. 32A-32B shows a section condition list associated with the condition performance analysis window. PMA may be configured to collect condition values (C^{S} (tₑᵥₐₗ)) in the risk calculations of the pavement's life. PMA may be configured, for each of these conditions, to compute a cost using the appropriate cost by condition table and their sums become (C_{w}) and (C_{wo}).

FIGS. 33A-33B shows a work plan analysis window. The work plan analysis window may be configured to model conditions of Sections condition into the future. The work plan analysis window may be configured to apply M&R work to calculations regarding the condition of a Section in the present or in the future. Application of M&R work may result in an improvement of the condition and/or lifespan of the Section.

FIGS. 34A-34B shows a work plan analysis window with a budget tab selected. PMA may be configured to provide users with settings to constrain a budget available to a work plan. PMA may generate work recommendations. Work recommendations may be generated on a set schedule such as yearly or monthly. PMA may prioritize the work recommendation using a prioritization algorithm. PMA may reduce the work applied to fit within the budget limitations. In some configurations, PMA may comprise a prioritization method that utilizes risk analysis of ROI results.

FIGS. 35A-35B show a risk calculation window. The window can be turned on and off for each work category. As shown, there are checkboxes for localized stopgap M&R, localized preventative M&R. A global preventive M&R checkbox has sub-boxes: calculate risk and ROI, only plan global in PCI range, allow global for sections above critical with load defects, minimum age before global. A major M&R checkbox may comprise calculate risk and ROI.

FIGS. 36A-36B, 37A-37B, and 38A-38B show tabs. PMAM&R family tabs that may affect risk calculation. Paver may be configured to require the fill out these tabs when a risk calculation is turned on (enabled). The properties on these tabs may be configured to determine whether the assigned M&R Families are used to specify which cost tables to use or whether a single cost table should be used across all Sections.

FIGS. 39A-39B show a work plan analysis window with a global M&R family settings tab selected. PMA may be configured the user adjust/configure these global M&R family settings for the global risk calculations.

FIGS. 40A-40B show a results selection tool configured to cause PMA to display a result window such as a table, graph, map, menu, or display. In the example of FIGS. 40A-40B, PMA may be configured to generate thirty different results. In the example of FIGS. 40A-40B, a Section PCI by Year checkbox is selected. The result of Section PCI by Year is shown in FIGS. 41A-41C.

FIGS. 41A-41C show the results table Section PCI by Year table and graph. The table shows network ID, branch ID, and section ID. The screenshot also shows a graph of condition by year. Condition on the Y-axis, and year on the X axis.

FIGS. 42A-42B show a result window configured to display a major M&R risk by Section summary. In this window, PMA may be configured to calculate the ROI for each row and display them in the result window.

FIGS. 43A-43B show a result window configured to display a localized preventative M&R risk by section summary. The table shows year, NetworkID, BranchID, SectionID, PCI at work date, % ROI (localized preventive), deterioration rate with localized preventive, Critical PCI, and Work Date for Risk.

FIGS. 44A-44C show a project planning window. PMA may be configured to generate projects. PMA may be configured to allow user to set projects as required or optional. These projects may define specific work to be done in the future. These projects may be included when running the work plan. A work planner (a software routine or logic) may be configured to take the project work into account when budgeting and making work recommendations. Once the work is completed, PMA may move these projects into a work history database for the relevant Sections.

FIG. 45 shows a work required window. Work required logic in the work required window may generate additional windows when the calculate risk button is selected. The additional windows generated may be configured to allow PMA to present options to the user. The options may be selected through three tabs: localized stopgap M&R, localized preventative M&R, and Major M&R.

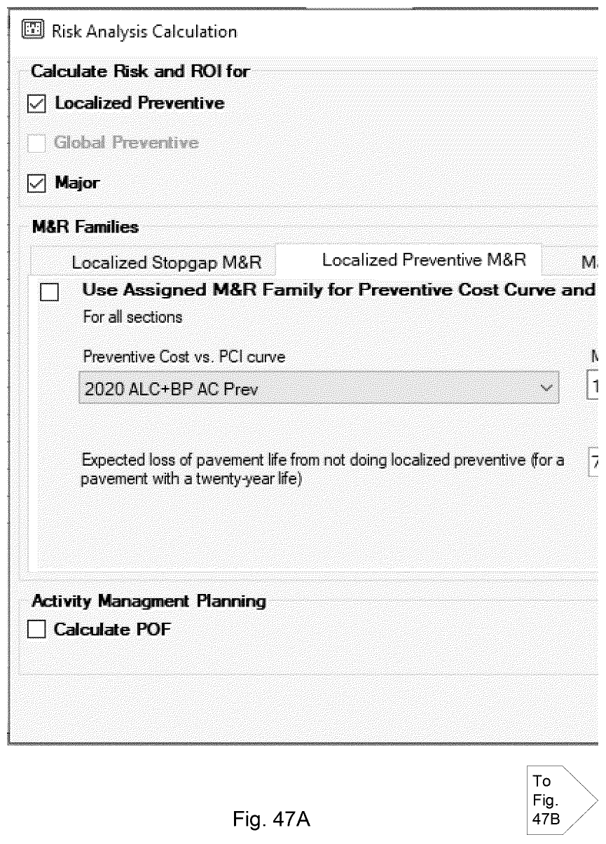

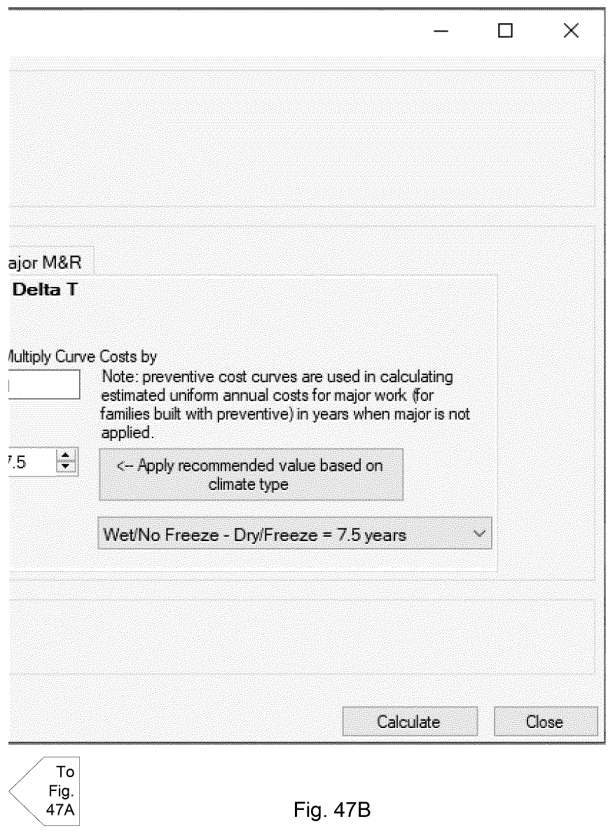

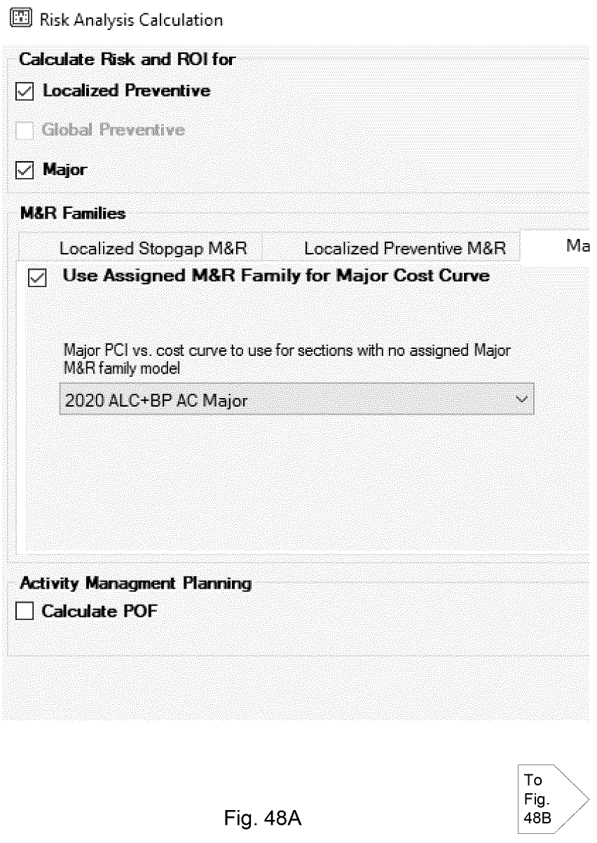

FIGS. 46A-46B, FIGS. 47A and 47B, and FIGS. 48A and 48B show additional risk calculation windows. FIG. 46 shows M&R Families calculations for localized stopgap M&R. FIG. 47 shows localized preventative M&R. Fig. shows a window to calculate risk and ROI.

FIGS. 49A-49C and FIGS. 50A-50C show a risk analysis for project work window. PMA may be configured to display this window as part of a results display. PMA may individually calculate risk for a project for each work item in the project. In some configurations, PMA may calculate an overall risk value at the project level.

FIGS. 51A to 51B show a project work detail window. The project work detail window may be configured to display individual work items risk value in an overview grid.

FIGS. 52A-52B show an inventory: surface, use, rank category window. The window shows parking in blue, roadways in green, and storage in yellow.

FIGS. 53A-53B show an assignment of PCI deterioration and M&R families window. The window may display an assignment of PCI deterioration families to pavement sections.

FIGS. 54A-54B show a work category by projects window. This window may display a list of projects—colors indicated M&R category.

FIGS. 55A-55B show a projects list window. This window may create a display of all projects—colors indicated M&R work type.

FIGS. 56A-56B show a work plan category by year window. This window may display a workplan recommended annual work categories for all pavement sections.

FIGS. 57A-57B show a workplan recommended for Major M&R by year window. Red is major above critical. Blue is major below critical.

FIGS. 58A-58B shows a first year of an annual section PCI when recommended workplan is performed window. White shows no data. Green is good. Teal is satisfactory. Yellow is fair. Salmon is poor. Red is very poor. Crimson is serious. Gray is failed.

FIGS. 59A-59B shows a second year of an annual section PCI when recommended workplan is performed window. White shows no data. Green is good. Teal is satisfactory. Yellow is fair. Salmon is poor. Red is very poor. Crimson is serious. Gray is failed.

FIGS. 60A-60B show a second year of an annual section PCI when recommended workplan is performed window. White shows no data. Green is good. Teal is satisfactory. Yellow is fair. Salmon is poor. Red is very poor. Crimson is serious. Gray is failed.

FIGS. 61A-61B show a predicted PCI when no work is performed window. The window features the same color legend as described for FIGS. 58-60.

Referring to FIG. 62, when the pavement is appropriately designed for traffic and the environment, one can expect the green curve. If the pavement is too weak to support the traffic, it normally fails very quickly and it performs as shown in the red graph. If the pavement is strong or overdesigned, it performs as shown in the blue graph. One can see strong pavement performance sometimes in concrete pavement performance. PMA may be configured to use the results of PCI inspection to develop the performance curve for each similar group of sections (family). A family curve may be somewhere between the red and blue curves.

Referring to FIG. 63, the figure shows how PMA might calculate pavement performance in the case when a Global is applied at tₑᵥₐₗ. The first blue portion of the curve (t₀ to t_{wp}) may be the pavement history prior to starting the work plan analysis. The second purple portion (t_{wp} to tₑᵥₐₗ) may be where the work plan applies the family curve and accounts for any Localized or Global applications in that period. PMA may be configured such that if Major is applied the PCI becomes 100 and a new life analysis begins. The rest of the figure shows what might happen if PMA were determining the ROI (or calculate risk) assuming Global is applied at tₑᵥₐₗ. The dark blue shows a family curve applied to the section based on the section PCI at that time. The increase in PCI at tₑᵥₐₗ may be calculated based on the value of ΔT₍ₜₑᵥₐₗ₎. The calculation may be done by shifting the curve so that the PCI value at tₑᵥₐₗ, (before the Global application), is equal to the PCI at tₑᵥₐₗ, (before the Global application), plus ΔT₍ₜₑᵥₐₗ₎.

The claimed invention is:

1. A PMA computer comprising a processor and tangible memory storing non-transitory computer readable software configured to cause the processor to execute a pavement repair program; the program comprising:
an input interface displayed on a computer screen; the input interface requesting the user to:
select at least one pavement Section(S); the section(S) having an area (Area^{S});
the section having a pavement condition index;
specify a financial budget;
specify a date at which the computer should calculate an estimated uniform annual cost (EUAC);
a pavement condition index calculator configured to determine a PCI value for the section; the pavement condition index including:
a deterioration curve caused by pavement age, pavement condition, and localized preventative M&R history information; and
a critical PCI value being a value the critical PCI value is a value below which global and localized preventative maintenance and repair (M&R) are no longer performed and safety M&R begins;
a database for storing:
an M&R family (MF) assigned to the selected Section;
an inspection history for Section(S); the inspection history comprising a date of inspection; an age of the pavement at the date of inspection (time/age); and
the PCI value based on measured distresses of the pavement;
a work planning date (t_{wp}) indicating when M&R work planning is scheduled to begin;
a work planning module configured to integrate risk and return on investment (ROI) calculations into pavement work planning;
a lifetime calculator configured to calculate a lifetime of section S (T^{S}_{w}(tₑᵥₐₗ)); and
a return on investment calculator configured to determine an estimated uniform annual cost per unit of a section of road EUAC^{s}_{w}(tₑᵥₐₗ).

2. The PMA computer of claim 1, wherein the M&R family comprises:
a cost curve from PCI to localized preventive M&R cost per unit area;
a cost curve from PCI to localized safety M&R cost per unit area;
a cost curve from PCI to major M&R cost per unit area;
a plurality of specific types of global work to perform for minimal, climate-related and skid-causing distresses;
a cost table specific global work type to cost per unit area; and
a PCI reconstruction (PCI_{recon}) specifying a value below which roads section in this M&R family are reconstructed.

3. The PMA computer of claim 1, wherein the database comprises:
a work history (WH^{S}) of section S; the work history including dates when the section received major M&R or global M&R;
an evaluation date (tₑᵥₐₗ) indicating when estimated uniform annual cost is calculated; and
a lifetime (T^{S}_{w}(tₑᵥₐₗ)) of section S from a most recent major M&R to PCI_{crit} based on work of a particular category of M&R performed on S at tₑᵥₐₗ.

4. The PMA computer of claim 1, wherein the work planning module is configured to:
estimate a condition of the section in future years by factoring in the PCI family assigned to the Section;
determine what maintenance and repair work to do in which year;
estimate work costs for each plan year by factoring in of an M&R work family assigned to the section;
generate a work plan WP^{S}(tₑᵥₐₗ) for the section from t_{wp} to tₑᵥₐₗ−1; and
generate a set of conditions C^{S}(tₑᵥₐₗ) the work planner has predicted for S from t_{wp} to tₑᵥₐₗ.

5. The PMA computer of claim 1, wherein the lifetime calculator is configured to calculate the lifetime wherein the lifetime includes a length of time beginning from a last major maintenance and repair work to a critical PCI value (PCI_{crit}).

6. The PMA computer of claim 5, wherein the lifetime calculator is configured to factor into the calculation that work of a particular category of maintenance and repair work is performed on S at tₑᵥₐₗ.

7. The PMA computer of claim 1, wherein the estimated uniform annual cost factors in performance of a particular category of work at an evaluation time (tₑᵥₐₗ).

8. The PMA computer of claim 1, wherein the return on investment calculator is configured to generate an estimated uniform annual cost per unit of a section EUAC^{s}_{wo}(tₑᵥₐₗ).

9. The PMA computer of claim 8, wherein the estimated annual cost factoring in nonperformance of a particular category at the evaluation time (tₑᵥₐₗ).

10. The PMA computer of claim 1, wherein the return on investment calculator is configured to generate:
a change in estimated uniform annual cost per unit area between doing work and not doing work of a particular category on S at the evaluation time (ΔEUAC^{s}) (tₑᵥₐₗ);
a return on investment (ROI^{S}(tₑᵥₐₗ)) for performing work of a particular category on S at tₑᵥₐₗ; the return on investment equal to (ΔEUAC^{s}) (tₑᵥₐₗ)/(EUAC^{s}_{w}) (tₑᵥₐₗ); and
an estimated repair cost per unit of a section of pavement to perform work of a particular category at an evaluation time (tₑᵥₐₗ).

11. The PMA computer of claim 1, comprising a risk calculator configured to calculate an annual risk cost (RC^{S}(tₑᵥₐₗ)) for performing work of a particular type on S at tₑᵥₐₗ; the annual risk cost being equal to (ΔEUAC^{s})×Area^{S}.

12. The PMA computer of claim 1, comprising a solver configured to accurately determine (EUAC^{s}_{w}) (tₑᵥₐₗ) and (EUAC^{s}_{wo}) (tₑᵥₐₗ) for a particular work category for a pavement section at time/age tₑᵥₐₗ.

13. The PMA computer of claim 1, comprising a Section M&R computer configured to schedule maintenance and repair work for the Section based on the work plan generated by the PMA computer.

14. A PMA computer comprising a processor and tangible memory storing non-transitory computer readable software configured to cause the processor to execute a pavement repair program specialized in determining global maintenance and repair costs (Global M&R); the program comprising a solver configured to determine an estimated uniform annual cost per unit of a section when performing work (EUAC^{s}_{w}) (tₑᵥₐₗ) for a particular work category for a pavement section at an evaluation date (tₑᵥₐₗ) and an estimated uniform annual cost per unit of a section without performing work (EUAC^{s}_{wo}) (tₑᵥₐₗ) for a particular work category for a pavement section at an evaluation date (tₑᵥₐₗ); the solver comprising:
an input interface configured to allow a user to specify to the program:
a Section of road for evaluation(S);
a PCI family (PF) assigned to Section(S) defined as PF^{S}; wherein PCI is a pavement condition index of the Section;
a critical PCI (PCI_{crit}) for PF^{S};
a M&R family (MF^{S}) assigned to S;
an inspection history (IH^{S}) for S;
a work history (WH^{S}) for S;
a work plan start (t_{WP});
a time of evaluation (tₑᵥₐₗ);
a work-planned work for S before (tₑᵥₐₗ); and
a work-plan predicted conditions (CS(tₑᵥₐₗ)) for S up to tₑᵥₐₗ;
a work calculator;
a work planner;
a common cost calculator configured to calculate a common cost (Common$) equal to G$_{before}+Major$_{crit};
a EUAC_{WO} calculator for determining EUAC^{S}_{WO}(tₑᵥₐₗ); an estimated uniform annual cost per unit area for S without (wo) performing work of a particular category on S at time/age tₑᵥₐₗ; and
a EUAC_{W} calculator for determining EUAC^{S}_{W}(tₑᵥₐₗ); an estimated uniform annual cost per unit area for S when performing work (w) of a particular category at time/age tₑᵥₐₗ.

15. The PMA computer of claim 14 wherein the work calculator is configured to:
determine actual global work costs (G$ₚᵣₑ) by using WH^{S} to compute (G$ₚᵣₑ); (G$ₚᵣₑ) equal to global work costs before t_{WP}; and
determine major work costs (Major$_{crit}) from PCI_{crit} and a major M&R cost curve in MF.

16. The PMA computer of claim 14 wherein the particular work category is global work.

17. The PMA computer of claim 14 wherein the work planner is configured to:
calculate a cost of planned global work;
compute G$_{before} by summing G$ₚᵣₑ+work planned global cost to tₑᵥₐₗ−1; and
store the cost in a work planned for the Section of road (WP^{S}).

18. The PMA computer of claim 14 wherein the EUAC_{WO} calculator is configured to:
resolve variables: Common$; localized costs when not computing global (L$_{WO}); and
total pavement life when not computing global (TS_{WO}(tₑᵥₐₗ));
determine a lifespan (time to critical condition) for S without doing global work TS_{WO}(tₑᵥₐₗ) at tₑᵥₐₗ by using PF^{S}(tₑᵥₐₗ);
determine a condition C_{WO} for each t from tₑᵥₐₗ to TS_{WO}(tₑᵥₐₗ) by using PF^{S}(t); and
directing a LocalCostCalc module configured to determine a localized cost component from t=0 to TS_{wo}(tₑᵥₐₗ).

19. The PMA computer of claim 14 wherein the EUAC_{w} calculator is configured to resolve variables Common$; cost for performing global work at tₑᵥₐₗ(G$_{curr}), cost for performing localized work after performing global work at tₑᵥₐₗ(L$_{w}), and a lifespan for S when performing global work at tₑᵥₐₗ(TS_{w}(tₑᵥₐₗ)).

20. The PMA computer of claim 18 wherein the EUAC_{W} calculator is configured to determine a global work type identified in MF including a lifespan increase that results when a global work type is applied.

21. The PMA computer of claim 19 wherein the EUAC_{W} calculator is configured to convert the lifespan increase to a new PCI P_{after} for S at tₑᵥₐₗ after the global work is performed by factoring in PF^{S}(tₑᵥₐₗ).

22. The PMA computer of claim 20 wherein the EUAC_{W} calculator is configured to shift PF^{S}(t) for t>tₑᵥₐₗ to pass through tₑᵥₐₗ, P_{after}; the EUAC_{W} configured to use P^{S}(tₑᵥₐₗ+1) to determine T^{S}_{w}(tₑᵥₐₗ)) defined as the lifespan for S with global work at tₑᵥₐₗ; the calculator using P^{S} (t) to compute condition C_{w} for S in each year from tₑᵥₐₗ+1 to T^{S}_{w}(tₑᵥₐₗ).

23. The PMA computer of claim 21 wherein the EUAC_{w} calculator is configured to:
direct a LocalCostCalc module to determine a localized cost up to T^{S}_{w}(tₑᵥₐₗ);
calculate cost for global repairs on S (G$_{curr}) at tₑᵥₐₗ by factoring in:
the global work types identified in MF; and
distresses recorded in HIS; stresses having a category selected from the set consisting of: climate-related and skid-causing.

24. A PMA computer comprising a processor and tangible memory storing non-transitory computer readable software configured to cause the processor to execute a pavement repair program; the program comprising a LocalCostCalc module configured to calculate a localized cost component of EUAC across three separate time periods; the LocalCostCalc module comprising:
a historical calculator for determining costs from a last major M&R (t=0) until work planning starts (t=t_{wp}−1);
a planned calculator for determining costs from a work plan starting (t=t_{wp}) until before the current evaluation time (t=tₑᵥₐₗ);
a future calculator for determining costs from t=tₑᵥₐₗ to a year before reconstruction (t=t_{recon}−1); and
a cost calculator configured to calculate a result cost; the result cost generated by summing a first cost vector, a second cost vector, and a third cost vector.

25. The computer of claim 23 wherein the historical calculator is configured to:
use PF^{S}(t) to calculate the PCI for each year in an interval from 0 to min (t_{end}, t_{wp}−1);
for instances of PF that include preventive work and PCI(t)≥PCI_{crit}, selecting L$₁ (t) as a preventive cost from MF for PCI(t);
for instances of PF that do not include preventive work or PCI(t)<PCI_{crit}, selecting L$₁ (t) as a safety cost from MF at PCI(t); and
produce the first cost vector; the first cost vector comprising the preventative cost or the safety cost.

26. The computer of claim 23 wherein the planned calculator is configured to:
use C^{S}(t) to calculate the PCI(t);
for work plans that include preventive work and PCI(t)≥PCI_{crit}, select L$₂ (t) as the preventive cost from MF for PCI(t);
for work plans that do not include preventive work or PCI(t)<PCI_{crit}, select L$₂ (t) as the safety cost from MF at PCI(t); and
produce the second cost vector; the second cost vector comprising the preventative cost or the safety cost.

27. The computer of claim 23 wherein the future calculator is configured to:
use PF^{S}(tₑᵥₐₗ) to determine the PCI for each year in the interval from [tₑᵥₐₗ, min (t_{recon}−1, t_{end})];
for work plans that include preventive work and PCI(t)≥PCI_{crit}, selecting L$₃ (t) as the preventive cost from MF for PCI(t);
for work plans that do not include preventive work or PCI(t)<PCI_{crit}, selecting L$₃ (t) as the safety cost from MF at PCI(t); and
produce the third cost vector; the third cost vector comprising the preventative cost or the safety cost.

28. A PMA computer comprising a processor and tangible memory storing non-transitory computer readable software configured to cause the processor to execute a pavement repair program; the program comprising:
an input interface configured to allow a user to specify to the program:
a pavement Section for evaluation(S);
a PCI family (PF) assigned to Section(S) defined as PF^{S}; wherein PCI is a pavement condition index of the Section;
a critical PCI (PCI_{crit}) for PF^{S};
a M&R family (MF^{S}) assigned to S;
PCI_{recon}: reconstruction PCI for S from MF;
IH^{S}: Inspection history for S;
WH^{S}: Work history for S;
t_{wp}: work plan start;
tₑᵥₐₗ: Time of evaluation;
WP^{S}(tₑᵥₐₗ): Work-planned for S before tₑᵥₐₗ; and
C^{S}(tₑᵥₐₗ): Work-plan predicted conditions for S up to tₑᵥₐₗ;
a EUAC_{WO} calculator configured to compute EUAC^{S}_{wo}(tₑᵥₐₗ); an estimated uniform annual cost per unit area for S without (wo) performing work of a particular category on S at time/age tₑᵥₐₗ;
use PF^{S}(t_{wp}) to compute t_{recon};
compute Major$_{recon} using MF^{S}; Major$_{recon}=cost for performing major work on S at PCI_{recon};
compute G$_{wo} using WH^{S} or WPₜₒ; G$_{wo} equal to a sum of global work costs from t=0 to min (t_{recon}−1, tₑᵥₐₗ−1); min refers to a minimum value function;
calculate L$_{wo} by using LocalCostCalc with t_{end}=tₑᵥₐₗ−1;
determine EUAC^{S}_{wo}(tₑᵥₐₗ) using the formula of (Major$_{recon}+G$L$)/t; and
a EUAC_{w} calculator configured to:
compute EUAC^{S}_{w}(tₑᵥₐₗ); an estimated uniform annual cost per unit area for S when performing work (w) of a particular category at time/age tₑᵥₐₗ;
compute Major$ using C^{S}(tₑᵥₐₗ) and MF; Major$=cost for performing major work on S at tᵣₑᵥₐₗ;
compute G$w using WH^{S} and WP^{S}; G$w=sum of global work costs from t 0 tₑᵥₐₗ−1;
compute L$_{w} by using LocalCostCalc with t_{end eval}−1; and
determine EUAC^{S}_{w}(tₑᵥₐₗ) using the formula of (Major$+G$L$)/t.
